(19) United States
(12) Patent Application Publication
(10) Pub. No.: US 2026/0321272 A1
(43) Pub. Date: Oct. 15, 2026

(54) SILENT-SPEECH ENABLED EAR-WORN CONTEXTUAL COMPANION PLATFORM

(71) Applicant: Maximilian Ralph Peter von Liechtenstein, Concord, MA (US)

(72) Inventor: Maximilian Ralph Peter von Liechtenstein, Concord, MA (US)

(21) Appl. No.: 19/666,274

(22) Filed: May 3, 2026

Related U.S. Application Data
(63) Continuation-in-part of application No. 19/452,243, filed on Jan. 17, 2026.
Application No. 19/452,243 is a continuation of application No. 18/406,094, filed on Jan. 6, 2024, now Pat. No. 12,537,013.

(51) Int. Cl. G10L 21/0216; G06F 3/01; G10L 13/02; G10L 15/02; G10L 15/187; G10L 15/25; H04R 23/00

(52) U.S. Cl. CPC G10L 21/0216; G06F 3/013; G10L 13/02; G10L 15/02; G10L 15/187; G10L 15/25; G10L 2015/025; G10L 2021/02166; H04R 23/008

(57) ABSTRACT

An ear-worn contextual companion platform includes an ear-worn device having an optical or infrared sensor, a head-motion sensor, a silent-speech sensor, and a private output transducer. The platform receives temporally separated observations acquired as a head orientation of a user changes and generates or updates a contextual representation comprising candidate referents in the user's surroundings. Silent or low-audibility user input is processed to determine a semantic objective requiring contextual grounding, and a candidate referent is selected from the contextual representation for the semantic objective. The platform may cause an assistant operation associated with the selected referent, including private output through the ear-worn device, translation, navigation, payment, communication, person or object identification, or device control. In some embodiments, the platform detects a user-relevant condition without a contemporaneous user command and privately outputs an alert or action proposal through the ear-worn device.

### BACKGROUND OF THE INVENTIONS

### 1. Field of the Inventions

Example embodiments relate to apparatus and methods for processing silent speech, silent sounds, linking visual cues and visual speech recognition with audio signals, enhancing speech audio with the results of audiovisual speech recognition, controlling a device with silent audio commands by using smart earplugs in conjunction with other portable or wearable devices.

### 2. Description of the Related Art

Any discussion of the related art throughout the specification should in no way be considered as an admission that such related art is widely known or forms part of common general knowledge in the field. Unless otherwise indicated herein, the materials described in this section are not prior art to the claims in this application and are not admitted to be prior art by inclusion in this section.

Any discussion of the related art throughout the specification should in no way be considered as an admission that such related art is widely known or forms part of common general knowledge in the field.

When working with speech input, such as speech commands for all kinds of portable and wearable devices, a limiting factor has been background noise. Speech input is currently only suited for environments which are naturally quiet. For such quiet environments there a number of solutions, such as Amazon Alexa for speech-driven command input or Apple Siri with voice control to navigate and interact with a device using voice to tap, swipe, type, and more. However such type of input is fraught with problems when there are high levels of ambient noise, especially when there are multiple speakers, speaking simultaneously.

Also the use of virtual assistants which are voice-controlled is fraught with the privacy problem, in the sense that any bystander in a crowded can overhear voice interactions between a user and their virtual assistant.

In hearing aid type of use cases there are similar problems. The current generation of hearing aids features digital signal processing which offers improved quality in isolating and enhancing speech per se. However, the current state of the art does not allow for distinguishing between speakers and for discriminating between speakers based on a detected interest by the user of the device.

### SUMMARY OF THE INVENTIONS

The present invention recognizes that it is desirable for a user of a speech-enabled device to be able to communicate with the device in such a way that it becomes possible to use speech input in a noisy environment. An embodiment of the invention uses silent speech to realize that aim. Silent speech is when a user either mimes speech, whispers or speaks in such a low volume that an interlocutor in the vicinity would not be expected to be able to hear or understand the speech. The inventor has realized that a lot of people using mobile devices would generally like to use speech input, but are too shy, too private or too self-aware to use audible speech input in a crowded place with strangers around. Hence by using inaudible speech, speech input can be used and the problem of lack of privacy is eliminated.

Another embodiment uses silent sound to control an electronic device. Silent sound is a sound used as a control input which cannot normally be heard by interlocutor in the immediate vicinity of the user. Examples of such silent sounds are a soft clatter of teeth, clicking the tongue or gently touching of the front teeth with the tongue. A command interpreter can translate such silent sounds into control inputs of an electronic device.

The prior art knows of ways to control a visual pointer, such as a mouse pointer, by eye tracking. The prior art also knows that it is desirable to offer a hands-free mode for being able to operate wearable devices at times where the user needs their hands free to accomplish another task. The prior art has ways to position a mouse-type pointer at a location where the user is directing their gaze and it is possible to simulate a mouse click with gestures, such as an eye gesture, of which a wink would be an example. The inventor has realized that the drawback of the prior art is that the known methods to simulate a mouse click with a gesture are all very straining. In other words, whilst it is certainly feasible to simulate an occasional mouse click with a gesture, it becomes prohibitively straining when these mouse click type inputs become very frequent. Fatigue sets in very quickly and also such movements, like conscious winking and blinking, feel so unnatural, that repeating such movements frequently makes for an unpleasant user experience. The same is true for hand gestures. Hand gestures may not be as physiologically straining as winking gestures, but they have the disadvantage that they are socially awkward. It is socially unsettling to be seen talking seemingly to oneself or be seen making strange hand movements, actions that have in the past been primarily associated as an indication of insanity and for which there is even now a subconscious unease when people perform these kind of actions in a public setting when interacting with their personal portable or wearable computing devices. The inventor has realized that especially gentle tongue movements exhibit none of the aforementioned disadvantages when used as a means for making mouse click type inputs to a computing device. It is not socially awkward in any way, since nobody even in the immediate vicinity of the user has any way of telling that the user is even making these command inputs. It is also extremely private and secure since these types of input cannot be easily picked up or intercepted by potentially malicious onlookers. Also tongue movements have the major advantage that they are not straining. It is possible for the tongue to very gently touch the front teeth in a soft clicking type motion for hundreds of times in a row, without strain, fatigue or discomfort setting in. The same is true for a soft clatter of the teeth. A teeth clatter needs to be only extremely faint in order to be observable by the innovative microphone technology which is also subject of this specification. Hence in a preferred embodiment a wearable or portable device is controlled by steering a pointer by gaze to a control surface and by making selections in such a way that a silent sound is produced when the pointer is positioned over a click-enabled control surface. A pointer is optional, it is also possible to just direct a gaze to an object of interest and by making a silent sound control input at the same time. The preferred embodiment also comprises a silent speech mode, whereby the wearable or portable device is controlled by speech input, or whereby the devices is accepting speech input for other purposes, such for speech-to-text or real time speech interpretation/translation kind of scenarios.

Silent speech is especially advantageous for applications where security is of paramount concern, such with authorizations for payments, entering passwords and PINs and for unlocking of any kind. Especially in a setting where perhaps no screen is available and/or no touchpad. An embodiment is realized as a wearable earphone type device, such as smart earplugs or smart headphones. Security-sensitive data may be efficiently entered by silent speech without being interceptable by potentially malicious bystanders. Such input is more secure than tapping in a PIN on a keypad or even using fingerprint recognition. Keypads have the disadvantage that they can be observed when being operated and fingerprint recognition is flawed in the sense that there is no way of ensuring that it is a live fingerprint as opposed to a malicious reproduction of an intercepted fingerprint. Silent speech on the other hand offers the possibility of combining speaker recognition with speech input of sensitive data. Speaker Recognition is the problem of identifying a speaker from a recording of their speech. It is an important topic in Speech Signal Processing and has a variety of applications, especially in security systems. Voice controlled devices also rely heavily on speaker recognition. The main principle behind speaker recognition is extraction of features from speech which are characteristic to a speaker, followed by training on a data set and testing. Hence an innovation departure of the present invention is the combination of speaker recognition and silent speech for the input of sensitive information in order to gain access, such as PINs and passwords.

Another embodiment of the invention is an apparatus to enhance speech. Eye tracking of the user is used to determine a gaze to an interlocutor and the gaze is used to determine a bearing to the interlocutor. Once a bearing is obtained then sound not coming from the direction of the bearing is actively filtered. Hence an embodiment of the present invention is useful as a hearing aid. In another embodiment sound coming from the direction of the bearing is analyzed with the aid of a language model and sound is enhanced in such a way that speech coming from the interlocutor is enhanced in real time.

The inventor has realized that for silent sound inputs and for silent speech inputs to be possible innovative microphones are of particular importance. In one embodiment a set of earpieces for each ear is of the type which is useful for listening to music. The earpieces comprise not only loudspeakers for producing the output sound, but also a set of microphones. In one embodiment there is one microphone on the outside of the earpieces, such as for picking up sounds and noise coming primarily from the outside world, i.e. away from the user. The said embodiment also comprises a microphone on the inside of the earpiece for picking up sounds and noises which are transmitted through the user's head. It is those sounds and noises which may comprise silent speech and noises such as a clatter of the user's teeth or a clicking of the user's tongue which may be used as a command input. An advantage of such earpieces having outside-facing and inside-facing microphones is that sounds originating inside the user's head can therefore be filtered and amplified by known active noise cancellation techniques. Alternative embodiments comprise bone-conducting transducers which may be attached to the frame of smartglasses or cartilage-conducting transducers which may be attached to the earpiece and touch the concha of the user's ear when the device is in operation. Such transducers are also able to pick up sounds and noises originating from inside the user's head. It is possible to use such transducers in isolation, or in combination with the aforementioned set of microphones. A combination is advantageous in the sense that it aids the performance of active noise cancellation in order to filter out the signal from the ambient noise.

The inventor has realized that laser microphones offer special advantages when used for implementing the internal microphones. This is because the laser light can be directed directly onto the ear drum of the user in such a way that vibrations of the membrane can be picked up with great precision and it is these vibrations which tend to comprise a signal rich in silent speech and silent noise control inputs.

There has thus been outlined, rather broadly, some of the features of the silent sound and silent speech apparatus and method in order that the detailed description thereof may be better understood, and in order that the present contribution to the art may be better appreciated. There are additional features of apparatus and methods that will be described hereinafter and that will form the subject matter of the claims appended hereto. In this respect, before explaining at least one embodiment of the apparatus and method in detail, it is to be understood that the technique is not limited in its application to the details of construction or to the arrangements of the components set forth in the following description or illustrated in the drawings. The described technique is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 illustrates a schematic view of an embodiment of the invention.

FIG. 2 illustrates a schematic view of an embodiment of the invention.

FIG. 3 illustrates an architectural overview of an embodiment of the invention.

FIG. 4 illustrates a schematic overview of click equivalents for an embodiment of the invention.

FIG. 4A illustrates a physiological overview of actions required for performing click equivalents for an embodiment of the invention.

FIG. 5 illustrates a schematic overview of use cases for an embodiment of the invention.

FIG. 6 is a flow diagram for an embodiment of the invention, illustrating a flow of inputs and intermediate steps, resulting in a plurality of output options.

FIG. 7 is a flow diagram for an embodiment of the invention, illustrating a flow of inputs and intermediate steps, resulting in a command output.

FIG. 8 is a flow chart for a silent speech enabled payment process for an embodiment of the invention.

FIG. 9 is a flow chart for a silent speech enabled process for a head mountable embodiment of the invention.

FIG. 10 illustrates an ear-worn contextual companion platform including ear-worn devices, companion devices, a remote assistant system, private assistant output, public companion-device output, and representative components of an ear-worn device.

FIG. 11 illustrates natural head-motion contextual mapping in which temporally separated observations acquired at different head orientations are associated with head-orientation information and used to generate or update a contextual representation.

FIG. 12 illustrates silent intent and referent resolution in which silent or low-audibility user input is processed to determine a semantic objective, resolve an incomplete referent slot using a contextual representation, and cause an assistant operation.

FIG. 13 illustrates reactive mode and proactive mode operation of the ear-worn contextual companion platform, including user-initiated operation and detection of a user-relevant condition without contemporaneous user command.

FIG. 14 illustrates context-disambiguated silent interpretation and translation, including source-language silent input, translation processing, context disambiguation, public speaker output, foreign-language reply, and private return translation.

FIG. 15 illustrates an authenticated silent communication session in which silent or low-audibility user input is authenticated and converted into generated user-voice audio for a remote participant.

FIG. 16 illustrates a longitudinal user-specific companion state including relationship data, safety policy, trusted contact data, communication style profile, prior support outcome data, user-state estimation, and personalized output generation.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

As will be appreciated by one skilled in the art, aspects of the present inventions may be embodied as a system, method or computer program product. Accordingly, aspects of the present inventions may take the form of an entirely hardware embodiment, an entirely software embodiment (including firmware, resident software, micro-code, etc.) or an embodiment combining software and hardware aspects that may all generally be referred to herein as a “circuit.” “module” or “system” Furthermore, aspects of the present inventions may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present inventions may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventions are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention recognizes that it is desirable for a user of a speech-enabled device to be able to communicate with the device in such a way that it becomes possible to use speech input in a noisy environment. An embodiment of the invention uses silent speech to realize that aim. Silent speech is when a user either mimes speech, whispers or speaks in such a low volume that an interlocutor in the vicinity would not be expected to be able to hear or understand the speech. The inventor has realized that a lot of people using mobile devices would generally like to use speech input, but are too shy, too private or too self-aware to use audible speech input in a crowded place with strangers around. Hence by using inaudible speech, speech input can be used and the problem of lack of privacy is eliminated.

Another embodiment uses silent sound to control an electronic device. Silent sound is a sound used as a control input which cannot normally be heard by interlocutor in the immediate vicinity of the user. Examples of such silent sounds are a soft clatter of teeth, clicking the tongue or gently touching of the front teeth with the tongue. A command interpreter can translate such silent sounds into control inputs of an electronic device.

The prior art knows of ways to control a visual pointer, such as a mouse pointer, by eye tracking. The prior art also knows that it is desirable to offer a hands-free mode for being able to operate wearable devices at times where the user needs their hands free to accomplish another task. The prior art has ways to position a mouse-type pointer at a location where the user is directing their gaze and it is possible to simulate a mouse click with gestures, such as an eye gesture, of which a wink would be an example. The inventor has realized that the drawback of the prior art is that the known methods to simulate a mouse click with a gesture are all very straining. In other words, whilst it is certainly feasible to simulate an occasional mouse click with a gesture, it becomes prohibitively straining when these mouse click type inputs become very frequent. Fatigue sets in very quickly and also such movements like conscious winking and blinking feel so unnatural, that repeating such movements frequently makes for an unpleasant user experience. The same is true for hand gestures. Hand gestures may not be as physiologically straining as winking gestures, but they have the disadvantage that they are socially awkward. It is socially unsettling to be seen talking seemingly to oneself or be seen making strange hand movements, actions that have in the past been primarily associated as an indication of insanity and for which there is even now a subconscious unease when people perform these kind of actions in a public setting when interacting with their personal portable or wearable computing devices. The inventor has realized that especially gentle tongue movements exhibit none of the aforementioned disadvantages when used as a means for making mouse click type inputs to a computing device. It is not socially awkward in any way, since nobody even in the immediate vicinity of the user has any way of telling that the user is even making these command inputs. It is also extremely private and secure since these types of input cannot be easily picked up or intercepted by potentially malicious onlookers. Also tongue movements have the major advantage that they are not straining. It is possible for the tongue to touch the front teeth very gently in a soft clicking type motion for hundreds of times in a row, without strain, fatigue or discomfort setting in. The same is true for a soft clatter of the teeth. A teeth clatter needs to be only extremely faint in order to be observable by the innovative microphone technology which is also subject of this specification. Hence in a preferred embodiment a wearable or portable device is controlled by steering a pointer by gaze to a control surface and by making selections in such a way that a silent sound is produced when the pointer is positioned over a click-enabled control surface. A pointer is optional, it is also possible to just direct a gaze to an object of interest and by making a silent sound control input at the same time. The preferred embodiment also comprises a silent speech mode, whereby the wearable or portable device is controlled by speech input, or whereby the devices is accepting speech input for other purposes, such for speech-to-text or real time speech interpretation/translation kind of scenarios.

Silent speech is especially advantageous for applications where security is of paramount concern, such with authorizations for payments, entering passwords and PINs and for unlocking of any kind. Especially in a setting where perhaps no screen is available and/or no touchpad. An embodiment is realized as a wearable earphone type device, such as smart earplugs or smart headphones. Security-sensitive data may be efficiently entered by silent speech without being interceptable by potentially malicious bystanders. Such input is more secure than tapping in a PIN on a keypad or even using fingerprint recognition. Keypads have the disadvantage that they can be observed when being operated and fingerprint recognition is flawed in the sense that there is no way of ensuring that it is a live fingerprint as opposed to a malicious reproduction of an intercepted fingerprint. Silent speech on the other hand offers the possibility of combining speaker recognition with speech input of sensitive data. Speaker Recognition is the problem of identifying a speaker from a recording of their speech. It is an important topic in Speech Signal Processing and has a variety of applications, especially in security systems. Voice controlled devices also rely heavily on speaker recognition. The main principle behind speaker recognition is extraction of features from speech which are characteristic to a speaker, followed by training on a data set and testing. Hence an innovation departure of the present invention is the combination of speaker recognition and silent speech for the input of sensitive information in order to gain access, such as PINs and passwords.

Another embodiment of the invention is an apparatus to enhance speech. Eye tracking of the user is used to determine a gaze to an interlocutor and the gaze is used to determine a bearing to the interlocutor. Once a bearing is obtained then sound not coming from the direction of the bearing is actively filtered. Hence an embodiment of the present invention is useful as a hearing aid. In another embodiment sound coming from the direction of the bearing is analyzed with the aid of a language model and sound is enhanced in such a way that speech coming from the interlocutor is enhanced in real time.

The inventor has realized that for silent sound inputs and for silent speech inputs to be possible innovative microphones are of particular importance. In one embodiment a set of earpieces for each ear is of the type which is useful for listening to music. The earpieces comprise not only loudspeakers for producing the output sound, but also a set of microphones. In one embodiment there is one microphone on the outside of the earpieces, such as for picking up sounds and noise coming primarily from the outside world, i.e. away from the user. The said embodiment also comprises a microphone on the inside of the earpiece for picking up sounds and noises which are transmitted through the user's head. It is those sounds and noises which may comprise silent speech and noises such as a clatter of the user's teeth or a clicking of the user's tongue which may be used as a command input. An advantage of such earpieces having outside-facing and inside-facing microphones is that sounds originating inside the user's head can therefore be filtered and amplified by known active noise cancellation techniques. Alternative embodiments comprise bone-conducting transducers which may be attached to the frame of smartglasses or cartilage-conducting transducers which may be attached to the earpiece and touch the concha of the user's ear when the device is in operation. Such transducers are also able to pick up sounds and noises originating from inside the user's head. It is possible to use such transducers in isolation, or in combination with the aforementioned set of microphones. A combination is advantageous in the sense that it aids the performance of active noise cancellation in order to filter out the signal from the ambient noise.

The inventor has realized that laser microphones offer special advantages when used for implementing the internal microphones. This is because the laser light can be directed directly onto the ear drum of the user in such a way that vibrations of the membrane can be picked up with great precision and it is these vibrations which tend to comprise a signal rich in silent speech and silent noise control inputs.

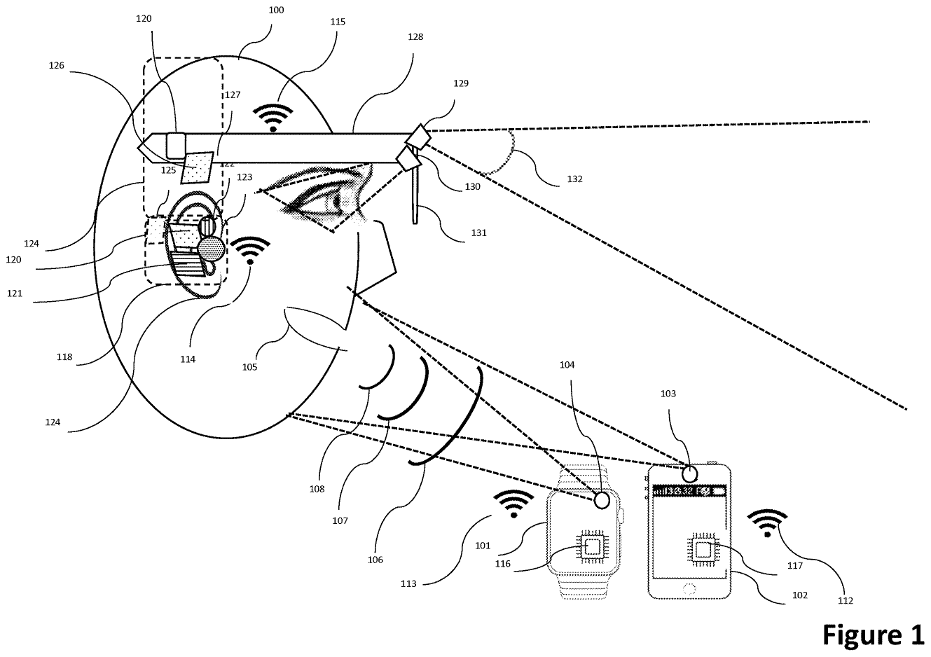

FIG. 1 depicts an apparatus embodying a number of principles of the invention. The apparatus comprises a set of portable and/or wearable devices which may be wirelessly networked. A user 100 is wearing smart glasses and wireless ear buds. The user's face, in particular the area around the mouth 105 is observed by cameras 103 104 which may be hosted on a handheld device 102 or wrist-attached device 101. The sound waves associated with speaking are symbolically depicted as curly brackets 106 107 108 109 110 111. The various devices may be interconnected via a wireless connection in order to make up the composite apparatus. The wireless connection is realized with Bluetooth LM in a preferred embodiment. The wireless interconnectivity is symbolized as 112 113 114 115. An advantage of the depicted wireless interconnectivity is that the apparatus can be configured as a distributed computing system whereby the processors 116 117 on the handheld device 102 or the wrist-attached device 101 serve as the main processors of the distributed apparatus. With current technology it is challenging to integrate a processor capable of performing the very processor-intense signal processing and speech processing operations within the earbud device or the smart glasses device. Also, such capable processors require battery power which is difficult to provide within smart glasses or smart ear buds because of the weight of the necessary batteries. In an example embodiment a wrist attached device 101 was implemented with an Padgene DZ09 Bluetooth Smart Watch with an MTK6261 533 Mhz processor. In a further example embodiment, the handheld device 102 was implemented using an Apple iphone 13 smartphone with a Hexa-core processor (2×3.23 GHz Avalanche+4×1.82 GHz Blizzard) and a 12 MP, f/2.2, 23 mm (wide), 1/3.6″ user-facing (selfie) camera and Bluetooth connectivity.

The user 100 is wearing an ear-mountable device 118 which may be wirelessly networked 114 with a smart glasses type device 128 and a hand-held computing device such as 102, or a wrist-strapped computing device, such as 101. Other embodiments are possible, provided that the computing device is equivalent to 101 or 102 in the sense that the computing device comprises a user-facing camera, a processor capable of performing lip reading and speech processing tasks and wireless connectivity to the earpiece 118. The ear mountable device 118 may comprise an outward facing microphone 120, in the sense that the microphone facing away from the user 100 in such a way that environmental sounds, as opposed to sounds originating within the body of the user, are being picked up. The ear mountable device may also comprise an inward-facing microphone 121, in the sense that the microphone is facing the ear of the user and whereby the microphone is configured to preferentially pick up sound originating from within the user's body. In a preferred embodiment microphones 120 and 121 are Cardioid microphones, which are characterized by being unidirectional. They pick up significantly more sound from the front of the capsule than the back and sides. Microphones 120 and 121 are conventional microphones, in the sense that they belong to the three primary types of microphones-dynamic microphones, condenser microphones, and ribbon microphones. In an exemplary embodiment Sonion 6001 Directional Microphones are used for realizing microphones 120 and 121. All three comprise a capsule, sometimes called a baffle, which picks up the sound and converts it to electrical energy. Inside the capsule is a diaphragm, a thin membrane that vibrates when it comes in contact with sound waves, initiating the conversion process. Those skilled in the art will realize that other types of microphones are possible.

Specifically, the ear mountable device may comprise an inward-facing laser microphone 122 in order to realize an internal microphone. A laser microphone reflects a laser off a vibrating object and uses a receiver to capture the laser's reflection. The reflection of the laser gets deflected as vibrations shift the surface of the vibrating object. Therefore, if a receiver takes in the oscillating laser signal from a fixed location, the receiver will detect the laser deflections caused by the vibrations that were originally produced from an audio signal. The receiver can then filter and amplify this signal. An innovative embodiment uses an ear drum of the user as the vibrating surface and hence as the target for the laser. An embodiment uses a CivilLaser 780 nm 1 mW IR Low Power Laser Diode Module Dot Small Module 8 mm in combination with a RadioShack P722-5R cadmium-sulfide photocell for picking up the reflected light.

The ear mountable device may also comprise a cartilage conducting transducer 123. The cartilage conducting transducer serves the function of detecting vibrations which originate from sounds produced by the body, such as speech. Hence the transducer serves as a cartilage conduction microphone. The cartilage conduction transducer 123 may be coupled to a portion of the back of an auricle of an ear 124 of a user. In cartilage conduction, a sound transducer may also be placed on the cartilage of the pinna, whereby the air-conduction and osseotympanic bone conducting components are also transmitted. The vibrating surface often contacts not only with the aural cartilage but also with the osseous parts of/around the pinna. Other placements against cartilage tissue on or in the vicinity of an ear are possible. An embodiment uses a Sonion Voice Pickup Bone Sensor (VPU) sensor for realizing the cartilage conducting transducer 123.

The ear mountable device may comprise a bone conducting transducer 125. The bone conducting transducer 125 may be brought into contact with the temporal bone in a position behind the ear at a location where a lack of hair growth permits a direct contact of the transducer with the temporal bone. In embodiments with a head clamp 124 pressure exerted by the head clamp may be used to bring the bone conducting transducer 125 into contact with the user's skin in the area of the temporal bone. An embodiment uses a Sonion Voice Pickup Bone Sensor (VPU) sensor for realizing bone conducting transducer 125.

In an alternative embodiment a bone conducting transducer 126 may be brought into contact with the user's skin in the area of the temporal bone by attaching the transducer to the skin-facing side of the temple tips 127 of smart glasses 128. The inventors have found it useful to integrate the temple tips 127 with the overall frame of the smart glasses 128 in such a way that the temple tips are made of a flexible material and wherein the temple tips, when not worn, protrude inwards into what would be the temple area when worn. The intended result is that the temple tips will need to be flexed away from the temple area when worn. Flexing the temple tips away from the temple when putting on the smart glasses results in the temple tips exerting pressure on the temple area. This pressure is essential for the bone conducting transducer 126 to be operatable. It is important that the pressure is not too strong, such as to cause discomfort to the user and yet strong enough to permit a snug fit of the transducer 126 with the user's temple area. In order to achieve the snug fit, embodiments have been constructed using plastic, nylon and combination materials for the frame of the eyeglasses, including the temple tips. The two commonly used plastic frame materials are zyl and propionate. Zyl, also known as cellulose acetate, is the most commonly used plastic frame material. Propionate is the second most common materials and is a nylon-based, hypoallergenic plastic. Gliamides and Grilamid is also a suitable material for embodiments of the eyeglass frame and temple tips. It is typically made of a high-quality thermoplastic material that is shock-resistant, lightweight, and non-allergenic. It provides structural integrity and stability that is very resistant to hot, cold, and chemical damage. Also suitable for practicing the invention are combination frames which help to get the best of various materials with frames that combine metal with the thickness of plastic. The list of materials is non-exhaustive, any material which is suitably flexible to exert the required pressure in order to press the transducer to the user's skin can be used in alternative embodiments. The smart glasses 128 may also comprise a front facing camera 129 suitable for observing the field of view 132 of the user within the visual range. The front facing camera 129, in one embodiment, was a H.264 camera with 1920×1080 pixels at 25 fps. The smart glasses 128 may also comprise eye tracking capability. In an embodiment eye tracking has been realized with an eye tracking unit 130, comprising both a eye camera and an infrared eye illuminator. In an example embodiment Tobii Pro Glasses 3 have been used as the basis for smart glasses 128. In an embodiment the Tobii Pro Glasses 3 has been enabled for wireless connectivity 115 using a Bluetooth LE adapter realized as a Pluggable USB Bluetooth 4.0 Low Energy Micro Adapter. By using the Tobi Pro Glasses 3 basis a smart glasses frame is provided which realizes camera 129 with a scene camera with a wider field of view (106° H: 95°, V: 63°) and which also realizes the eye tracking unit 130 with 16 illuminators and 4 eye cameras integrated into the lenses 131.

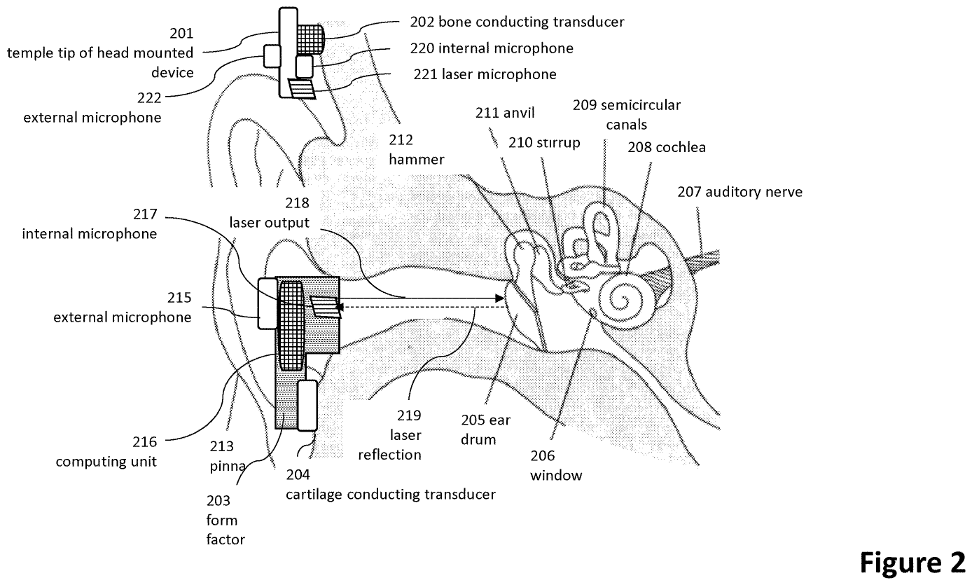

FIG. 2 depicts a side view of an exemplary embodiment with particular emphasis on the integration and interaction of the embodiment with the human anatomy around the skull area. 201 depicts a cross-section of the temple tips of a head mountable device or smart glasses. The temple tips 201 may have an integrated bone conducting transducer 202 which is pressed against the user's skin by pressure exerted through the frame of the head mountable device, of which the temple tips may be an integral component. The ear mountable device comprises a form factor 203 which houses the functional components and which may also be molded for a snug fit with the anatomy of the ear canal and the ear area of a user. The form factor may either be inserted into the ear, being held in place by the snug anatomical fit itself. In a preferred embodiment, a head clamp may be used to ensure a close fit. The prior art knows a wide variety of different types of head clamps, such as those being commonly used for headphones of all types. 204 is a cartilage conducting transducer which may be pressed against the user's skin either by the snugly fitting form factor itself, or alternatively by a clamp, such as a head clamp of the headphone type, which may be applied to the form factor. The temple tips 201 may comprise an external microphone 222 and an internal microphone 220 whereby external signifies in this context that the direction of the microphone is away from the user and internal signifies that the direction on the microphone is pointing towards the user. The combination of an external and internal microphone in the temple tips has the advantage that noise originating from the user can be filtered through noise cancellation algorithms. The temple tips may also comprise a user-facing laser microphone 221 configured to pick up telltale oscillations which may be associated with silent speech from the skin around the temple area of the user's skull.

The figure also depicts the human anatomy of the ear area, namely ear drum 205, the window 206, the auditory nerve 207, the cochlea 208, the semicircular canals 209, the stirrup 210, the anvil 211, the hammer 212 and the pinna 213.

The form factor 203 may comprise an internal microphone 217 and an external microphone 215. The internal microphone is facing toward the ear canal of the user, when the form factor is worn; whereas the external microphone is normally facing away from the ear canal. An innovative departure from the prior art is constituted through using inward and outward facing microphones, enabling active noise cancellation regarding noises originating from the outside world, i.e. outside the body of user. Since one aim of the invention is the detection of silent speech, i.e. speech inaudible for the outside world it is useful to cancel noise from the outside world. Noise cancellation algorithms may be executed through computing unit 216, wherein a computing unit may comprise one or more processors, a transceiver, communication interfaces and data storage. In a preferred embodiment the internal microphone is an inward-facing laser microphone whereby the laser output may be directed towards the ear drum 205, causing a laser reflection 219 to be returned to the laser microphone. In other embodiments non laser-based microphones were used for the internal microphone, such as microphones which use built-in membranes or other moving parts as intermediaries between the incoming acoustic and the resulting electrical quantity.

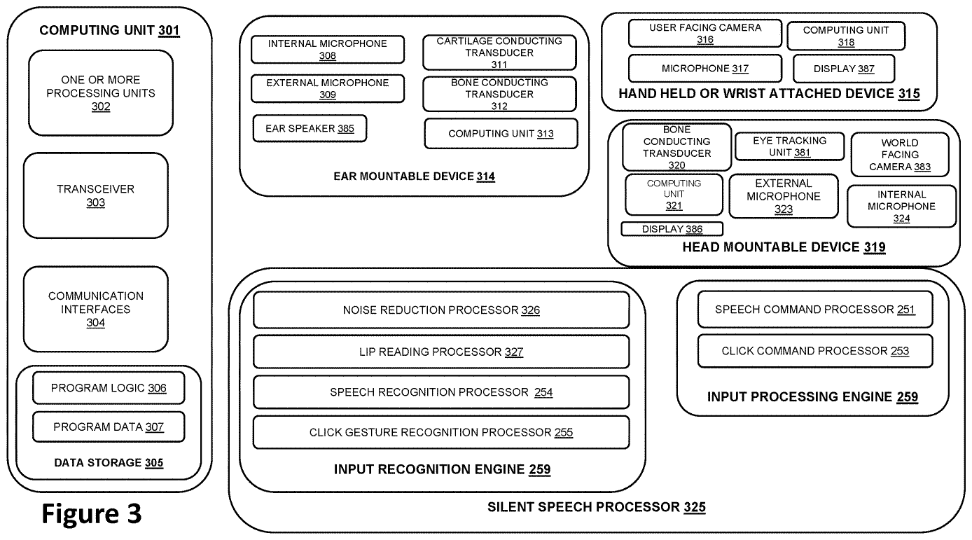

FIG. 3 depicts an overall system diagram of a preferred embodiment of the present invention. The system may comprise one or more computing units 301. A computing unit may be integrated with a wrist-attached device 101, a handheld device 102, an ear-mountable device 118 and a head-mountable device 128. A computing unit may comprise one or more processing units 1110 which can either constitute a shared resource, or especially if performance-critical tasks are performed, separate processors can be added to the singular components. The preferred embodiment further may comprise one or more communication interfaces 304. In a preferred embodiment each system component which in integrated with its own computing unit comprises at least one Bluetooth LE communication interface for letting the system components network with each other and the overall system comprises at least one wireless local area network (WLAN) and one Global System for Mobile communication (GSM) communication interface for enabling communications beyond the system boundaries.

The system may comprise one or more transceivers 303, wherein said transceivers may perform the function of enabling wireless connections between the components themselves and with the wider world, such as to access cloud services. The transceivers in the preferred embodiment may comprise Bluetooth transceivers, wireless local area network transceivers and a GSM transceiver, however those skilled in the art will appreciate that any combination of wireless transceivers will suffice for enabling an embodiment of the present invention. A preferred embodiment comprises data storage 305. Data storage may be used to store both program logic 306 and program data 307 for execution on the processing units 302.

A preferred embodiment comprises two ear mountable devices 314, one for each ear. The invention, however, may be practiced with only a single ear mountable device also. An ear mountable device may comprise an internal microphone 308, an external microphone 309, a cartilage conducting transducer 311, a bone conducting transducer 312, an ear speaker 385 and a computing unit 313.

In an exemplary embodiment the ear speaker 385 was realized with a PHONSUN Earpiece Ear Speaker. In embodiments of the invention the ear speakers have been utilized to output text-to-speech in speech-to-text-to-speech type use cases which are useful for hearing aid type applications, i.e. when the speech of a by standing person is being recognized, aided by viseme recognition, transcribed to text and subsequently output as synthetic speech through the ear speaker.

In alternative hearing aid type embodiments, recognized speech may be output as text on a subtitle type of display on a paired device, such as an augmented reality type retinal projection display or the display of a smartphone type device, such as the display 386 of the head mountable device 319 or the display 387 on the hand-held or wrist-attached device 315.

The system may comprise one or more handheld or wrist attached devices 315. A handheld or wrist attached device may comprise a user facing camera 316, a microphone 317 and a computing unit 318.

The system may comprise a head mountable device 319 which is realized by a smart glasses type device 128 in a preferred embodiment. The head mountable device may comprise a world-facing camera 383, an eye tracking unit 381, a bone conducting transducer 320, a computing unit 321, an internal microphone 323 and an external microphone 324. The internal microphone is realized as a laser microphone in a preferred embodiment, wherein the constituent laser may be configured to pick up oscillations of an area of skin of the user's head.

The system may comprise a silent speech processor 325. The silent speech processor may be a distributed processor in such a way that the associated program logic may be executed on more than one device and that the results may be aggregated from more than one device. There are also embodiments which use cloud computing in the sense that some of the program logic of the silent speech processor may be executed on one or more cloud computing servers. The silent speech processor may comprise a noise reduction processor 326 for reducing ambient noise and thus enhancing acoustic signals originating from the body of a user. The silent speech processor may use a digital signal processor (DSP) to adapt the noise cancellation to the specific environment.

The system may comprise a lip-reading processor 327. A lip-reading processor may take a video stream of the user's mouth area, or general face area, as input and transcribe speech, including silent speech. In a preferred embodiment the lip-reading processor has been implemented using a TITAN X GPU, CUDA and the TensorFlow deep learning framework. The NVIDIA CUDA Toolkit provides a development environment for creating high performance GPU-accelerated applications. An output of the lip-reading processor may be a stream of recognized visemes, wherein the recognized visemes may be an input to the phoneme disambiguation step during subsequent speech recognition by the speech recognition processor 254.

The system may further comprise a speech recognition processor 254. A preferred embodiment was using a 14-nm inference chip leveraging 34 large arrays of phase-change memory (PCM) devices, digital to analog input, analog peripheral circuitry, analog to digital output and massively parallel-2D-mesh routing. The described embodiment implemented the MLPerf version of RNNT, a large data-center network, on Librispeech without any additional hardware-aware retraining. This model has 45 million weights, which we implement using more than 140 million Pulse Code Modulation (PCM) devices across five packaged chip modules. PCM devices are responsible for converting digital sound sequences to analog waveforms, or analog waveforms to digital sound sequences.

The system may further comprise a click gesture recognition processor 255. Click gesture recognition requires analyzing data stream from sensors such as bone conducting transducers, acoustic microphones or laser microphones. Such data streams need to be search for patterns resembling a click gesture input. Pattern matching is a fundamental concept in computer science that involves checking a given sequence of tokens for the presence of the constituents of some pattern. Embodiments of the invention employ pattern recognition using neural. Neural networks are based on parallel subunits referred to as neurons that simulate human decision-making. A preferred embodiment is using neural networks with deep learning, which applies deep convolutional neural networks (CNN) to solve classification tasks. The recent advances in hardware have led to the emergence of Graphical Processing Units (GPU) as a solution for speeding up the process of executing complex deep learning algorithms. Although GPU offers massive parallelism through a large number of cores, it is not always the optimum choice for executing training of all deep learning models. A preferred embodiment of the click gesture recognition processor uses a CPU because performance tests for click gesture recognition using CNN have indicated that the CPU trains up to 2 times faster than the GPU.

An embodiment may comprise an input processing engine 259, which in turn may comprise sub-components comprising a speech command processor 251, a click command processor 253, and a speech recognition processor 254. An embodiment of the speech command processor 251 was implemented using NXP Voice Intelligent Technology (VIT) Wake Word and Voice Command Engines which are free, ready to use voice UI engines. They enable customer-defined wake words and commands using online tools. The NXP library and voice control software package is delivered via the MCUXpresso SDK or Linux BSP. A click command processor 253 was also implemented using the MCUXpresso SDK, whereas an embodiment was mapping a detected click gesture or click sound to a wake word.

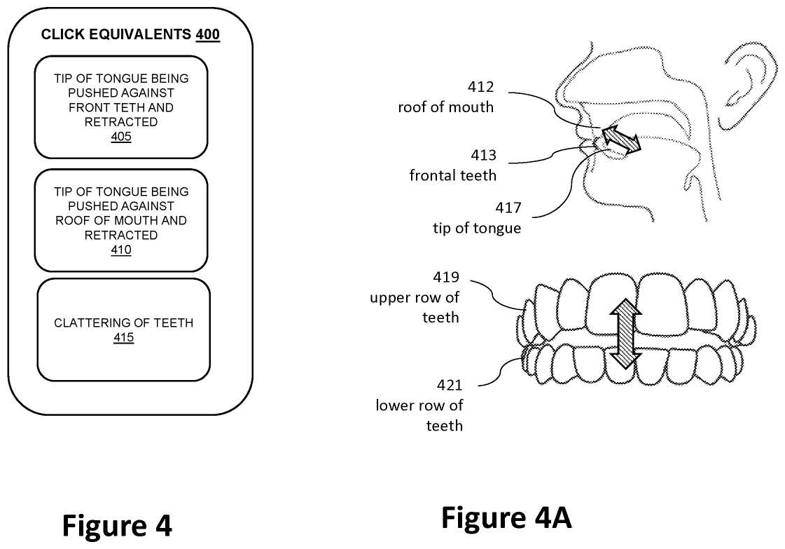

FIG. 4 and FIG. 4A describe embodiments wherein novel click equivalents 400 are utilized. In an innovative departure from the prior art, Applicant has realized that the tip of the user's tongue 417 being pushed against the front teeth 413 and then being retracted 405 may serve as a semantic equivalent to the mouse click type user command known in the prior art. Alternatively, the user's tip of the tongue 417 may be briefly pushed against the roof of the user's mouth 412 and then being retracted 410. Another embodiment may comprise interpreting a clattering of teeth 415 as a click equivalent, whereby of clattering of teeth may be defined as bringing an upper row of teeth 419 together with a lower row of teeth 421 in such a way that a faint noise is produced. Such a noise is normally too faint to be detectable by a third person human observer, such as a bystander. However, such a noise is normally detectable both by sensitive microphones, such as which are described for embodiments of the instant specification, and also by the user themselves. The user typically being able to sense such body internal sounds, even in noisy environments, offers the advantage of a sensatory feedback look, which in turns aids to improve precision of inputs. The inventor has realized that these embodiments offer the added advantage of being relative fatigue free, as compared with repetitive strain from finger movements, as may be the case with the risk of repetitive strain injury arising from finger movements which are required for prior art type mouse click inputs. Moreover, these types of described click equivalents have the advantage that they are also precise, especially on a measure of timing. However, it is possible that involuntary click equivalents are detected, such as an involuntary clattering of teeth, or an involuntary touching of teeth, or the roof of the mouth with the tongue. In such cases, embodiments practice a contextual evaluation in order to be able to distinguish between involuntary and voluntary click equivalents. In an embodiment such a context evaluation comprises determining whether a pointer, such as a mouse pointer, rests atop a clickable surface of a user interface when such a click equivalent is detected.

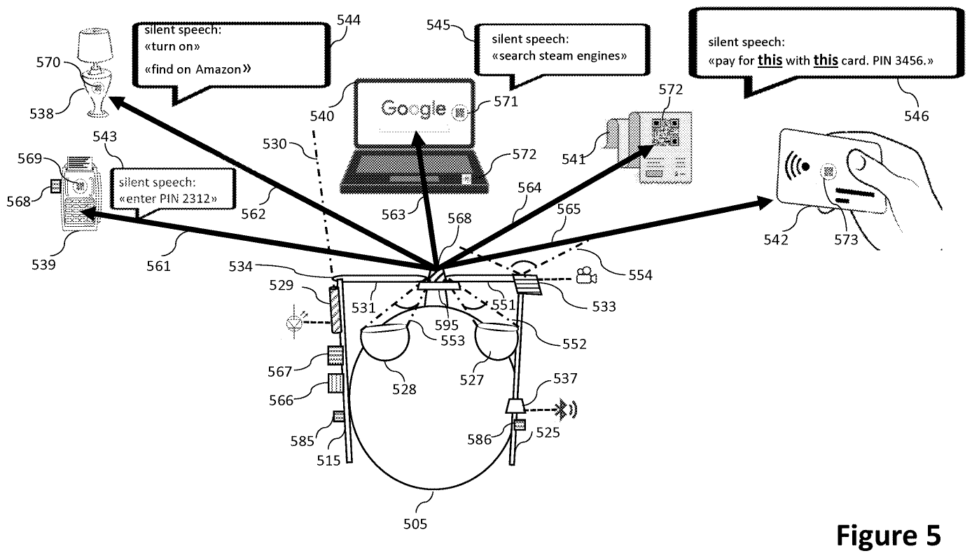

FIG. 5 is a schematic diagram depicting several use cases for an embodiment comprising a head wearable device. A user 505 may wear smart glasses which may comprise a head wearable frame 515, wherein the frame may comprise a left lens 531 for a left eye 528 and a right lens 551 for a right eye 527. Attached to the frame or alternatively embedded therein, or alternatively connected wirelessly or by wire, may be a silent speech processor 566 and a computing unit 567. Attached to the frame may be a light emitting device 529, wherein said light emitting device may be configured in such a way that emitted light is directional and wherein emitted light is directed towards the direction 530 where the user's head is pointing. A preferred embodiment is using a laser diode with light of the near infrared spectrum. Other light emitting devices and wavelengths other than near infrared are possible. However, in all embodiments it is desirable that the light emitting device emits as narrow a beam as possible and that the light is invisible to the human eye.

Attached to the frame, or integrated therein, may be a left microphone 585 and a right microphone 586. The left and right microphones are directional microphones, configured in such a way that sound is picked up primarily from a specific direction, wherein the left microphone may pick up sound originating from directions to the left side of the device and wherein the right microphone may pick up sound originating from directions to the right side of the device. It is possible to alternatively use an omnidirectional microphone as a directional microphone by installing it in such a way that sounds from directions other than the preferred direction are reduced by sound-absorbing obstacles. Exemplary embodiments have used Sanskrit AN-300 directional MEMS microphones for implementing the left and rights microphones. Alternatively, an array of microphones of more than two microphones may be used.

Attached to the frame, or integrated therein, may be an eye tracking unit 568. In a preferred embodiment, a Tobii Eye Tracker 5 was attached to the frame. The eye tracking unit is capable of determining a gaze direction from visually observing the user's eyes 528 and 527 by illuminating the eyes with a cone of light 552 and 553 and imaging the user's pupils. Other eye tracking implementations are possible. Also, it is possible that the eye tracker is external to the frame. If the eye tracker is external to the frame, embodiments use low power wireless communications, such as Bluetooth in a preferred embodiment, to allow the eye tracker to interface with the silent speech processor and the computing unit. Attached to the frame, or integrated therein, may be a wireless communications unit 525, which is a Microchip RN4870/71 Bluetooth Low Energy Module in one embodiment.

Attached to the frame, or integrated therein, may be a forward-facing video camera 533 which may be configured to image a field of view 554 essentially corresponding to the user's field of view. An embodiment was using the DesignSpark RP-VC1 camera module CSI-2 with 1920×1080 pixels resolution.

Attached to the frame, or integrated therein, may be a display 595. In a preferred embodiment, a virtual retinal display was used. A virtual retinal display (VRD), also known as a retinal scan display (RSD) or retinal projector (RP), is a display technology that draws a raster display directly onto the retina of the eye. In one embodiment a QD Laser VRD RETISSA Display II was used.

One use case for a head mountable embodiment is the touchless entry of a PIN number into a point of sale (POS) terminal 539. The inventor has realized that it is desirable to enter a PIN number in such a way that it is essentially both unobservable to outside observers for privacy reasons and touchless for hygienic reasons. The described use case starts with a customer in shop approaching the POS terminal and making eye contact with it. With eye contact being established, an interfacing between the user and the POS terminal is then automatically initiated. In one embodiment the light emitting device 529 is signaling to the POS via modulated light and wherein the POS terminal comprises a light receptor unit 568. In other alternative embodiments, the eye tracker 568 in combination with the forward-facing camera 533, determines that the user has made eye contact with the POS terminal 539. The said determination is aided if a visual code, such as a bar code or a QR code is being displayed, or alternatively being attached to the POS terminal casing as a sticker, or alternatively being printed on the POS terminal casing. Said visual code serves as an aid for identifying the POS terminal and once a POS terminal has been identified, then an address for said POS terminal may be determined. A possible address would be an Internet-accessible web service, such as a REST endpoint for example, with a unique identifier for said POS terminal. Once the POS terminal is addressable, either through transmitting modulated light to it, or alternatively by addressing it through an Internet-centric communication protocol, then embodiments may transmit the required PIN number. As a first requirement of all embodiments, the PIN has to be communicated by the user, using silent speech 543. Thus, the user is miming the typical lip movements that would be required for speaking the PIN number aloud, but the user is taking care that no sound is being produced which would be loud enough to be overheard by bystanders. So, either no sound is produced at all, which implies miming of speaking, or alternatively sound is reduced to an inaudible volume, such as whispering. Once the silent speech processor has detected a PIN number silent speech input it is transmitted to the POS terminal which has been detected in the first step. Transmission may be either direct to the POS terminal on an optical path via modulated light through the light emitter 529 or via said acquired address, typically though a REST endpoint via the Internet or via a localized Bluetooth connection directly between the head-mountable device, or a secondary device (such as a smartphone) electronically paired with the head mountable device. After input of a PIN number, a click equivalent, such as detailed in FIG. 4 may be used to confirm the input.

In another use case, a user of the head mountable embodiment may direct their gaze at an arbitrary object 538 in their field of view. By combining data received from the eye tracker 568 and the front-facing camera 533 the embodiment is capable of determining a generic type of object, such an item of merchandise, for example the depicted lamp 538, or alternatively to identify a specific object, such as a landmark or monument. In a preferred embodiment the user makes a silent speech command 544 such as “turn on” or “find on Amazon” whilst dwelling their gaze on the object, which may be followed by transmitting image data to an image-based search service, such as Google's Search by Image search service for example. The general steps that Search by Image takes to process a submitted image are:
(a) analyze image: The submitted image is analyzed to find identifiers such as colors, points, lines, and textures.
(b) generate query: These distinct features of the image are used to generate a search query.
(c) match image: The query is matched against the images in Google's back end.

In a preferred embodiment the top result from the “match image” step is then taken as the context for executing the silent speech command. So to follow through the given example, the user dwells their gaze on a lamp, which is followed by Google Images determining that the lamp is probably a particular model of lamp from a particular manufacturer, for example an “ACME model 7/11 lamp”. Therefore, the silent speech command “find on Amazon” is, in the context of this example, interpreted to mean “find [an ACME model 7/11 lamp] on Amazon [and show the query results on the paired screen device]”. An alternative use case would be the silent speech query “what is this?” and the output would be synthetic speech on a paired earphone device, speaking “an ACME model 7/11 lamp”.

When dwelling a gaze on an object, another use case of the invention is to cause an action of a specific object. It is important to note that the object does not need to be a paired, or previously known object, as would be the case in home automation. In the depicted example the lamp in question is a lamp which the user has not previously acquainted with, for example a lamp at a restaurant table. In the example the lamp is identifiable through a visual code, a QR code 570 in the example, which is picked up with camera 533. The embodiment may determine that the lamp is in the user's focus by deriving that the user's gaze is dwelling on the object. If, during a dwelling on the object, a silent speech command is uttered, such as “turn on”, then the computing unit 301 may be configured to send the command as text to a web service whereby the object identifier which has been learned from the OR code is included as an argument. After uttering a command phrase, a click equivalent, such as detailed in FIG. 4 may be used to confirm the input.

In another use case an embodiment may use silent speech to enter data into a graphical user interface of a personal computer, such as depicted at 540. The personal computer may be paired with the head mountable device, or alternatively the personal computer may be unpaired, but a visually detectable identifier is displayed 571 or attached to the personal computer or printed on the personal computer 572. In case of pairing a silent speech utterance such as “search steam engines”, for example, may be entered directly as text into an input capable field on the user interface, provided that the user's gaze 563 is dwelling on the said field. In an unpaired use case, first a visual identifier has to be picked up by the front-facing camera 533 and then a pairing from the head mountable device to the personal computer may be initiated. After input of text into a field a click equivalent, such as detailed in FIG. 4 may be used to confirm the input.

In another use case a payment for goods or services may be accomplished by first directing the user's gaze to a visual code 572 which is linked to a request for payment. The visual code may be printed, for example, on a paper slip 541 which may be produced by a POS terminal, or the visual code. Alternatively, the visual code 572 which is linked to a request for payment may be displayed on a display screen by the POS terminal, or in fact any screen device capable of displaying a payment request. So, alternative use case may involve a payment request being displayed on the user's personal computer whilst online shopping. In a silent speech enabled payment workflow, the user's gaze dwell may change from the visual code for a payment request to a means of payment, such as a credit card 546. The means of payment may be identifiable by a visual code, such as a QR code 573, or the means of payment may be optically recognized, in the sense that an optical recognition search determines that a credit card is in the hand of the user and the optical recognition is capable of visually recognizing the credit card details. A time threshold may be settable which determines an allowable time window in which the dwelling on the request for payment 564 and the dwelling on the means for payment 565 have to occur in order for a link between the payment request and means for payment to occur. Also, an explicit payment order may be made by silent speech, for example by making the utterance “pay for this [gaze dwell on payment request] with this [gaze dwell on credit card]. PIN 3456.” 546. A payment order may be explicitly confirmed by a click equivalent, such as detailed in FIG. 4.

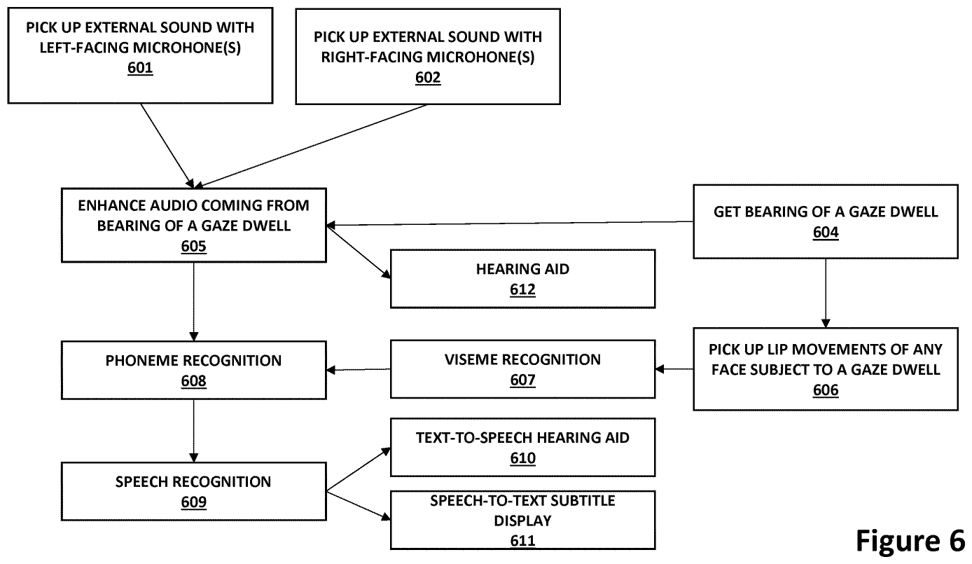

FIG. 6 depicts a flowchart of an embodiment useful for improved speech recognition precision. The use case is recognizing speech made by a third person, whereby this third person is visually observable. In a preferred embodiment a user is wearing a head mountable device, such as specified in FIG. 1, and the user is able to observe the third person with said head mountable device. A longstanding problem in the art is the difficulty to achieve reliable speech recognition in a noisy environment. Particularly in noisy environments, such as a party or a nightclub, it can be very difficult to communicate with other people due to the general ambient noise levels and the circumstance that people sometimes tend to talk over one another. This is a problem which is particularly severe for people who are hard of hearing due to hearing loss. Embodiments of the invention have solved this problem by combining acoustic speech recognition with visual speech recognition techniques, such as lip reading. Moreover, by combining speech recognition with eye tracking techniques, it becomes possible to identify which of the available speech sounds is of interest to the user and to filter out the overlaying other speech sounds. This is something why conventional hearing aids are unable to achieve because they have no knowledge of where the user is looking at and hence they are not able to discriminate individual speakers when speech is overlayed by different speakers.

This described effect may be achieved by picking up sounds with a plurality of at least two microphones. A preferred embodiment picks up sound with a left-facing microphone 601 and a right-facing microphone 602. In a preferred embodiment the left-facing microphone is located near the left ear of the user of a wearable device and the right-facing microphone is located near the right ear of a user of the device. By using eye tracking capability, the system is capable of determining eye contact with user facing camera(s) and world-facing camera(s) 603. Eye tracking allows the system to determine where the gaze of the user is dwelling. Front-facing cameras allow the system to image the area of gaze dwell. The imaged area may then be subjected to image analysis, in particular to object recognition. If the object recognition determines that a human face is being imaged, and that in particular the eye area of the human face is the subject of gaze dwell, then the system may deem that eye contact has been made with a potential speaker. Once an eye contact has been detected, then as a next step a bearing from the speaker to the potential speaker can be calculated. Certain embodiments have found it useful to express the bearing of the eye contact as the angle between the looking-straight-ahead direction of the user's head and the line going from the user's head to the center of the detected speaker's head.

In some embodiments the bearing of a gaze dwell 604 is used for audio enhancement. A gaze dwell is detectable by the eye tracking unit 381. The eye tracking unit is capable, either directly or indirectly, of providing a bearing towards a gaze dwell.

A dwell time may be used to quantify the amount of time that a user has spent looking at a particular real word object. A gaze dwell is hence defined as having occurred when a user spends an amount of dwell time, in excess of a set threshold, dwelling their gaze on a real-world object, during a set interval of time. Embodiments of the inventions have used the time spent looking a an interlocutor's face as the basis for determining whether the interlocutor is subject to a gaze dwell.

A long duration of looking at a certain region can indicate a high level of interest, while shorter duration times can indicate that other areas on the screen or in the environment might be more interesting.

With an array of microphones picking up sounds in different locations, or alternatively directional microphones, it becomes possible to selectively amplify sound coming from a certain direction, or alternatively to suppress or filter sound coming from other directions. Thus, with step 605 speech coming from the bearing of the bearing of the eye contact can be isolated, in the sense that sound coming from this bearing is amplified and/or enhanced and/or sounds coming from other bearings are being suppressed. The resulting sound is capable of being fed back to the user's earpiece as audio, such as is the use case for a novel type of hearing aid 612.

To accomplish the task of isolating speech sound coming from a particular direction, in this case the direction of the gaze dwell, arrays of multiple microphones are often used to create a directional beam that can point to a specific person and isolate their voice. The more directional the beam, the more the background noise is rejected, resulting in better isolation of the person's voice. It is possible to replace the multiple omnidirectional microphones in a traditional array with multiple directional microphones. For example, a 2-microphone omnidirectional broadside array can be replaced by a broadside array of 2 directional microphones. Likewise the broadside beamformer, an alternative 2-microphone omnidirectional endfire array can be replaced by an endfire array of 2 directional microphones. When using omnidirectional microphones in arrays, there is a fundamental tradeoff between signal to noise ratio (SNR) and directivity. If a high SNR is needed, a broadside beamformer can be used with limited directionality. Otherwise, for applications with substantial noise or reverb, a differential endfire beamformer can be used to provide more directionality, at the expense of reduced SNR and thus audio quality. Further, due to aliasing effects, only a limited bandwidth of directionality can be achieved. Exemplary embodiments have used two Sanskrit AN-300 directional microphones to realize microphones 585 and 586.

Unlike traditional omnidirectional microphones, directional microphones have two sound ports. In an exemplary embodiment each sound port was coupled to a sound port in the casing of either the ear-mountable device or in the head-mountable device. In a preferred embodiment the through-hole sound port configuration was used since it provides the best directional microphone performance compared to the alternative V-configuration or L-configuration of sound ports.

In order to isolate a source of speech at a given bearing, coinciding with the direction of a gaze dwell, from signals received from the array of microphone, a step sound processing may be required. Exemplary embodiments have used techniques for beamforming, whereas beamforming is the art of separating sounds according to their direction of incidence. Separation of signals along distance was not attempted for the preferred embodiment and, therefore, beamforming can consider a simplified form of Eq. (1) by removing the terms related to the sound source distance. Alternatively, a reference distance r_{ref} can be used as long as this is large compared to the sound source wavelength.

$${p}_{m i c} ( k , \vec{{r}_{s c}} ) = {p}_{s r c} ( k ) {\sum }_{n = 0}^{∞} ( 2 n + 1 ) \frac{{h}_{n} ( k {r}_{s r c} )}{{h}_{n}^{′} ( {kr}_{m i c} )} {P}_{n} ( \frac{\vec{{r}_{m ι c}} \cdot \vec{{r}_{s r c}}}{\vert \vec{{r}_{m ι c}} \vert \vert \vec{{r}_{s r c}} \vert} ) \qquad ( Eq . 1 )$$

In Eq. (1), p_{mic} stands for the sound pressure observed at a point \vec{r_{mιc}} on the rigid sphere. A single point source of amplitude p_{src} is assumed to be located at \vec{r_{src}}. Functions hₙ and Pₙ are, respectively, the spherical Hankel functions and the Legendre polynomials, both of order n. Primed symbols are used to denote function derivatives.

A simple approach to beamforming is to consider a desired directivity pattern D(Θ,φ). The target directivity is sampled at a representative set of angles and the sound pressures expected to be observed at each of the microphones due to a sound source at each of the sampled directions is calculated. The recordings for all microphones can then be combined into a single signal approximating the target directivity using Eq. (2).

$${P}_{beam} = [ \begin{matrix}{D}_{1} & {D}_{2} & ⋯ & {D}_{a}\end{matrix} ] [ \begin{matrix}{p}_{1 \to 1} & {p}_{2 \to 1} & ⋯ & {p}_{a \to 1} \\ {p}_{1 \to 2} & {p}_{2 \to 2} & ⋯ & {p}_{a \to 2} \\ ⋮ & ⋮ & ⋱ & ⋮ \\ {p}_{1 \to b} & b & ⋯ & {p}_{a \to b}\end{matrix} ] \qquad ( Eq . 2 )$$

In Eq. (2) a total of a sample directions [D₁ D₂ . . . Dₐ] are sampled using an array of b microphones. In a preferred embodiment exactly 2 external microphones are used. The actual microphone recordings are represented by p₁, . . . , p_{b}, while the ideal sound pressure expected at a given microphone i in the presence of a single sound source at direction j is written as p_{j→i}. This is calculated using Eq. (1) or its plane-wave equivalent. The symbol |⋅|⁺ denotes a matrix inversion, typically a pseudoinverse.

Conventional beamforming using a single microphone array can isolate sounds that originate from a given direction. It, however, cannot separate multiple sources when they are aligned. The problem is hard to overcome since compact arrays can only sample the sound field from a single viewpoint. It is possible, however, to use multiple compact arrays, that is, an array-of arrays to isolate sounds originating from a specific position in space. The preferred embodiment is not affected by this restriction, since a bearing to the speaker is derived from the detected gaze dwell. Hence distance to the speaker is not a factor for this embodiment. Other exemplary embodiments, however, are configured to derive not only a bearing, but also a distance from to interlocutor's face which is subject to a gaze dwell. Once the distance is known, then it becomes possible for these embodiments to isolate the speech of one speaker, even if there are other speaker are positioned in essentially the same bearing, but at different distances.

In a different use case, the enhanced audio which is coming from the bearing of the gaze dwell 605 is subsequently fed into a dual source phoneme recognition step, whereby the second source is a feed of probable phonemes which have been detected by a viseme recognition step 607. Step 606 may thus pick up lip movements of any face which is the subject of a gaze dwell by the user of the device. Once a bearing to a gaze dwell has been detected, then an image analysis from an image captured by the world-facing camera may yield a face having been detected in the direction of the gaze dwell. In order to detect faces, embodiments have used the face-recognition 1.3.0 Python library using dlib's face recognition built with deep learning. The model has an accuracy of 99.38% on the Labeled Faces in the Wild benchmark. Other face recognition algorithms may be used alternatively.

The viseme recognition step 607, in turn is preceded by step for picking up lip movements of the speaker who is being identified by a face being visually detected in direction of the bearing of a gaze dwell, whereas the gaze dwell may be detected in the preceding step 604. Thus, the phoneme recognition step is novel, in part, because phoneme recognition is both audio-derived and visually disambiguated with visemes derived from the lip movements of an algorithmically detected speaker. Phoneme recognition 608 may be followed by a speech recognition step 609, which is the step where language modelling is applied to translate the sequence of phonemes into text. The resulting text, in turn, may be translated to speech which may then be fed into an earpiece worn by the user, such as is the use case for a text-to-speech hearing aid 610, i.e. a novel type of hearing aid, whereby the user primarily hears audio resulting from synthetic speech of a speaker whereby the speaker has been determined to be the subject of a gaze dwell and whereby the speech from the speaker has undergone at least one cycle to speech-to-text and text-to-speech digital processing.

Hence a text-to-speech hearing aid would be characterized by the steps of: recognizing a speech made the subject of the detected gaze dwell in such a way that the speech is transcribed into text, performing a text-to-speech conversion of said text, wherein said conversion is resulting in a synthetic speech and outputting said synthetic speech on a wearable device, wherein said wearable device is worn by said user.

In another use case, an embodiment may display the resulting text from the speech recognition step 609 visually. In a preferred embodiment, the speech uttered by a speaker who is subject to a gaze dwell is displayed as subtitles 611 on a display which is integrated with the head mountable device.

Hence a subtitle type of hearing aid may be characterized by the following steps: recognizing a speech made the subject of the detected gaze dwell in such a way that the speech is transcribed into text and outputting said text on a subtitle display in augmented reality.

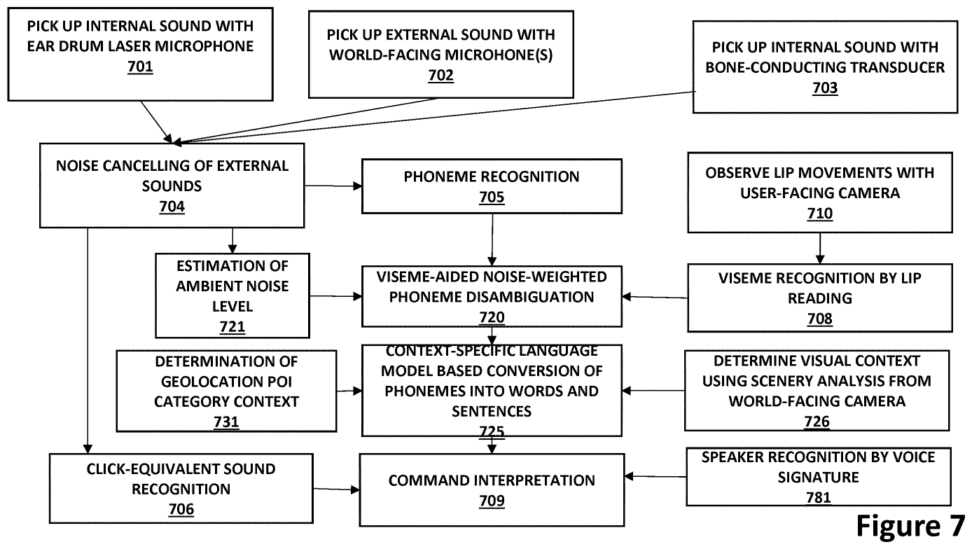

FIG. 7 details another use case of embodiments of the present invention. In the flow chart of FIG. 7 sounds are being picked up with a plurality of microphones, either microphone in different locations and/or directional microphones. The embodiments may comprises microphones configured for picking up body-external sounds and microphones configures for picking up body-internal sounds, whereby the body-internal sounds are those which are relevant for the silent speech signal and body-external sounds are noise which needs to be filtered in order to reveal the silent speech signal. In one embodiment internal sounds are picked up with an ear drum laser microphone 701 and/or a bone conducting transducer 703 whilst external sounds are picked up with one or more world-facing microphones 702. By having separate audio feeds of internal and external microphones, the external sounds are able to be subjected to noise cancelling 704, which leaves the internal sounds as the signal whilst suppressing the external sounds. From the noise-cancelled internal sound audio feed a step of phoneme recognition 705 may be executed. The result of the phoneme recognition step may be ambiguous in the sense that there may me a plurality of possible phonemes at any given time and that a disambiguation is necessary in subsequent steps. The inventor has realized that as an inventive departure from the prior art it is desirable to augment audio-based phoneme recognition with a novel type of viseme recognition. Visemes are the visual equivalent of phonemes. Although not precisely defined in the art, the inventors have adopted a working definition of a viseme being a set of phonemes which have identical appearance on the lips. Therefore, a phoneme maps to exactly one viseme but a viseme may represent many phonemes: a many to one mapping. In order to be able to perform visual phoneme recognition lip movements of the user have to be picked up by a user facing camera in one step 710. In the next step viseme recognition by lip reading 708 is performed. Following the noise cancellation step 704 it becomes possible to estimate the general level of ambient noise 721. Ambient noise may be estimated by comparing a baseline of the volume of the external sound to a baseline of the volume of the internal sound. Other methods of estimating a level of ambient noise are known in the art. Next may be a step 720, a viseme-aided noise-weighted phoneme disambiguation, taking as input an estimation of noise level from step 721 and a stream of recognized visemes 708. Step 720 may make use of preconfigured viseme-to-phoneme mapping tables to determine whether a phoneme detected at a point on the time axis is compatible with the viseme detected at the same time. If it is not compatible, then the system may check whether another candidate phoneme is compatible the detected viseme. As a result, there may be a plurality of phonemes which are compatible with the detected viseme at any given time. The system may choose to given either the visual phoneme disambiguation (i.e. viseme based) or the audio based phoneme disambiguation greater weight, based on an estimation of noise. Increased weight may hence be assigned to visual-based phoneme recognition over audio-based phoneme recognition when the ambient noise level increases. In a very noisy environment, a higher weight may be given to viseme-based disambiguation, which is because phoneme recognition is more unreliable in noisy environments, whereas noise is not a factor in viseme detection. Hence the noisier the environment the less weight may be given to audio-based phoneme disambiguation and the more weight may be given to visual-based phoneme disambiguation.

Next may be a step of context-specific language model-based conversion of the disambiguated phonemes into words and sentences 725 with a novel combination of input from both a determined geolocation context 731 and a determined visual context using scenery analysis from one or more word-facing cameras 726. The visual scenery analysis may be performed using an imaged based search of video stills from a world-facing camera, such as interfacing via a web service the automatic image description feature called Get Image Descriptions from Google in one embodiment. Such embodiment may return a textual description of the real world scenery the user is immersed in. As an example, the user may be standing at a market stall and the textual description received from the web service may be “Fruits and vegetables at the market”. A keyword matching may be performed in step 725, whereby a match may be found with a context-specific language model “fruits and vegetables” or “market”, for example.

Hence a context-specific language model may be found by capturing an image with a world-facing camera, querying an image description service for a textual description of said image, mapping the textual description to a category, and searching for a language model which is associated with said category. Concerning the mapping of a textual description to a category, this may be achieved by using a keyword lookup, wherein each category may be associated with one or more keywords. For example, if the textual description is “Fruits and vegetables at the market” and a category is “shopping”, then there may be a lookup table which associated the category “shopping” with the keyword “market”. Since the textual description comprises the keyword “market”, an association may therefore be made between that textual description and the context-specific language model which is associated with the category “shopping”. In order to practice the invention other methods known in the art may related to mapping an image to a category may be used also.

The context-specific language model may also be selected, in step 725, based on the detected geolocation. For example, if the geolocation of the user has been detected to coincide with the point of interest (POI) “McDonalds Restaurant, Mayfair, London, England”, then a category matching with the POI category 731 may yield a context-specific language models, for example a “restaurant” POI category may match with a “restaurant” language model which may be a language model which is optimized for detecting language typically used when interacting with restaurant staff.

Hence a context-specific language model may be selected by determining a geolocation of a user, determining one or more points-of-interest at said geolocation, determining one or more categories of said points-of-interest and searching for a language model which is associated with one or more of these categories.

The recognized words and sentences from step 725 may subsequently be fed to the command interpreter 709. Also fed into the command interpreter may be an output from an optional speaker recognition step 781. In an exemplary embodiment a recognized silent speech command is only executed if the speaker can be authenticated via their voice signature. Such speaker identification may be text-independent, in the sense that there are no restrictions on what the speaker says in the audio. The speaker's voice may be recorded in an enrollment phase, whereby the voice features are extracted to form a unique voice signature for the user. In a speaker identification step, the input voice sample may be compared to a list of enrolled voices. In an exemplary embodiment the Microsoft Azure Speech Service was used to provide speaker-identification services. Other embodiments have used a visual speaker identification, as opposed to an audio-based speaker identification, such as when using a user-facing camera to identify the speaker using face recognition. It is also possible to use biometric speaker recognition. The inventor has realized that audio-based speaker identification, when coupled with silent speech may be the most secure way of issuing and authenticating a command in a crowded place. Other possible authentication methods suffer from the drawbacks that they may be either observable by malicious onlookers or interlocutors, or that it is unknowable if the input has been made by a live user, as would be the case with fingerprints, for example, which can simply be copied.

Also, the noise-cancelled stream of head-internal sounds 704 may be fed to a step of click-equivalent sound recognition 706, i.e. sounds made by touching the roof of the mouth or the front teeth with the tongue, or a faint clattering of teeth. These detected click-equivalent sounds may also be fed to the command interpretation engine in step 709.

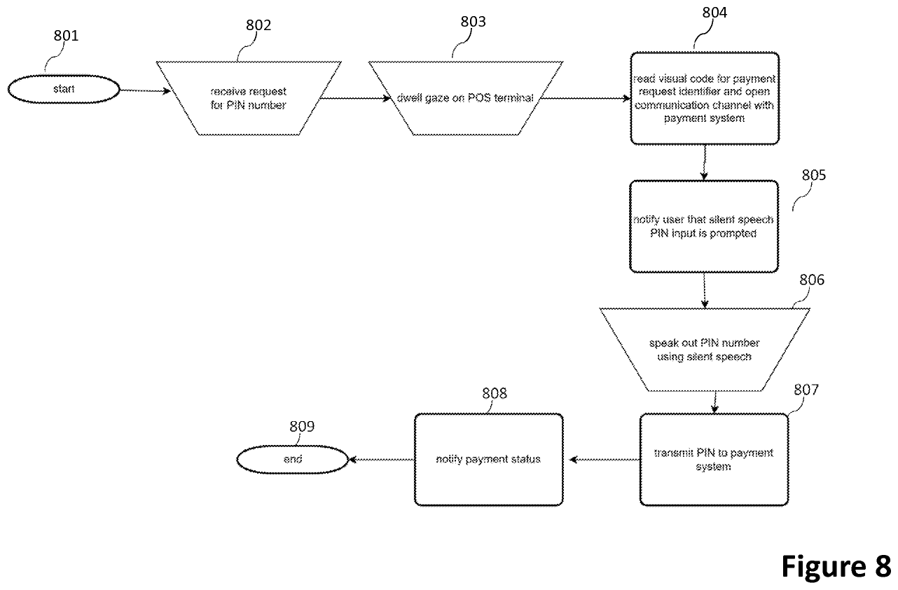

FIG. 8 is a flow chart depicting a workflow for an embodiment which is entering confidential information, such as a PIN number, during a shop purchase for example. The workflow starts at 801 with the user receiving a request for entering a PIN (personal identification number) 802, such as a PIN used for a credit or debit card for example. A next step may be that the user dwells their gaze on the display of the POS terminal 803. As a next step the system may read, with a word-facing camera, a visual code for a payment request identifier and use that identifier to open a communication channel with the payment system 804. As a next step the user may be notified that silent speech PIN input is prompted. The user may then speak out the PIN number with silent speech 806. The system may then transmit the PIN to the payment system 807 and the workflow may be ended 809 with the system notifying the user of the payment status.

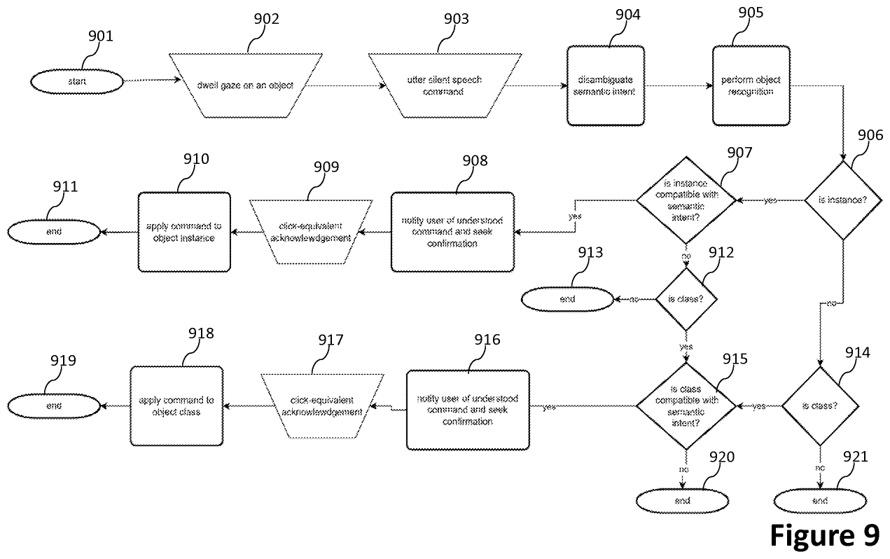

FIG. 9 is a flow chart depicting a workflow for an embodiment which is using a silent speech enabled head-mounted augmented reality device for issuing object related commands, for example “find me one of these on Amazon”, “switch it on”, “tell me what this is called and which year it was built”. This is a type of use case particularly useful for silent speech because augmented reality in a public place usually implies that the user wants to operate in a hands free mode, but at the same time is hesitant to use regular speech input because the user is either too embarrassed to be overheard by the public, or the speech command are too confidential for them to be spoken out aloud in a public place. The workflow starts at 901 with a gaze dwell on an object 902. While gaze dwelling on an object, a silent speech command may be uttered by the user 903. Semantic intent may be defined as being the meaning behind a user input, in the sense of what a user intends to happen in response to them uttering a certain speech input. Semantic intent may be ambiguous, in the one sense that there may be a many-to-one mapping between an utterance and a semantic intent and in the sense that one utterance may potentially apply to a plurality of possible semantic intents, and it is therefore unclear which is the semantic intent which the user had in mind when they made the utterance. Therefore, as a next step the system may attempt to disambiguate the semantic intent of silent speech command 904. Disambiguation of semantic intent may be defined as mapping the received silent speech command to a pre-defined set of possible commands. As a next step object recognition may be performed 905. This step may involve an image search of an image which corresponds to the user's gaze dwell. The image-based search may be of a type which is able to distinguish whether the imaged object is an instance or a class. An instance in this context may be defined as an identifiable specific object for which an object automation interface can be accessed. If, for example, the user is imaging a car, which the object recognition step determines to be the user's own car, then the decision step 906 “is instance?” will be classed as “yes”. If on the other hand the object recognition deems to object to be a previously unknown car of a certain model and manufacturer, then the decision step 914 “is class?” would return “yes”. As class in this context is defined as a generic group of objects that has the same characteristics or properties. If the imaged object cannot be resolved to either a class or an object, then the workflow fails and ends 921. An instance may be checked whether it is compatible with semantic intent 907. As an example, if the user looks at their own car and commands “tell me how much is one of these”, then the semantic intent is clearly incompatible with an instance, in which case a decision is made based on whether the object is also recognized as a class 912. As an example, if the user is looking at their own car, then the system needs to be able to know the generic make and model of the car. If that is the case the decision follows the “yes” route and may arrive at a following decision step “is class compatible with semantic intent?”. Otherwise, the flow ends at 913. If the class is not compatible with the semantic intent, then the flow ends likewise at 920. An example a class not being compatible with semantic intent would be “Tell me today's opening hours” when looking at an object which is recognized as a car. If a class or an object compatible with semantic intent, then the following two steps may be the same for both, namely a notification to the user what command has been understood and an (optional) request to confirm the command. This applies to 908 (notify user of understood command and seek confirmation) and 909 (click-equivalent acknowledgement) for instances and 916 (notify user of understood command and seek confirmation) and 917 (click-equivalent acknowledgement) for classes. An example for these steps, for an instance, would be a silent speech command “turn the heater on” when looking at their own car, which would be followed by the notification “You want me to switch on your car's standby heater for 30 minutes?”. An example for these steps, for a class, would be a silent speech command “tell me how much one of these costs” when looking at a previously unknown car in a car park, which would be followed by the notification “You want me to find out how much a Merecedes 200D is listed for on AutoTrader?”. The instance-related branch ends at 911 after the command has been applied to the object instance 910, usually through Internet-of-things (IOT) mediated automation. The class related branch ends at 919 after the command has been applied to the object class 918, usually through a search engine type query.

### Additional Embodiments: Ear-Worn Contextual Companion Platform

In further embodiments, the inventions described herein may be implemented as, or extended into, an ear-worn contextual companion platform 1001. In such embodiments, an ear-worn device 1014, such as a left ear-worn device 1010, a right ear-worn device 1012, an earbud, smart earplug, hearing-aid-type device, hearable device, headphone, or other earpiece, may provide a socially accepted and substantially private interface between a user 1000 and a computerized assistant system. The ear-worn device 1014 may combine one or more of silent or low-audibility user input 1200, contextual sensing, head-motion sensing, private audio output, wireless communication, authentication, and distributed processing with one or more companion devices or remote computing systems.

In one embodiment, the ear-worn device 1014 may comprise a housing 1016, an ear speaker or private output transducer 1018, one or more outward microphones 1020, one or more inward microphones 1022, one or more bone-conduction, cartilage-conduction, vibration, or body-conducted-signal sensors 1024, one or more silent-speech sensors 1026, one or more optical or infrared or near-infrared sensors 1030, one or more inertial measurement units or head-motion sensors 1040, one or more processors 1042, memory 1044, one or more wireless interfaces 1046, one or more authentication sensors or authentication modules 1048, and a battery or power unit 1050. These components may be distributed across the left ear-worn device 1010, the right ear-worn device 1012, a companion handheld device 1060, a companion wrist-worn device 1062, a companion head-mounted device 1064, or a remote assistant system 1066 accessible over a network connection 1068.

The inventor has realized that an ear-worn form factor is uniquely advantageous for a contextual assistant because it is lightweight, commonly worn in public, socially unobtrusive, and capable of outputting information privately to the user 1000. Unlike a head-mounted display or smart glasses, the ear-worn device 1014 does not necessarily signal to surrounding persons that contextual sensing or contextual analysis is occurring. At the same time, the ear-worn position is well suited for collecting contextual information because the ear-worn device 1014 moves with the head of the user 1000 and is therefore naturally swept through different orientations during ordinary use.

Such ordinary use may include walking, turning toward speakers, looking around a room, scanning signs, facing a display, looking at a menu, turning toward a vehicle, orienting toward a person, moving through a restaurant, entering or leaving a transport station, looking toward a payment terminal, passing a doorway, reacting to a sound, or participating in a social conversation. During these ordinary activities, one or more optical or infrared sensors 1030, microphones 1020, 1022, inertial measurement units 1040, or other sensors of the ear-worn device 1014 may obtain sensor observations associated with the surroundings of the user 1000.

Accordingly, in some embodiments, the ear-worn device 1014 may serve as a contextual sensor node for a personal assistant system. The ear-worn device 1014 need not provide a conventional photographic or video-recording camera. Instead, the ear-worn device 1014 may include one or more optical, infrared, depth, event-based, low-resolution, non-photographic, or other environmental sensors 1030 configured to generate image-derived, spatial, motion-derived, object-derived, person-derived, text-derived, gesture-derived, acoustic-associated, or environmental features. Such features may be processed locally by processor 1042, by the companion handheld device 1060, by the companion wrist-worn device 1062, by the companion head-mounted device 1064, by the remote assistant system 1066, or by a combination of such devices.

In some embodiments, the ear-worn device 1014 may obtain temporally separated observations 1112 over time as a head orientation of the user 1000 changes. The system may combine the temporally separated observations 1112 with head-orientation information 1116, inertial information from the inertial measurement unit 1040, acoustic information from microphones 1020, 1022, location information, application context, user-specific context, or other contextual information to generate or update a contextual representation 1120 of the surroundings of the user 1000. The contextual representation 1120 may comprise one or more candidate referents 1122.

Candidate referents 1122 may include persons, objects, signs, menus, text-bearing objects, vehicles, personal items, doors, payment terminals, user-interface elements, displayed content items, locations, devices, known contacts, previously observed entities, events, hazards, or other entities or situations that may be relevant to a user command, query, warning, assistant operation, or proactive intervention. In some embodiments, the candidate referents 1122 may include a candidate person referent 1124, a candidate object referent 1126, a candidate text-bearing referent 1128, a candidate vehicle or hazard referent 1130, or a referent outside a current field of view 1136 of the optical or infrared sensor 1030.

The inventor has further realized that a contextual assistant does not always need to observe a candidate referent 1122 at the exact time at which the user 1000 refers to it. In ordinary life, the head of the user 1000 is not stationary. Natural head movements may cause the optical or infrared sensor 1030 of the ear-worn device 1014 to acquire temporally separated observations 1112 of different portions of the surroundings of the user 1000. These temporally separated observations 1112 may be associated with head-orientation information 1116, time, direction, location, confidence values 1138, object class, identity, text content, actionability, or other metadata. As a result, the system may maintain the contextual representation 1120 as a rolling contextual representation, spatial representation, semantic map, scene graph, environmental memory, candidate-referent store, or spatially indexed context cache 1132.

A later silent or low-audibility user input 1200 may then be resolved to a selected candidate referent 1210 that was previously observed, even when the selected candidate referent 1210 is not currently within an instantaneous sensor field of view 1110 of the optical or infrared sensor 1030. For example, the user 1000 may briefly turn toward a sign, menu, person, vehicle, door, display, payment terminal, or other object. The optical or infrared sensor 1030 may acquire one or more temporally separated observations 1112 sufficient to generate features associated with that object or person. The system may store the object or person as a candidate referent 1122 in the contextual representation 1120. Thereafter, the user 1000 may silently or quietly utter a command or query, such as “translate that,” “who is that,” “open it,” “pay for this,” “call him,” “get me there,” “read that,” or “what does that say.” The system may determine that the silent or low-audibility user input 1200 comprises a semantic objective 1204 that is incomplete without identifying a referent. The system may then use a referent resolver 1208 to select one or more candidate referents 1122 from the contextual representation 1120 and complete the semantic objective 1204 by associating the selected candidate referent 1210 with the semantic objective 1204.

In some embodiments, the contextual representation 1120 may cover an angular range greater than the instantaneous sensor field of view 1110 of any one optical or infrared sensor 1030 of the ear-worn device 1014. This may occur because temporally separated observations 1112 obtained during a head sweep path 1114 are combined into a rolling representation of the surroundings of the user 1000. Thus, even the optical or infrared sensor 1030 with a limited instantaneous sensor field of view 1110 may contribute to broader contextual awareness over a preceding time window 1134. The preceding time window 1134 may be short, such as less than one second, several seconds, tens of seconds, minutes, or longer, depending on the use case, available memory, privacy settings, power budget, and confidence level.

In some embodiments, a current head orientation, motion, gesture, utterance content, acoustic scene, application state, location, time, user history, or other context may be compared with the contextual representation 1120 to select the selected candidate referent 1210. Selection may be based on one or more confidence values 1138. Such confidence values 1138 may be based on recency of observation, duration of observation, head orientation, apparent attention direction, semantic compatibility between the semantic objective 1204 and the candidate referent 1122, object class, person identity, actionability, proximity, trajectory, visual saliency, acoustic relevance, relationship to the user 1000, location context, application context, or previous user behavior.

In some embodiments, the ear-worn contextual companion platform 1001 may operate in a reactive mode 1300. In the reactive mode 1300, the user 1000 provides the silent or low-audibility user input 1200, and the system determines the semantic objective 1204 from the input. The silent or low-audibility user input 1200 may be silent, subvocal, whispered, mouthed, low-audibility, or otherwise minimally expressed speech or sound. The system may then ground the semantic objective 1204 using the contextual representation 1120 and cause an assistant operation 1214. The assistant operation 1214 may include answering a question, identifying a person, translating text or speech, reading a sign, summarizing content, selecting a navigation route, initiating payment, sending a message, placing a call, controlling a device, searching for information, generating a conversational prompt, or performing another action.

In some embodiments, the ear-worn contextual companion platform 1001 may operate in a proactive mode 1302. In the proactive mode 1302, the system may detect a user-relevant condition 1304 without receiving a contemporaneous command from the user 1000. The user-relevant condition 1304 may include a safety risk, an alert condition 1306, an approaching person, an approaching vehicle, a left-behind object, a route deviation, an unsafe route, an approaching known contact, a translation opportunity, a remembered obligation, an emotionally significant notification, a payment risk, a communication risk, a transportation need, or another condition that may be relevant to the user 1000. The system may generate a private alert, prompt, explanation, recommendation, or action proposal 1308 and output it as a private prompt or private output 1216 through the ear speaker or private output transducer 1018.

In some embodiments, assistant information may be output privately through the ear-worn device 1014 as a private assistant output 1070 in a manner perceptible to the user 1000 and not perceptible to one or more nearby persons. The private assistant output 1070 may comprise synthetic speech, whispered audio, spatial audio, a tone, a haptic indication, or another private output. In other embodiments, the assistant operation 1214 may also include public companion-device output 1072, such as outputting translated speech through the companion handheld device 1060, transmitting generated speech to a remote participant in a communication session, displaying information on a paired display, or initiating an external service.

In some embodiments, the ear-worn contextual companion platform 1001 may select one of a plurality of assistant services using an assistant service selector 1212 based on the semantic objective 1204 and the contextual representation 1120, without requiring the user 1000 to explicitly select an application. Such assistant services may include translation, navigation, messaging, calling, payment, contact identification, calendar access, ride-hailing, emergency assistance, evidence preservation, device control, search, note-taking, or other services. Thus, the user 1000 may express an objective, while the system determines which service or combination of services is appropriate in view of the contextual representation 1120.

In some embodiments, the ear-worn contextual companion platform 1001 may maintain a longitudinal user-specific context 1600. The longitudinal user-specific context 1600 may include preferences, trusted contact data 1606, prior interactions, relationship data 1602, safety policy 1604, payment settings, communication style profile 1608, prior support outcome data 1610, frequently visited locations, calendar information, message history, or other permissioned user-specific information. The longitudinal user-specific context 1600 may be used to select the selected candidate referent 1210, disambiguate the semantic objective 1204, select an assistant service, determine whether the user-relevant condition 1304 should be generated, select an intervention level 1310, select a tone or urgency level of the private assistant output 1070, or decide whether to request user confirmation 1218 before an action is performed.

The ear-worn contextual companion platform 1001 may be implemented as a distributed system. One or more ear-worn devices 1014 may obtain sensor data and provide private output. The companion handheld device 1060, companion wrist-worn device 1062, companion head-mounted device 1064, vehicle system, or remote assistant system 1066 may perform one or more processing steps. Processing may include feature extraction, speech recognition, silent-speech recognition, language modeling, object recognition, person recognition, text recognition, scene analysis, contextual mapping, referent resolution, confidence scoring, service selection, user authentication, encryption, evidence preservation, or generation of private assistant output 1070. The distribution of processing among devices may depend on power, latency, privacy, connectivity, security, or computational requirements.

The embodiments described in this section may be combined with any silent speech, silent sound, click-equivalent, speech recognition, speaker recognition, viseme recognition, gaze-based, object-recognition, payment, hearing-aid, or wearable-device embodiments described elsewhere herein. In particular, the silent or low-audibility user input 1200 described in this section may be implemented using the silent speech input structures described elsewhere herein, and the ear speaker or private output transducer 1018 may be implemented using the ear speaker described elsewhere herein. The contextual representation 1120 described in this section may provide additional context for disambiguating the semantic objective 1204 of such silent or low-audibility user input 1200.

In some embodiments, the ear-worn device may avoid storing raw optical images by converting the sensor data into feature vectors, embeddings, classifications, bounding regions, optical-flow fields, object identifiers, text strings, confidence values, or other derived data. Raw optical data may be discarded after feature extraction unless a user command, alert condition, evidence-preservation condition, debugging setting, or other retention condition is satisfied. In some embodiments, raw optical data may never leave the ear-worn device. In other embodiments, selected derived features may be transmitted to a companion device or remote service for further processing.

In a presently preferred embodiment, the ear-worn contextual companion platform 1001 comprises a left ear-worn device 1010 and a right ear-worn device 1012, each being an example of an ear-worn device 1014. Each ear-worn device 1014 may comprise at least one optical or infrared sensor 1030, an inertial measurement unit or head-motion sensor 1040, one or more outward microphones 1020, one or more inward microphones 1022, one or more bone-conduction, cartilage-conduction, vibration, or body-conducted-signal sensors 1024, one or more silent-speech sensors 1026, an ear speaker or private output transducer 1018, a wireless interface 1046, memory 1044, a processor 1042, an authentication sensor or module 1048, and a battery or power unit 1050.

In the presently preferred embodiment, the optical or infrared sensors 1030 acquire temporally separated observations 1112 during natural head movement of the user 1000. The inertial measurement units or head-motion sensors 1040 provide head-orientation information 1116, which is used to associate the temporally separated observations 1112 with corresponding head orientations, times, directions, or spatial regions. The system thereby generates or updates a rolling contextual representation 1120 comprising candidate referents 1122 in the surroundings of the user 1000. The contextual representation 1120 may include candidate person referents 1124, candidate object referents 1126, candidate text-bearing referents 1128, candidate vehicle or hazard referents 1130, and referents outside a current field of view 1136 of the optical or infrared sensor 1030.

In the presently preferred embodiment, the ear-worn devices 1014 perform at least initial sensing, signal acquisition, private output, wireless communication, and authentication functions. A companion handheld device 1060 performs at least some higher-level processing, including maintaining at least part of the contextual representation 1120, referent resolution by referent resolver 1208, assistant service selection by assistant service selector 1212, translation processing by translation processor 1402, context-disambiguation processing by context-disambiguation processor 1404, communication-session support, privacy management, and interaction with one or more assistant services. In other embodiments, such processing may be performed by the processor 1042 of the ear-worn device 1014, the companion wrist-worn device 1062, the companion head-mounted device 1064, the remote assistant system 1066, or a combination thereof.

In the presently preferred embodiment, the user 1000 may provide silent or low-audibility user input 1200 through the silent-speech sensors 1026, inward microphones 1022, outward microphones 1020, sensors 1024, optical or infrared sensors 1030, inertial measurement units 1040, or a combination thereof. The silent speech processor 1202 determines a semantic objective 1204 from the silent or low-audibility user input 1200. Where the semantic objective 1204 requires contextual grounding, the referent resolver 1208 selects a selected candidate referent 1210 from the contextual representation 1120. The assistant service selector 1212 then selects an assistant operation 1214, and the ear speaker or private output transducer 1018 outputs private assistant output 1070 to the user 1000.

In the presently preferred embodiment, raw optical or infrared data is converted into derived contextual features where possible. Such derived contextual features may include object labels, person features, text strings, optical-flow features, depth features, gesture features, trajectory data, confidence values 1138, or contextual embeddings. Raw optical or infrared data may be discarded after feature extraction unless a user command, user confirmation 1218, alert condition 1306, evidence preservation action 1316, or other retention condition applies. Sensitive operations, including generated user-voice audio 1512, payment, trusted-contact action 1312, transportation action 1314, evidence preservation action 1316, public companion-device output 1072, or disclosure of longitudinal user-specific context 1600, may require wearer authentication 1502, articulation biometric 1504, companion-device authentication, user confirmation 1218, or another authorization mechanism.

### Ear-Worn Optical and Infrared Contextual Sensing

In some embodiments, the ear-worn contextual companion platform 1001 comprises one or more optical or infrared sensors 1030 carried by an ear-worn device 1014. The term optical or infrared sensor 1030 is used broadly herein and is not limited to a conventional camera. An optical or infrared sensor 1030 may include, without limitation, an infrared sensor, near-infrared sensor, visible-light sensor, low-resolution image sensor, event-based sensor, dynamic vision sensor, depth sensor, time-of-flight sensor, structured-light receiver, structured-light sensor, optical-flow sensor, fisheye sensor, wide-angle sensor, proximity sensor, light-field sensor, photodiode array, or other sensor capable of generating information derived from light, reflected light, emitted light, depth, motion, spatial structure, image features, or environmental features.

In some embodiments, the optical or infrared sensor 1030 is configured to generate machine-interpretable sensor data rather than human-viewable photographs or video. For example, the optical or infrared sensor 1030 may generate image-derived features, optical-flow features, spatial features, depth features, object features, person features, text-region features, gesture features, scene features, motion features, landmark features, contextual embeddings, or other intermediate representations. In such embodiments, the processor 1042, companion handheld device 1060, companion wrist-worn device 1062, companion head-mounted device 1064, remote assistant system 1066, or a combination thereof may process the optical or infrared sensor data without storing or displaying a conventional photographic image.

In some embodiments, the ear-worn device 1014 may comprise an infrared emitter or illumination source 1036. The infrared emitter or illumination source 1036 may include a near-infrared light emitting diode, infrared light emitting diode, vertical-cavity surface-emitting laser, structured-light projector, pulsed illumination source, dot projector, flood illuminator, or other light emitter. The emitted light may be invisible or substantially invisible to the human eye. The emitted light may be used to improve sensing in low-light environments, determine depth, detect motion, detect proximity, identify surfaces, detect hand gestures, detect facial or mouth movement, support optical-flow estimation, support text detection, support person detection, or support contextual mapping.

The optical or infrared sensor 1030 may be positioned at any suitable location on or in the housing 1016 of the ear-worn device 1014. In some embodiments, the optical or infrared sensor 1030 is outward-facing, in the sense that it is oriented at least partly away from the ear or head of the user 1000 and toward the surrounding environment. In other embodiments, the optical or infrared sensor 1030 is side-facing, rear-oblique, forward-oblique, downward-facing, upward-facing, or oriented toward a region near the cheek, jaw, mouth, neck, hand, shoulder, or torso of the user 1000. In further embodiments, the ear-worn device 1014 may comprise a plurality of optical or infrared sensors 1030 with different orientations.

In one embodiment, a first optical or infrared sensor 1032 may be configured primarily for environmental sensing, while a second optical or infrared sensor 1034 may be configured primarily for detecting mouth, jaw, cheek, neck, hand, or other body movement associated with silent or low-audibility user input 1200. In another embodiment, the first optical or infrared sensor 1032 may be outward-facing and the second optical or infrared sensor 1034 may be oblique or downward-facing. In another embodiment, the first optical or infrared sensor 1032 may be provided on the left ear-worn device 1010, while the second optical or infrared sensor 1034 may be provided on the right ear-worn device 1012.

In some embodiments, the left ear-worn device 1010 and the right ear-worn device 1012 may each comprise one or more optical or infrared sensors 1030. The left and right optical or infrared sensors 1030 may provide different viewing angles, different occlusion conditions, different baselines, different illumination conditions, or different fields of observation. The processor 1042 or another processor may select data from one of the sensors, combine data from both sensors, or select whichever sensor has a clearer view of a candidate referent 1122, gesture, text-bearing object, person, vehicle, sign, menu, payment terminal, display, or other contextual feature.

In some embodiments, the left ear-worn device 1010 and the right ear-worn device 1012 may provide stereo, differential, triangulation, parallax, or time-offset information. In other embodiments, the left and right ear-worn devices 1010, 1012 may increase the probability that at least one optical or infrared sensor 1030 obtains a usable observation of a relevant object, person, text, event, or hazard. For example, when the user 1000 turns the head, one ear-worn device may obtain a clearer view of a sign, person, menu, hand gesture, payment terminal, vehicle, or approaching object than the other ear-worn device.

In some embodiments, the optical or infrared sensor 1030 has a wide-angle or fisheye field of view. Such a field of view may be advantageous because the ear-worn device 1014 is not necessarily positioned on a central visual axis of the user 1000. A wide-angle or fisheye sensor may capture peripheral environmental information, persons approaching from a side direction, vehicles or bicycles approaching from behind or oblique directions, hand gestures near the face, objects on a table, signs, menus, displays, doors, payment terminals, personal items, or other contextual features. In other embodiments, narrower field-of-view sensors may be used, especially where the sensor is intended to capture specific regions such as the mouth, cheek, jaw, neck, hand, or a direction associated with head orientation.

The inventor has realized that the optical or infrared sensor 1030 of the ear-worn device 1014 does not need to be coextensive with the instantaneous field of vision of the user 1000 in order to be useful. The user 1000 naturally turns the head during ordinary activity. As a result, the optical or infrared sensor 1030 can acquire temporally separated observations 1112 from many different orientations over time. When the temporally separated observations 1112 are associated with head-orientation information 1116, time, motion, location, or spatial direction, they may be used to build or update the contextual representation 1120. Thus, the optical or infrared sensor 1030 may function as a contextual sensing device even when its instantaneous sensor field of view 1110 is limited or offset from a gaze direction of the user 1000.

In some embodiments, the optical or infrared sensor 1030 may be used to detect or characterize persons. For example, the system may detect a face, body, gait pattern, clothing feature, posture, approach direction, gesture, proximity, movement trajectory, or social interaction cue. The detected person may be stored as a candidate person referent 1124 in the contextual representation 1120. The candidate person referent 1124 may be associated with identity information, confidence information, relationship information, prior-interaction information, event information, location information, or other information from longitudinal user-specific context 1600. The system may later use the candidate person referent 1124 as the selected candidate referent 1210 for a silent query such as “who's that,” “where do I know him from,” “what did I promise her,” or “tell her I am late.”

In some embodiments, the optical or infrared sensor 1030 may be used to detect or characterize text-bearing referents. A candidate text-bearing referent 1128 may include a sign, menu, name badge, product label, ticket machine, transport board, warning sign, street sign, shop sign, display screen, document, receipt, payment terminal, or other object containing visible text, symbols, codes, or markings. The system may detect the presence of text, determine a language or script, perform optical character recognition, extract a visual code, store the candidate text-bearing referent 1128 in the contextual representation 1120, or associate the candidate text-bearing referent 1128 with a location, direction, or semantic category. A later silent or low-audibility user input 1200 such as “translate that,” “what does that say,” “read that,” or “is this safe” may then be resolved to the candidate text-bearing referent 1128.

In some embodiments, the optical or infrared sensor 1030 may be used to detect or characterize objects, places, devices, or interface elements. Examples include a bag, wallet, phone, key, door, vehicle, bicycle, stroller, table, food item, product, medication package, payment terminal, vending machine, ticket gate, appliance, remote control, display screen, user-interface element, or home-automation device. The system may classify the object as a candidate object referent 1126, associate the object with the user 1000, determine whether the object is actionable, determine whether the object has been left behind, determine whether the object is compatible with the semantic objective 1204, or determine whether the object satisfies a user-relevant condition 1304 or alert condition 1306.

In some embodiments, the optical or infrared sensor 1030 may be used to detect or characterize vehicles, bicycles, animals, moving persons, obstacles, or hazards. For example, the system may detect a candidate vehicle or hazard referent 1130, determine a trajectory, speed, bearing, proximity, closing rate, or collision risk, and generate a private prompt or private output 1216 through the ear speaker or private output transducer 1018. Such output may include a directional alert, such as an indication that a bicycle, vehicle, person, animal, or obstacle is approaching from the left, right, front, rear, or oblique direction.

In some embodiments, the optical or infrared sensor 1030 may be used to detect hand or body gestures. For example, the optical or infrared sensor 1030 may detect pointing, reaching, touching, grasping, waving, raising a hand, a hand moving toward a mouth, a hand holding an object, a hand near a payment terminal, a hand near a door, or a hand indicating a person or object. Gesture information may be combined with silent or low-audibility user input 1200 and the contextual representation 1120 to select the selected candidate referent 1210. For example, the silent or low-audibility user input 1200 “that one” may be resolved using a detected hand gesture, head-orientation information 1116, and a candidate object referent 1126 stored in the contextual representation 1120.

In some embodiments, optical or infrared sensor data may be combined with acoustic data. For example, the outward microphone 1020 may detect speech, a vehicle sound, bicycle bell, footsteps, impact, siren, horn, laughter, hostile tone, or another acoustic event. The system may associate the acoustic event with optical, infrared, or spatial observations. For example, a person speaking in a foreign language, a vehicle approaching from behind, or a person following the user 1000 may be represented as a candidate referent 1122 or alert condition 1306 in the contextual representation 1120. Directional microphones, beamforming, spatial audio processing, or head-orientation information 1116 may be used to estimate a bearing or location of an acoustic source.

In some embodiments, optical or infrared sensor data may be combined with location data, map data, point-of-interest data, calendar data, application data, payment context, communication data, or other external context. For example, an optical observation of a counter, menu, and person may be interpreted differently when the user 1000 is located in a restaurant than when the user 1000 is located in a railway station. Similarly, a sign, platform board, ticket gate, vehicle, payment terminal, or hotel desk may be interpreted based on location and point-of-interest information. Such contextual interpretation may be used to select a language model, translate an utterance, select an assistant service, determine whether a risk is present, or choose a private prompt.

In some embodiments, the ear-worn device 1014 may avoid storing raw optical images by converting the sensor data into feature vectors, embeddings, classifications, bounding regions, optical-flow fields, object identifiers, text strings, confidence values 1138, or other derived data. Raw optical data may be discarded after feature extraction unless a user command, alert condition 1306, evidence-preservation condition, debugging setting, or other retention condition is satisfied. In some embodiments, raw optical data may never leave the ear-worn device 1014. In other embodiments, selected derived features may be transmitted to the companion handheld device 1060, companion wrist-worn device 1062, companion head-mounted device 1064, or remote assistant system 1066 for further processing.

In some embodiments, the optical or infrared sensor 1030 may be configured to operate intermittently, opportunistically, continuously, or in response to detected conditions. For example, the optical or infrared sensor 1030 may operate at a low sampling rate during ordinary use, increase sampling when the inertial measurement unit 1040 indicates scanning or head movement, increase sampling when the silent-speech sensor 1026 detects silent or low-audibility user input 1200, increase sampling when the user-relevant condition 1304 or alert condition 1306 is suspected, or reduce sampling when privacy, power, or thermal constraints require it. The system may also activate or deactivate one or more sensors based on whether the user 1000 is walking, speaking, receiving a notification, entering a crowded place, approaching a payment terminal, requesting translation, or moving through an unfamiliar environment.

In some embodiments, the ear-worn device 1014 may include a privacy indicator, permission setting, consent mechanism, or mode control. However, in other embodiments, because the optical or infrared sensor 1030 may generate non-photographic features rather than conventional images, the sensor may operate as a contextual sensor without presenting itself as a conventional image-recording camera. The system may provide the user 1000 with controls for whether optical or infrared data is processed locally, transmitted, retained, used for safety detection, used for translation, used for social assistance, used for evidence preservation, or used for personalization.

In some embodiments, the optical or infrared sensor 1030, infrared emitter or illumination source 1036, outward microphone 1020, inward microphone 1022, inertial measurement unit 1040, silent-speech sensor 1026, ear speaker or private output transducer 1018, processor 1042, memory 1044, wireless interface 1046, authentication sensor or module 1048, and battery or power unit 1050 may be integrated within the housing 1016 of the ear-worn device 1014. In other embodiments, some components may be distributed between the left ear-worn device 1010 and the right ear-worn device 1012, between the ear-worn device 1014 and the companion handheld device 1060, between the ear-worn device 1014 and the companion wrist-worn device 1062, between the ear-worn device 1014 and the companion head-mounted device 1064, between the ear-worn device 1014 and a vehicle system, or between the ear-worn device 1014 and the remote assistant system 1066.

The embodiments described in this section may be combined with the silent speech processing, silent sound processing, internal microphone, external microphone, cartilage-conduction, bone-conduction, laser microphone, speaker recognition, viseme recognition, command interpretation, contextual language-model selection, payment, hearing-aid, and object-command embodiments described elsewhere herein. In particular, optical or infrared contextual sensing by the ear-worn device 1014 may supply additional context for disambiguating the silent or low-audibility user input 1200, selecting the selected candidate referent 1210, selecting an assistant service using the assistant service selector 1212, generating the private prompt or private output 1216, or initiating a proactive alert in proactive mode 1302.

### Natural Head-Motion Contextual Mapping

In some embodiments, the ear-worn contextual companion platform 1001 generates or updates a contextual representation 1120 of the surroundings of the user 1000 by combining sensor observations acquired over time with information indicating movement or orientation of the head of the user 1000. The inventor has realized that, in ordinary use, the head of the user 1000 is not stationary. The user 1000 naturally turns the head while walking, speaking, listening, scanning a room, orienting toward another person, checking a sign, looking at a menu, avoiding an obstacle, entering a vehicle, looking toward a display, reacting to a sound, or changing walking direction. These natural head movements cause one or more sensors carried by the ear-worn device 1014 to acquire temporally separated observations 1112 from different directions over time.

In some embodiments, the optical or infrared sensor 1030 may have a limited instantaneous sensor field of view 1110, may be offset from an eye direction of the user 1000, or may not be aligned with a forward-facing visual axis of the user 1000. Nevertheless, the optical or infrared sensor 1030 may acquire useful temporally separated observations 1112 over a preceding time window 1134 as the head orientation of the user 1000 changes from a first head orientation 1100, to a second head orientation 1102, to a third head orientation 1104, or through another sequence of head orientations. The system may associate each temporally separated observation 1112, or features derived from each such observation, with head-orientation information 1116, time information, motion information, location information, acoustic information, or other contextual information. By combining such temporally separated observations 1112, the system may maintain the contextual representation 1120 over an angular range greater than the instantaneous sensor field of view 1110 of the optical or infrared sensor 1030.

The contextual representation 1120 may be referred to herein as a contextual map, spatial representation, environmental representation, rolling world model, semantic map, scene graph, candidate-referent store, spatially indexed context cache 1132, short-term environmental memory, or other equivalent structure. The contextual representation 1120 need not be a full geometric three-dimensional reconstruction. In some embodiments, the contextual representation 1120 may include only approximate directions, relative positions, identities, classes, semantic labels, text strings, risk indicators, confidence values 1138, or actionability indicators associated with candidate referents 1122. In other embodiments, the contextual representation 1120 may include spatial anchors, depth information, object trajectories, persistent landmarks, estimated positions, or a three-dimensional map.

A candidate referent 1122 may be any entity, feature, person, object, event, location, or situation that may later be relevant to a semantic objective 1204, assistant operation 1214, private prompt or private output 1216, action proposal 1308, or proactive alert. Candidate referents 1122 may include, without limitation, persons, faces, bodies, voices, signs, menus, labels, vehicles, bicycles, personal items, doors, exits, payment terminals, transport boards, text-bearing objects, user-interface elements, devices, appliances, objects on a table, food items, medication packages, messages, locations, hazards, gestures, or acoustic sources. Candidate referents 1122 may also include more abstract situational contexts, such as a restaurant situation, transport situation, payment situation, social conversation, safety risk, route deviation, or communication event.

In some embodiments, the system may generate the contextual representation 1120 by performing feature extraction on optical or infrared sensor data from the optical or infrared sensor 1030, acoustic sensor data from the outward microphone 1020 or inward microphone 1022, inertial data from the inertial measurement unit 1040, location data, or other sensor data. Feature extraction may produce object classifications, text detections, person detections, face embeddings, gesture detections, optical-flow vectors, depth estimates, semantic labels, acoustic bearings, speech fragments, environmental sound classifications, motion trajectories, or other derived features. The derived features may be stored in memory 1044, in the companion handheld device 1060, in the companion wrist-worn device 1062, in the companion head-mounted device 1064, or in the remote assistant system 1066, instead of, or in addition to, raw sensor data.

Head-orientation information 1116 may be obtained from the inertial measurement unit 1040 in the ear-worn device 1014, from the left ear-worn device 1010, from the right ear-worn device 1012, from the companion head-mounted device 1064, from the companion handheld device 1060, from the companion wrist-worn device 1062, from image-based motion estimation, from acoustic localization, or from a combination of these sources. The head-orientation information 1116 may include yaw, pitch, roll, angular velocity, angular acceleration, heading, turn direction, or relative orientation change. In some embodiments, the system may determine that the user 1000 has performed a natural head sweep along a head sweep path 1114 and may use temporally separated observations 1112 acquired during the head sweep path 1114 to update the contextual representation 1120.

In some embodiments, each temporally separated observation 1112 or derived feature may be indexed by one or more of a timestamp, head-orientation information 1116, estimated bearing, estimated distance, confidence value 1138, location, object class, identity confidence, semantic label, acoustic bearing, or actionability value. For example, a sign may be stored as a candidate text-bearing referent 1128 at an approximate bearing relative to the user 1000. A person may be stored as a candidate person referent 1124 with a face embedding, voice signature, proximity value, and relationship confidence. A bag may be stored as a candidate object referent 1126 associated with the user 1000. A vehicle may be stored as a candidate vehicle or hazard referent 1130 with a trajectory, speed, and approach direction.

In some embodiments, the contextual representation 1120 is rolling or time-limited. Candidate referents 1122 may be retained for the preceding time window 1134 and then removed or down-weighted. The preceding time window 1134 may be selected based on the type of candidate referent 1122, confidence value 1138, privacy setting, power setting, user setting, use case, or risk level. For example, a vehicle trajectory may be retained for only a few seconds, a menu or sign may be retained for minutes, a person at an event may be retained for the duration of the event, and a trusted-contact association may be retained in longitudinal user-specific context 1600. Raw sensor observations may be discarded more quickly than derived contextual features.

In some embodiments, a candidate referent 1122 may remain available for semantic-intent resolution even after the candidate referent 1122 is no longer within the instantaneous sensor field of view 1110 of the optical or infrared sensor 1030. For example, the user 1000 may turn toward a menu, thereby allowing the optical or infrared sensor 1030 to detect text or a food item. The user 1000 may later turn away and provide silent or low-audibility user input 1200, such as “translate that,” “is this vegetarian,” or “what does that say.” The referent resolver 1208 may resolve the silent or low-audibility user input 1200 to the previously observed menu or food item using the contextual representation 1120, even though the menu or food item is not currently imaged by the optical or infrared sensor 1030.

In another example, the user 1000 may briefly turn toward a person at a social event. One or more sensors may generate features associated with the person, such as a face embedding, body feature, voice feature, location, or event context. The user 1000 may then look away and provide silent or low-audibility user input 1200, such as “who is that,” “where do I know him from,” or “what did I promise her.” The referent resolver 1208 may select the previously observed candidate person referent 1124 from the contextual representation 1120 and generate private assistant information associated with the selected candidate referent 1210.

In another example, the user 1000 may pass a sign or transport board while walking. The system may detect text or layout information and store a candidate text-bearing referent 1128 indexed by time, direction, and location. The user 1000 may later provide silent or low-audibility user input 1200, such as “what did that say,” “which platform,” or “translate that.” The system may retrieve the candidate text-bearing referent 1128 or a feature representation thereof and provide the private prompt or private output 1216 through the ear speaker or private output transducer 1018.

In some embodiments, the contextual representation 1120 may support attention determination without requiring eye tracking. The system may determine an attention target or likely referent by comparing current head-orientation information 1116, recent head motion, semantic content of the silent or low-audibility user input 1200, gesture information, acoustic source direction, object saliency, and the contextual representation 1120. For example, if the user 1000 provides the silent or low-audibility user input 1200 “open that” while turning toward a door or interface element that was previously observed, the referent resolver 1208 may infer that the door or interface element is the selected candidate referent 1210. Such an inference may be made without determining a gaze vector, gaze dwell, pupil direction, or eye openness.

In some embodiments, the contextual representation 1120 may be updated opportunistically. The system need not continuously run all sensors at maximum power. Instead, the system may increase sensing, feature extraction, or map updating when one or more triggers occur. Triggers may include head movement detected by the inertial measurement unit 1040, entry into a crowded environment, detection of silent or low-audibility user input 1200, detection of an affective utterance, detection of a foreign language, detection of a safety-relevant sound, detection of a potential personal item, detection of a payment context, detection of a known person, detection of a transport environment, user request for assistance, or a proactive risk score exceeding a threshold.

In some embodiments, the contextual representation 1120 may include confidence values 1138 associated with candidate referents 1122. A confidence value 1138 may depend on clarity of an optical or infrared observation, number of observations, recency, consistency across the left ear-worn device 1010 and the right ear-worn device 1012, consistency with acoustic direction, consistency with head-orientation information 1116, semantic compatibility with the semantic objective 1204, consistency with location or application context, identity confidence, or past user confirmations. If the confidence value 1138 is below a threshold, the system may request private user confirmation 1218 before initiating the assistant operation 1214.

In some embodiments, the contextual representation 1120 may be used to disambiguate incomplete, deictic, or affective utterances. A deictic utterance is an utterance whose meaning depends on context, such as “this,” “that,” “there,” “him,” “her,” “it,” “that one,” “over there,” or similar expressions. An affective or incomplete utterance may include an exclamation, hesitation, sigh, short phrase, or low-content expression such as “oh,” “oh no,” “damn,” “help,” “not again,” or “I cannot.” The system may determine whether such an utterance corresponds to the semantic objective 1204, a support need, a protective action, or a request for information by comparing the utterance and current context with the contextual representation 1120 and, where available, the longitudinal user-specific context 1600.

In some embodiments, the contextual representation 1120 may be fused with the longitudinal user-specific context 1600. The longitudinal user-specific context 1600 may include relationship data 1602, safety policy 1604, trusted contact data 1606, communication style profile 1608, prior support outcome data 1610, contacts, calendar entries, prior interactions, photos, messages, emails, tasks, payment settings, travel plans, known devices, trusted locations, or other permissioned user-specific information. Such longitudinal user-specific context 1600 may allow the system to recognize that the candidate person referent 1124 is a known person, that a location is a scheduled destination, that a payment terminal corresponds to a current purchase, that a vehicle is a booked ride, or that a message or event resembles a prior situation.

In some embodiments, the system may distinguish between a currently imaged referent, a recently observed referent, and a long-term known referent. A currently imaged referent is presently within the instantaneous sensor field of view 1110 of the optical or infrared sensor 1030. A recently observed referent was observed during the preceding time window 1134 but may no longer be visible. A long-term known referent may be stored in the longitudinal user-specific context 1600, such as a known contact, known device, known vehicle, home object, or trusted location. The semantic objective 1204 may be resolved using any one or more of these referent categories.

In some embodiments, the contextual representation 1120 may be maintained locally on the ear-worn device 1014, in memory 1044. In other embodiments, the contextual representation 1120 may be maintained on the companion handheld device 1060, companion wrist-worn device 1062, companion head-mounted device 1064, vehicle system, or other computing device. In further embodiments, one or more portions of the contextual representation 1120 may be maintained by the remote assistant system 1066. The system may partition the contextual representation 1120 based on latency, privacy, computational load, power consumption, storage capacity, security, or user settings.

In some embodiments, privacy is preserved by storing only derived features or by limiting retention time. For example, the system may retain a text string extracted from a sign but discard the corresponding raw optical image. The system may retain a candidate person identifier or confidence value 1138 but discard the raw image from which the person was detected. The system may retain a trajectory vector for an approaching vehicle but discard video frames. In safety or evidence-preservation modes, different retention rules may be applied as described elsewhere herein.

In some embodiments, the contextual representation 1120 may be used for proactive operations even in the absence of a user command. For example, the system may detect that a vehicle is approaching from an oblique or rear direction, that a personal item associated with the user 1000 has been left behind, that a known person is approaching, that a sign contains urgent information, that ambient speech is user-relevant, that a route is becoming unsafe, or that a person has remained near the user 1000 across multiple observations. The system may privately output an alert, explanation, or action proposal 1308 through the ear speaker or private output transducer 1018.

The embodiments described in this section may be combined with the ear-worn optical and infrared contextual sensing embodiments described herein, the silent speech embodiments described elsewhere herein, the contextual language-model embodiments described elsewhere herein, and the object-recognition and semantic-intent embodiments described elsewhere herein. In particular, the contextual representation 1120 may provide the context required to bind the silent or low-audibility user input 1200 to a person, object, location, text-bearing referent, service, alert condition 1306, or other situation.

### Referent Resolution and Semantic Grounding for Silent or Low-Audibility Input

In some embodiments, the ear-worn contextual companion platform 1001 uses the contextual representation 1120 to resolve a semantic objective 1204 derived from silent or low-audibility user input 1200. The silent or low-audibility user input 1200 may comprise silent speech, subvocal speech, mouthed speech, whispered speech, low-volume speech, low-audibility speech, a silent sound, a tongue click, a tooth click, a clatter of teeth, a breath pattern, an affective utterance, an incomplete utterance, or another user input that is not intended to be intelligible to nearby persons.

In some embodiments, the silent or low-audibility user input 1200 is processed by a silent speech processor 1202. The silent speech processor 1202 may receive signals from one or more silent-speech sensors 1026, outward microphones 1020, inward microphones 1022, bone-conduction, cartilage-conduction, vibration, or body-conducted-signal sensors 1024, optical or infrared sensors 1030, inertial measurement units 1040, or other sensors. The silent speech processor 1202 may generate phonemes, visemes, words, text, command candidates, semantic labels, embeddings, language-model outputs, intent candidates, confidence values, or other representations of the silent or low-audibility user input 1200.

The semantic objective 1204 may represent what the user 1000 intends to accomplish by providing the silent or low-audibility user input 1200. In some embodiments, the semantic objective 1204 may correspond to a command, question, request, query, warning request, translation request, navigation request, payment request, communication request, device-control request, social-assistance request, safety request, or other assistant objective. The semantic objective 1204 may be explicit, such as “call Anna,” or incomplete, such as “call him,” “translate that,” “read this,” “open it,” “send this,” “pay for this,” “get me there,” “what does that say,” or “who is that.”

In some embodiments, the semantic objective 1204 may include an incomplete referent slot 1206. The incomplete referent slot 1206 is a part of the semantic objective 1204 that cannot be fully resolved without identifying a person, object, place, device, text-bearing object, interface element, displayed content item, event, situation, or other candidate referent 1122. For example, in the utterance “translate that,” the word “that” may correspond to the incomplete referent slot 1206. In the utterance “call him,” the word “him” may correspond to the incomplete referent slot 1206. In the utterance “pay for this,” the word “this” may correspond to a payment request, product, service, bill, payment terminal, merchant, or other candidate referent 1122.

In some embodiments, the referent resolver 1208 fills the incomplete referent slot 1206 by selecting a selected candidate referent 1210 from the contextual representation 1120. The selected candidate referent 1210 may be selected from candidate referents 1122 that are currently imaged, recently observed, spatially indexed, semantically compatible, acoustically relevant, known to the user 1000, or otherwise associated with the current context. The selected candidate referent 1210 may be a candidate person referent 1124, candidate object referent 1126, candidate text-bearing referent 1128, candidate vehicle or hazard referent 1130, referent outside current field of view 1136, or another referent represented in the contextual representation 1120.

In some embodiments, the referent resolver 1208 may select the selected candidate referent 1210 based on one or more confidence values 1138. The confidence values 1138 may be based on recency of observation, duration of observation, frequency of observation, head-orientation information 1116, current head orientation, apparent attention direction, gesture information, acoustic source direction, proximity, trajectory, object saliency, semantic compatibility, actionability, location context, application context, relationship data 1602, user history, or prior confirmations by the user 1000. The referent resolver 1208 may select the candidate referent 1122 having the highest confidence value 1138, or may select a plurality of candidate referents 1122 for disambiguation or confirmation.

In some embodiments, semantic compatibility is used to select the selected candidate referent 1210. Semantic compatibility may indicate whether a candidate referent 1122 is capable of satisfying or completing the semantic objective 1204. For example, if the semantic objective 1204 is “translate that,” a candidate text-bearing referent 1128, foreign-language speech source, menu, sign, or document may have a higher semantic compatibility than a chair or vehicle. If the semantic objective 1204 is “call him,” a candidate person referent 1124 or known contact in the longitudinal user-specific context 1600 may have a higher semantic compatibility than an object. If the semantic objective 1204 is “open it,” a door, application, message, document, lock, browser tab, or device interface may have a higher semantic compatibility than a food item.

In some embodiments, the selected candidate referent 1210 is selected even though it is not currently within the instantaneous sensor field of view 1110 of the optical or infrared sensor 1030. For example, the selected candidate referent 1210 may correspond to a referent outside current field of view 1136 that was observed during the preceding time window 1134 and stored in the contextual representation 1120. The selected candidate referent 1210 may be selected based on current head-orientation information 1116, a recent head sweep path 1114, recency of observation, semantic compatibility with the semantic objective 1204, or user-specific context.

In some embodiments, the referent resolver 1208 may use current head orientation as a substitute for eye gaze. The system may determine that the user 1000 is oriented toward a spatial region associated with one or more candidate referents 1122 in the contextual representation 1120. The referent resolver 1208 may then select the candidate referent 1122 in that spatial region when the semantic objective 1204 is compatible with that candidate referent 1122. This allows the system to resolve an apparent attention target without requiring gaze tracking, gaze dwell, pupil tracking, eye openness measurement, or a camera directed toward the eyes of the user 1000.

In some embodiments, the referent resolver 1208 may use gesture information to resolve the incomplete referent slot 1206. Gesture information may be derived from the optical or infrared sensor 1030, inertial measurement unit 1040, microphones 1020, 1022, companion handheld device 1060, companion wrist-worn device 1062, or companion head-mounted device 1064. Gesture information may include pointing, reaching, touching, grasping, facing, nodding, turning, raising a hand, holding an object, or another body movement. For example, if the user 1000 silently says “that one” while a hand gesture points toward a product or menu item, the referent resolver 1208 may select the corresponding candidate object referent 1126 or candidate text-bearing referent 1128.

In some embodiments, the referent resolver 1208 may use acoustic context to resolve the incomplete referent slot 1206. Acoustic context may include a direction of a speaker, a language being spoken, a detected name, a vehicle sound, footsteps, a warning sound, a payment terminal sound, or another acoustic event. For example, if the semantic objective 1204 is “what did he say,” the referent resolver 1208 may select a candidate person referent 1124 associated with an acoustic speech source. If the semantic objective 1204 is “translate that,” the referent resolver 1208 may select an ambient foreign-language speech source represented in the contextual representation 1120.

In some embodiments, the referent resolver 1208 may use the longitudinal user-specific context 1600 to resolve the incomplete referent slot 1206. For example, if the semantic objective 1204 is “call him,” and the contextual representation 1120 includes a candidate person referent 1124 associated with relationship data 1602, the referent resolver 1208 may select the known person represented by the candidate person referent 1124. If the semantic objective 1204 is “ask her if I sent the deck,” the referent resolver 1208 may select a candidate person referent 1124 and retrieve prior interaction data from the longitudinal user-specific context 1600.

In some embodiments, the semantic objective 1204 may be inferred from an incomplete or affective expression rather than a fully specified command. For example, the silent or low-audibility user input 1200 may comprise “oh no,” “oh bummer,” “not again,” “help,” “damn,” “I can't,” a sigh, a hesitation, or another affective or low-content expression. The system may compare the current context, contextual representation 1120, communication data, notification data, user state, and longitudinal user-specific context 1600 to determine an implied semantic objective 1204, such as a request for explanation, reassurance, translation, trusted-contact escalation, route guidance, evidence preservation, delay of an outgoing message, or another assistant operation 1214.

In some embodiments, the assistant service selector 1212 selects an assistant service based on the semantic objective 1204 and the selected candidate referent 1210. The assistant service may comprise translation, navigation, payment, messaging, calling, search, calendar access, contact identification, ride-hailing, emergency assistance, evidence preservation, device control, text recognition, object identification, or another service. For example, if the semantic objective 1204 is “translate that” and the selected candidate referent 1210 is a candidate text-bearing referent 1128, the assistant service selector 1212 may select a translation service. If the semantic objective 1204 is “get me there” and the selected candidate referent 1210 is a location or sign, the assistant service selector 1212 may select a navigation service. If the semantic objective 1204 is “pay for this” and the selected candidate referent 1210 is a payment terminal or bill, the assistant service selector 1212 may select a payment service.

In some embodiments, the assistant service selector 1212 selects an assistant service without requiring the user 1000 to explicitly select an application. The user 1000 may provide the silent or low-audibility user input 1200 as a natural expression of an objective, and the system may determine which application, service, device, or workflow should be used. The assistant operation 1214 may therefore be an intent-level operation rather than an application-specific command. For example, “ask him if this is vegetarian” may cause the assistant service selector 1212 to use person identification, context-disambiguated translation, and public companion-device output 1072, without the user 1000 explicitly selecting a translation application.

In some embodiments, the assistant operation 1214 results in the private prompt or private output 1216 being generated. The private prompt or private output 1216 may be delivered to the user 1000 as private assistant output 1070 through the ear speaker or private output transducer 1018. The private prompt or private output 1216 may comprise an answer, warning, explanation, confirmation request, conversational prompt, navigation instruction, translation, identity cue, social-context cue, payment confirmation, safety alert, or other assistant information. The private assistant output 1070 may be perceptible to the user 1000 and not perceptible to nearby persons.

In some embodiments, the assistant operation 1214 may also cause public companion-device output 1072. For example, the companion handheld device 1060 may output translated speech to a third party, a remote participant 1510 in a communication session 1500 may receive generated user-voice audio 1512, or a display of the companion handheld device 1060 or companion head-mounted device 1064 may show information. In some embodiments, both private assistant output 1070 and public companion-device output 1072 may be generated. For example, a translated sentence may be output publicly, while a reply from a third party may be translated and returned privately to the user 1000.

In some embodiments, the system may request user confirmation 1218 before performing the assistant operation 1214. User confirmation 1218 may be requested when the confidence value 1138 is below a threshold, when the assistant operation 1214 involves payment, messaging, calling, trusted-contact escalation, ride-hailing, emergency assistance, evidence preservation, personal data disclosure, or another sensitive action. User confirmation 1218 may be provided by silent or low-audibility user input 1200, a silent sound, a click-equivalent sound, a head gesture, a touch input, a biometric confirmation, or another private input.

In some embodiments, the referent resolver 1208 may generate a clarification request if the contextual representation 1120 includes multiple candidate referents 1122 that are compatible with the semantic objective 1204. For example, if the user 1000 says “call him” while two candidate person referents 1124 are present, the system may output a private prompt such as “do you mean the person on your left or the person near the bar?” In another example, if the user 1000 says “translate that” while multiple candidate text-bearing referents 1128 were recently observed, the system may privately ask which sign, menu, or label is intended.

In some embodiments, prior user behavior may be used to improve referent resolution. The system may learn that the user 1000 usually means a person currently being faced when saying “him,” usually means the most recently observed sign when saying “that sign,” usually wants a private summary when uttering “oh bummer” after receiving a legal or medical notification, or usually wants a ride-hailing action when saying “get me out” at night. Such learned behavior may be stored in the longitudinal user-specific context 1600 and applied by the referent resolver 1208 or assistant service selector 1212.

In some embodiments, the referent resolver 1208 may use negative evidence. For example, a candidate referent 1122 may be down-weighted because it is not semantically compatible with the semantic objective 1204, was observed too long ago, is outside a plausible head orientation range, is inconsistent with a gesture, lacks an actionable interface, is not associated with the user 1000, or conflicts with location context. Negative evidence may reduce the confidence value 1138 associated with the candidate referent 1122.

In some embodiments, referent resolution may be performed locally by the processor 1042 or by a processor in the companion handheld device 1060, companion wrist-worn device 1062, companion head-mounted device 1064, or remote assistant system 1066. In some embodiments, low-latency or privacy-sensitive referent resolution is performed locally, while more computationally intensive recognition, translation, or search operations may be performed by the remote assistant system 1066.

The embodiments described in this section may be combined with the natural head-motion contextual mapping embodiments, the ear-worn optical and infrared contextual sensing embodiments, the silent speech embodiments, the contextual language-model embodiments, and the object-recognition and semantic-intent embodiments described elsewhere herein. In particular, the referent resolver 1208 may provide the bridge between the silent or low-audibility user input 1200 and the contextual representation 1120, allowing the system to complete the semantic objective 1204 using a selected candidate referent 1210 and to cause an assistant operation 1214 associated with that selected candidate referent 1210.

### Private Ear-Worn Output and Public Companion-Device Output

In some embodiments, the ear-worn contextual companion platform 1001 provides information to the user 1000 through private assistant output 1070. The private assistant output 1070 may be delivered through the ear speaker or private output transducer 1018 of the ear-worn device 1014. In some embodiments, the private assistant output 1070 is perceptible to the user 1000 and is not perceptible, or is not intelligible, to one or more nearby persons. The private assistant output 1070 may comprise synthetic speech, whispered synthetic speech, spatial audio, directional audio, a tone, a chime, a vibration, haptic feedback, bone-conduction output, cartilage-conduction output, or another output suitable for private communication with the user 1000.

In some embodiments, the private assistant output 1070 may be generated in response to the silent or low-audibility user input 1200. For example, the user 1000 may provide silent or low-audibility user input 1200 such as “who is that,” “translate that,” “read that sign,” “what did I promise him,” “get me there,” “pay for this,” “call Anna,” or “what does that say.” The referent resolver 1208 may select the selected candidate referent 1210 from the contextual representation 1120, the assistant service selector 1212 may select a service, and the system may generate the private assistant output 1070 as an answer, explanation, confirmation request, warning, social-context cue, navigation cue, translation, or other assistant information.

In some embodiments, the private assistant output 1070 may be generated without contemporaneous silent or low-audibility user input 1200. For example, in the proactive mode 1302, the system may detect a user-relevant condition 1304 or alert condition 1306 based on the contextual representation 1120, longitudinal user-specific context 1600, or other sensor data. The private assistant output 1070 may then comprise an unsolicited but user-relevant prompt, warning, reminder, explanation, suggestion, or action proposal 1308. Examples include a warning that a vehicle is approaching, a reminder that a personal item was left behind, a notice that a known person is approaching, an indication that a sign or announcement is relevant, a suggestion to call a trusted contact, or a proposal to initiate a transportation action 1314.

In some embodiments, the private assistant output 1070 may include an indication of direction, distance, urgency, identity, confidence, or recommended action. For example, the private assistant output 1070 may indicate that a vehicle is approaching from the left, that a bicycle is behind the user 1000, that a person identified with a candidate person referent 1124 is near the bar, that a candidate text-bearing referent 1128 contains a platform change, or that a candidate object referent 1126 associated with the user 1000 has been left behind. Such directional or spatial information may be generated from the contextual representation 1120, head-orientation information 1116, acoustic bearings, optical-flow data, depth data, or other sensor data.

In some embodiments, the private assistant output 1070 may be generated with a selected tone, urgency, brevity, formality, or intervention level 1310. The selected tone or intervention level 1310 may be determined based on the user-relevant condition 1304, confidence value 1138, severity value, user state, safety policy 1604, communication style profile 1608, prior support outcome data 1610, or other information in the longitudinal user-specific context 1600. For example, a low-risk reminder may be output as a gentle prompt, a social cue may be output discreetly, and a high-confidence safety risk may be output as a direct warning. In some embodiments, humorous, informal, or conversational output may be suppressed when the alert condition 1306 exceeds a severity threshold.

In some embodiments, the private assistant output 1070 may include a request for user confirmation 1218. The request for user confirmation 1218 may be generated before initiating the assistant operation 1214, especially when the assistant operation 1214 involves payment, messaging, calling, trusted-contact escalation, ride-hailing, navigation to a new destination, public companion-device output 1072, evidence preservation action 1316, emergency assistance, or disclosure of user information. The user confirmation 1218 may be provided using silent or low-audibility user input 1200, a silent sound, a click-equivalent sound, a head gesture, a touch input, biometric confirmation, or another input that may be private or substantially private to the user 1000.

In some embodiments, the private assistant output 1070 may be configured as a whispered assistant output. A whispered assistant output may be an audio signal that is presented at a low volume, localized to the ear of the user 1000, filtered to reduce leakage, delivered by bone or cartilage conduction, or otherwise configured so that nearby persons cannot readily perceive or understand it. The whispered assistant output may be especially useful in social environments, transport environments, offices, quiet rooms, restaurants, medical facilities, meetings, or other places where the user 1000 may not wish to expose an interaction with the ear-worn contextual companion platform 1001.

In some embodiments, the private assistant output 1070 may be spatialized. For example, spatial audio may indicate a bearing or direction associated with a candidate referent 1122, alert condition 1306, or action proposal 1308. A warning about a vehicle may be output with a spatial impression corresponding to the direction of the vehicle. A cue identifying a person may be output with a spatial impression corresponding to the person's location. A navigation cue may be output with a spatial impression corresponding to a direction of travel. Such spatialized private assistant output 1070 may be generated using head-orientation information 1116, the contextual representation 1120, or other spatial information.

In some embodiments, the private assistant output 1070 may be combined with public companion-device output 1072. Public companion-device output 1072 may be output by the companion handheld device 1060, companion wrist-worn device 1062, companion head-mounted device 1064, vehicle system, external speaker, conference device, display, or other device. Public companion-device output 1072 may be audible or visible to a person other than the user 1000. For example, a translation generated by a translation processor 1402 may be output as target-language output 1406 through a public speaker output 1408 of the companion handheld device 1060, while a response from a third party may be translated into a private return translation 1412 and output as private assistant output 1070 through the ear-worn device 1014.

In some embodiments, public companion-device output 1072 may be used in a communication session 1500. For example, the user 1000 may provide silent or low-audibility user input 1200 during the communication session 1500. After wearer authentication 1502, the system may generate speech audio using a user voice profile 1506 and a voice synthesis processor 1508. The generated user-voice audio 1512 may be transmitted to a remote participant 1510, while the reply of the remote participant 1510 is output privately to the user 1000 through the ear-worn device 1014. In this way, the user 1000 may participate in a phone call, video call, conference call, voice message exchange, push-to-talk session, or other communication session 1500 without audibly speaking in a way that is intelligible to nearby persons.

In some embodiments, the platform 1001 may maintain a distinction between private output, public output, and external service action. Private output may be delivered as private assistant output 1070 through the ear-worn device 1014. Public output may be delivered as public companion-device output 1072 through a companion device or external device. An external service action may involve initiating a payment, ride-hailing request, navigation route, emergency call, message, evidence preservation action 1316, trusted contact action 1312, transportation action 1314, or other assistant operation 1214. The system may select among these output and action modes based on the semantic objective 1204, selected candidate referent 1210, user state, privacy setting, confidence value 1138, and user confirmation 1218.

In some embodiments, the private assistant output 1070 may be used to avoid or reduce the need for visual interaction with the companion handheld device 1060. For example, when the user 1000 is walking alone, carrying objects, participating in a social conversation, travelling in a foreign country, standing in a crowded train, or otherwise unable or unwilling to look at a screen, the ear-worn device 1014 may output private prompts, warnings, translations, and confirmations. This enables the user 1000 to maintain awareness of the surroundings while still interacting with the assistant system.

In some embodiments, the private assistant output 1070 may be generated by a personalized output generator 1614. The personalized output generator 1614 may use the communication style profile 1608, relationship data 1602, safety policy 1604, prior support outcome data 1610, user-state estimator 1612, semantic objective 1204, selected candidate referent 1210, confidence value 1138, and user-relevant condition 1304 to generate a private output that is personalized to the user 1000. Personalization may include selecting a level of detail, tone, formality, brevity, directness, reassurance, humor, urgency, or suggested action. In some embodiments, personalization may be limited, disabled, or modified based on privacy, safety, regulatory, or user preference settings.

In some embodiments, the private assistant output 1070 may comprise a social-context cue. A social-context cue may identify a candidate person referent 1124, relationship data 1602, a prior interaction, a name, a meeting context, a promise, a suggested conversational topic, a warning to avoid a topic, or an indication that a social opportunity or social risk is present. Such a cue may be delivered privately so that the user 1000 can use the information without exposing the assistance to the candidate person referent 1124 or to other nearby persons.

In some embodiments, the private assistant output 1070 may comprise a safety-context cue. A safety-context cue may identify an approaching vehicle, a person or vehicle that has persisted near the user 1000, an unsafe route, a separation from a personal item, a mismatch between a booked ride and an observed vehicle, a potential scam, a foreign-language conversation that is user-relevant, or another alert condition 1306. The safety-context cue may include a recommended protective action, such as changing direction, crossing a street, moving toward a public area, initiating a transportation action 1314, initiating a trusted contact action 1312, or initiating an evidence preservation action 1316.

In some embodiments, the private assistant output 1070 may comprise an emotional or cognitive support cue. The platform 1001 may detect that a communication, notification, event, or context is likely to be emotionally significant to the user 1000. The system may generate a private output that summarizes the content, contextualizes the urgency, recommends waiting before responding, proposes a trusted contact action 1312, or offers another supportive assistant operation 1214. The system may select the tone and content of such output using the longitudinal user-specific context 1600 and user-state estimator 1612.

In some embodiments, private assistant output 1070 may be suppressed, delayed, modified, or escalated based on context. For example, the system may suppress non-urgent output during a conversation, delay a low-priority reminder, escalate a safety warning, shorten a prompt when the user 1000 is moving quickly, or request immediate user confirmation 1218 when an external action is proposed. Such suppression, delay, modification, or escalation may be determined based on user state, motion, acoustic context, conversation context, alert condition 1306, safety policy 1604, or communication style profile 1608.

In some embodiments, the private assistant output 1070 may be used to obtain silent user feedback. For example, after outputting a private prompt, the system may listen for silent or low-audibility user input 1200 indicating confirmation, rejection, modification, or clarification. The resulting user confirmation 1218 may be used to initiate, cancel, delay, or modify the assistant operation 1214. The system may update the longitudinal user-specific context 1600 based on the user confirmation 1218, the selected action, and the outcome.

The embodiments described in this section may be combined with the ear-worn optical and infrared contextual sensing embodiments, the natural head-motion contextual mapping embodiments, the referent resolution embodiments, the silent speech embodiments, the hearing-aid embodiments, the payment embodiments, and the communication embodiments described elsewhere herein. In particular, the private assistant output 1070 may be used as the output channel for assistant operations 1214 that are grounded in the contextual representation 1120 and selected candidate referent 1210, while public companion-device output 1072 may be used when the assistant operation 1214 is intended to communicate with a third party, remote participant 1510, payment terminal, transportation service, emergency service, or other external entity.

### Reactive Assistant Mode

In some embodiments, the ear-worn contextual companion platform 1001 operates in a reactive mode 1300. In the reactive mode 1300, the user 1000 initiates an assistant interaction by providing silent or low-audibility user input 1200. The silent or low-audibility user input 1200 may be detected by one or more silent-speech sensors 1026, outward microphones 1020, inward microphones 1022, bone-conduction, cartilage-conduction, vibration, or body-conducted-signal sensors 1024, optical or infrared sensors 1030, inertial measurement units 1040, companion handheld devices 1060, companion wrist-worn devices 1062, companion head-mounted devices 1064, or other sensors.

In the reactive mode 1300, the silent speech processor 1202 may process the silent or low-audibility user input 1200 to determine a semantic objective 1204. The semantic objective 1204 may comprise a command, query, request, instruction, affective expression, confirmation, rejection, modification, or other indication of what the user 1000 intends to accomplish. In some embodiments, the semantic objective 1204 may include an incomplete referent slot 1206, such that the semantic objective 1204 cannot be fully executed until a selected candidate referent 1210 is identified by the referent resolver 1208.

In some embodiments, the reactive mode 1300 allows the user 1000 to interact with an assistant system without speaking audibly, without removing the companion handheld device 1060 from a pocket or bag, without looking at a display, without making socially visible gestures, and without causing nearby persons to understand the interaction. This is advantageous in public places, crowded spaces, quiet rooms, transport vehicles, social events, restaurants, workplaces, meetings, hospitals, libraries, shops, streets, and other environments in which audible voice commands or visible device interactions may be undesirable.

In some embodiments, the semantic objective 1204 may be an identity query. For example, the user 1000 may silently or quietly utter “who is that,” “where do I know him from,” “what is her name,” “what did I promise him,” “did I meet her before,” or a similar query. The referent resolver 1208 may select a candidate person referent 1124 from the contextual representation 1120, optionally using relationship data 1602, prior support outcome data 1610, calendar data, message history, contact data, event information, or other information from the longitudinal user-specific context 1600. The assistant operation 1214 may then generate private assistant output 1070 comprising a name, relationship, prior meeting, shared event, recent communication, remembered obligation, or suggested conversational prompt.

In some embodiments, the semantic objective 1204 may be a translation, reading, or interpretation request. For example, the user 1000 may silently or quietly utter “translate that,” “what does that say,” “read that sign,” “is this vegetarian,” “does this contain peanuts,” “which platform,” “how much is that,” or a similar request. The referent resolver 1208 may select a candidate text-bearing referent 1128, candidate object referent 1126, ambient speech source, menu, sign, label, transport board, ticket machine, or other referent from the contextual representation 1120. The assistant service selector 1212 may select a translation service, optical character recognition service, language model, dietary context model, transport context model, or other assistant service. The resulting private assistant output 1070 may provide the answer privately to the user 1000, or the public companion-device output 1072 may provide translated speech to a third party.

In some embodiments, the semantic objective 1204 may be a navigation or location request. For example, the user 1000 may silently or quietly utter “get me there,” “where is that,” “take me to that place,” “which way,” “where is the exit,” “guide me to the platform,” or “get me home.” The referent resolver 1208 may select a location, sign, event, person, address, landmark, transport board, exit, vehicle, or other candidate referent 1122 from the contextual representation 1120 or longitudinal user-specific context 1600. The assistant service selector 1212 may select a navigation service and output private navigation instructions through the ear-worn device 1014.

In some embodiments, the semantic objective 1204 may be a payment or transaction request. For example, the user 1000 may silently or quietly utter “pay for this,” “use this card,” “confirm,” “decline,” “send him the money,” “split the bill,” or a similar payment-related expression. The referent resolver 1208 may select a payment terminal, bill, merchant, displayed amount, product, service, ticket machine, or other payment-related candidate referent 1122. The assistant service selector 1212 may select a payment service. The system may request user confirmation 1218 through private assistant output 1070 before initiating payment, especially where the semantic objective 1204 involves a financial transaction.

In some embodiments, the semantic objective 1204 may be a communication request. For example, the user 1000 may silently or quietly utter “call Cora,” “tell Richard I am late,” “reply yes,” “send this to her,” “draft a calmer answer,” “do not let me send this yet,” “call my husband,” “send my location,” or a similar expression. The referent resolver 1208 may identify a person, contact, message, notification, document, calendar event, or other communication-related referent. The assistant service selector 1212 may select a messaging service, calling service, email service, calendar service, trusted contact action 1312, or other communication service. The system may request user confirmation 1218 before sending or placing communications.

In some embodiments, the semantic objective 1204 may be a device-control or environment-control request. For example, the user 1000 may silently or quietly utter “open that,” “turn that on,” “unlock it,” “turn up the volume,” “switch off the light,” “open the door,” “start the car,” or a similar expression. The referent resolver 1208 may select a candidate object referent 1126, device, appliance, door, vehicle, media object, application, or user-interface element from the contextual representation 1120. The assistant operation 1214 may transmit a command to the selected device or service, optionally after user confirmation 1218.

In some embodiments, the semantic objective 1204 may be a safety or extraction request. For example, the user 1000 may silently or quietly utter “help,” “get me out,” “call someone,” “call police,” “call Cora,” “book an Uber,” “share my location,” “record this,” “preserve evidence,” “guide me to a safe place,” or a similar request. The assistant service selector 1212 may select a trusted contact action 1312, transportation action 1314, evidence preservation action 1316, navigation action, emergency communication action, or other protective action. The system may generate private assistant output 1070 asking for user confirmation 1218, unless a user-specific safety policy 1604 authorizes automatic escalation under defined conditions.

In some embodiments, the semantic objective 1204 may be an affective or low-content request. For example, the user 1000 may silently or quietly utter “oh bummer,” “damn,” “not again,” “I cannot,” “please no,” “help,” or another affective expression. The system may determine the semantic objective 1204 by considering the contextual representation 1120, current notification or communication data, user-state estimator 1612, longitudinal user-specific context 1600, and prior support outcome data 1610. The resulting assistant operation 1214 may comprise summarizing bad news, contextualizing urgency, proposing a trusted contact action 1312, delaying an outgoing communication, initiating a calming routine, suggesting transportation, or providing another supportive response.

In some embodiments, the reactive mode 1300 may be initiated without a wake word. The silent or low-audibility user input 1200 may be recognized as user-authorized input based on wearer authentication 1502, articulation biometric 1504, context, sensor activation state, or another authorization mechanism. In other embodiments, the reactive mode 1300 may require a wake word, wake gesture, silent sound, click-equivalent input, device touch, head gesture, or other activation signal. In further embodiments, the system may distinguish between private self-talk and intended assistant input using context, user settings, confidence values, or explicit confirmation.

In some embodiments, the reactive mode 1300 may operate as a continuous or semi-continuous private input channel. The user 1000 may provide short, incomplete, or deictic utterances because the contextual representation 1120 and longitudinal user-specific context 1600 supply missing meaning. For example, a short utterance such as “that one,” “him,” “no meat,” “get me there,” or “call her” may be sufficient because the referent resolver 1208 identifies the relevant candidate referent 1122 and the assistant service selector 1212 selects the relevant service.

In some embodiments, the reactive mode 1300 may use multi-step private dialogue. The system may output a private prompt or private output 1216, receive user confirmation 1218, modify the semantic objective 1204, select a different selected candidate referent 1210, or request clarification. For example, if the user 1000 silently says “pay for this,” the system may privately output “Do you want to pay £18.40 at this terminal using your default card?” The user 1000 may then silently confirm, reject, or modify the request. Such multi-step dialogue may occur without nearby persons perceiving the interaction.

In some embodiments, the reactive mode 1300 may use confidence thresholds. If the confidence value 1138 associated with the semantic objective 1204, selected candidate referent 1210, or assistant operation 1214 exceeds a threshold, the system may proceed automatically or with a brief private confirmation. If the confidence value 1138 is below the threshold, the system may ask a clarification question. If the assistant operation 1214 is sensitive, the system may require user confirmation 1218 regardless of confidence. Sensitive operations may include payment, message sending, calling, unlocking, trusted-contact escalation, emergency contact, evidence preservation, public output, or disclosure of personal information.

In some embodiments, the reactive mode 1300 may be context-disambiguated by the contextual representation 1120. For example, if the user 1000 silently says “is it safe,” the system may interpret the expression differently depending on whether the contextual representation 1120 includes a food item, medicine package, route, vehicle, person, payment terminal, or website. If the contextual representation 1120 includes a menu and allergy-related user information, the semantic objective 1204 may be interpreted as a dietary-safety query. If the contextual representation 1120 includes a dark street and a persistent person referent, the semantic objective 1204 may be interpreted as a personal-safety query.

In some embodiments, the reactive mode 1300 may operate in combination with public companion-device output 1072. For example, the user 1000 may silently formulate a sentence in a source language, the translation processor 1402 may generate target-language output 1406, and the companion handheld device 1060 may output the target-language output 1406 through public speaker output 1408 to a third party. The user 1000 may receive replies privately through the ear-worn device 1014. Thus, the user 1000 may converse with a third party without audibly speaking the source-language utterance.

In some embodiments, the reactive mode 1300 may operate in a communication session 1500. The user 1000 may provide silent or low-audibility user input 1200 while communicating with a remote participant 1510. After wearer authentication 1502, the voice synthesis processor 1508 may generate generated user-voice audio 1512 using a user voice profile 1506. The generated user-voice audio 1512 may be transmitted to the remote participant 1510, while the remote participant's audio is output privately through the ear-worn device 1014. This enables private speech input in public environments while providing normal or natural speech output to the remote participant 1510.

In some embodiments, the reactive mode 1300 may be personalized using the longitudinal user-specific context 1600. For example, the system may learn the user's preferred phrasing, preferred confirmation style, trusted contacts, payment preferences, safety thresholds, communication style, humor preference, social assistance preferences, or preferred service choices. Such personalization may be used to reduce friction while preserving privacy and safety. For example, the system may use a shorter confirmation for routine low-risk actions and a stronger confirmation for unusual or high-risk actions.

In some embodiments, the reactive mode 1300 may update the longitudinal user-specific context 1600 based on outcomes. If the user 1000 confirms a suggested referent, rejects an action, corrects a name, changes a translation, selects a trusted contact, cancels a payment, delays a message, or accepts a safety suggestion, the system may store this as prior support outcome data 1610. The prior support outcome data 1610 may later be used to improve referent resolution, assistant service selection, intervention level selection, and private output generation.

The embodiments described in this section may be combined with the ear-worn optical and infrared contextual sensing embodiments, natural head-motion contextual mapping embodiments, referent resolution embodiments, private output embodiments, translation embodiments, communication embodiments, payment embodiments, safety embodiments, and longitudinal companion-state embodiments described elsewhere herein. In particular, the reactive mode 1300 provides a user-initiated pathway by which the silent or low-audibility user input 1200 is converted into the semantic objective 1204, grounded against the contextual representation 1120, routed by the assistant service selector 1212, and completed through the assistant operation 1214.

### Proactive Companion Mode and Ambient Guardian Operation

In some embodiments, the ear-worn contextual companion platform 1001 operates in a proactive mode 1302. In the proactive mode 1302, the platform 1001 may detect a user-relevant condition 1304 without receiving contemporaneous silent or low-audibility user input 1200 from the user 1000. The user-relevant condition 1304 may be detected from the contextual representation 1120, optical or infrared sensor data from the optical or infrared sensor 1030, acoustic data from the outward microphone 1020 or inward microphone 1022, inertial data from the inertial measurement unit 1040, location data, communication data, notification data, application context, the longitudinal user-specific context 1600, or a combination thereof.

In some embodiments, the proactive mode 1302 enables the ear-worn contextual companion platform 1001 to operate as an ambient guardian. In such embodiments, the platform 1001 may monitor contextual conditions around the user 1000, determine that a user-relevant condition 1304 satisfies an alert condition 1306, generate an action proposal 1308, select an intervention level 1310, output private assistant output 1070 through the ear-worn device 1014, receive user confirmation 1218, and initiate an assistant operation 1214 when appropriate.

The alert condition 1306 may relate to safety, mobility, social context, communication context, translation context, emotional context, financial context, environmental context, or another context. For example, the alert condition 1306 may indicate that a vehicle, bicycle, person, animal, obstacle, or door is approaching the user 1000; that a personal item associated with the user 1000 has been left behind; that a known person is approaching; that a route is becoming unsafe; that a sign or announcement is relevant; that ambient speech concerns the user 1000; that a message or notification is emotionally significant; that the user 1000 may be impaired or overloaded; that a payment or outgoing communication may be risky; or that the user 1000 may need assistance.

In some embodiments, the proactive mode 1302 may detect a candidate vehicle or hazard referent 1130. The platform 1001 may determine, from optical or infrared observations, acoustic signals, inertial data, or location data, that a vehicle, bicycle, scooter, person, animal, or other moving object is approaching the user 1000. The platform 1001 may determine a trajectory, bearing, speed, proximity, closing rate, or collision risk associated with the candidate vehicle or hazard referent 1130. If the risk satisfies the alert condition 1306, the platform 1001 may output private assistant output 1070 indicating a direction, urgency, or recommended action, such as “left,” “bike behind,” “car approaching,” or another warning.

In some embodiments, the proactive mode 1302 may detect a personal item separation event. The platform 1001 may store a candidate object referent 1126 as being associated with the user 1000, such as a bag, wallet, phone, keys, laptop, stroller, umbrella, medication package, or other personal item. The platform 1001 may detect that the user 1000 is moving away from the candidate object referent 1126, that the candidate object referent 1126 is no longer within a threshold distance, that the candidate object referent 1126 remains at a previous location, or that another person is approaching or moving the candidate object referent 1126. If such condition satisfies the alert condition 1306, the platform 1001 may privately output a warning, reminder, or action proposal 1308.

In some embodiments, the proactive mode 1302 may detect a persistent-following condition. The platform 1001 may associate multiple temporally separated observations 1112 of a candidate person referent 1124, candidate vehicle or hazard referent 1130, or other candidate referent 1122 across multiple times, locations, directions, or head orientations. The platform 1001 may determine that the candidate referent 1122 has remained near the user 1000, followed a similar route, approached repeatedly, appeared at multiple locations, maintained an unusual angular relationship to the user 1000, or otherwise satisfied a persistence criterion. If the persistence criterion and one or more risk criteria satisfy the alert condition 1306, the platform 1001 may generate a private warning, propose a transportation action 1314, propose a trusted contact action 1312, propose an evidence preservation action 1316, or recommend another protective action.

In some embodiments, the proactive mode 1302 may detect an unsafe-route or unsafe-location condition. The platform 1001 may use location data, map data, time of day, crowd density, lighting information, user travel state, inertial data, acoustic data, optical or infrared observations, or safety policy 1604 to determine whether the user 1000 is moving into a less safe area, moving away from a planned route, moving away from a hotel or home, approaching a road, platform edge, isolated area, blocked exit, or other risk-associated location. If the unsafe-route or unsafe-location condition satisfies the alert condition 1306, the platform 1001 may output private assistant output 1070 proposing a safer route, trusted contact action 1312, transportation action 1314, or other assistant operation 1214.

In some embodiments, the proactive mode 1302 may detect a social approach condition. The platform 1001 may identify a candidate person referent 1124 before the user 1000 directly engages, faces, or interacts with the candidate person referent 1124. The candidate person referent 1124 may be associated with relationship data 1602, calendar data, event data, prior interaction data, communication history, or other data in the longitudinal user-specific context 1600. The platform 1001 may determine that the candidate person referent 1124 satisfies a user-relevant condition 1304, such as a desired social opportunity, an approaching colleague, an approaching client, a person the user 1000 wanted to avoid, a host, a person with whom the user 1000 has an outstanding obligation, or a person whose name or context may be useful. The platform 1001 may privately output a name, relationship cue, conversational prompt, warning, or other private assistant output 1070.

In some embodiments, the proactive mode 1302 may detect a translation opportunity. The platform 1001 may detect a candidate text-bearing referent 1128, ambient foreign-language speech, a transport announcement, a sign, menu, product label, warning label, name badge, or other language-bearing referent. The platform 1001 may determine that the detected language-bearing referent is relevant to the user 1000 based on location, head orientation, proximity, route, calendar context, user preference, safety policy 1604, or semantic relevance. The platform 1001 may output private assistant output 1070 indicating that a translation is available or may directly provide a translation when confidence and relevance exceed a threshold.

In some embodiments, the proactive mode 1302 may detect that ambient speech is user-relevant. The outward microphone 1020 may detect ambient speech. The platform 1001 may determine that the ambient speech is in a language different from a preferred language of the user 1000, or that the ambient speech includes a name, nickname, pronoun, gesture, pointing event, gaze direction, location, person identity, hostile sentiment, threatening content, reputational content, or other indication that the ambient speech concerns the user 1000. The platform 1001 may generate private assistant output 1070 comprising a summary, translation, warning, or action proposal 1308. In high-confidence or high-severity cases, the platform 1001 may select a more direct intervention level 1310.

In some embodiments, the proactive mode 1302 may detect a cross-cultural or unfamiliar-environment risk condition. For example, while the user 1000 is travelling, the platform 1001 may use location data, ambient speech, approach trajectories, coordinated movements of multiple persons, known scam patterns, user-specific vulnerability context, route context, transportation context, or other contextual information to determine that an apparently friendly approach may be associated with a risk condition. The platform 1001 may detect a discrepancy between a positive apparent social signal and a detected risk condition. If the detected risk condition satisfies the alert condition 1306, the platform 1001 may privately output a warning, recommend leaving, propose a route change, or propose a trusted contact action 1312 or transportation action 1314.

In some embodiments, the proactive mode 1302 may detect an emotionally significant communication or notification. The companion handheld device 1060, companion wrist-worn device 1062, or remote assistant system 1066 may receive an email, text message, call, legal notice, medical notice, financial notification, social notification, or other communication associated with the user 1000. The platform 1001 may determine that the communication is likely to be emotionally significant, urgent, distressing, or associated with a prior support outcome. The platform 1001 may use the user-state estimator 1612, longitudinal user-specific context 1600, communication style profile 1608, and prior support outcome data 1610 to generate private assistant output 1070 that summarizes, contextualizes, delays, calms, recommends, or proposes a trusted contact action 1312.

In some embodiments, the proactive mode 1302 may detect a reduced-capacity or vulnerability condition of the user 1000. The user-state estimator 1612 may infer that the user 1000 is intoxicated, fatigued, anxious, overloaded, distracted, disoriented, distressed, impaired, panicked, sleep-deprived, experiencing sensory overload, or otherwise less able to monitor surroundings or make decisions. Such inference may be based on gait, head motion, speech pattern, reaction time, missed prompts, repeated route loops, location, time of day, calendar context, biometric data, prior user behavior, or user-declared state. In response, the platform 1001 may lower thresholds for alert conditions 1306, increase confirmation requirements for risky actions, output more frequent private prompts, or initiate protective assistant operations 1214 after user confirmation 1218.

In some embodiments, the proactive mode 1302 may detect a self-originating risk. A self-originating risk may include a proposed payment, message, call, route choice, ride choice, social interaction, purchase, disclosure, or other action that may be inconsistent with safety policy 1604, user-specific preferences, prior support outcome data 1610, detected user state, or current context. The platform 1001 may generate protective friction by outputting private assistant output 1070, requesting user confirmation 1218, delaying an action, requiring additional authentication, proposing an alternative action, or escalating to a trusted contact action 1312. For example, the platform 1001 may privately ask whether to pause payments, delay a message, avoid an unverified vehicle, or call a trusted contact.

In some embodiments, the proactive mode 1302 may select the intervention level 1310 from a plurality of intervention levels. The intervention levels may include no action, quiet monitoring, a low-priority private prompt, a direct warning, a request for confirmation, a delay or protective friction, a trusted contact action 1312, a transportation action 1314, emergency escalation, evidence preservation action 1316, or another action. The selected intervention level 1310 may depend on confidence, severity, user state, location, time, safety policy 1604, user preference, legal or regulatory setting, and prior support outcome data 1610.

In some embodiments, the action proposal 1308 may identify one or more protective actions. Protective actions may include changing direction, crossing a street, moving toward a public area, selecting a safer route, initiating a transportation action 1314, initiating a trusted contact action 1312, sharing location, calling emergency services, sending a preconfigured message, increasing sensor sampling, initiating evidence preservation action 1316, delaying a payment, delaying a message, initiating a check-in timer, or prompting the user 1000 to confirm that no assistance is needed. The action proposal 1308 may be output privately so that a person associated with the alert condition 1306 does not perceive the prompt.

In some embodiments, the platform 1001 may receive user confirmation 1218 in response to the action proposal 1308. User confirmation 1218 may be provided by silent or low-audibility user input 1200, a click-equivalent sound, a head gesture, touch input, biometric input, or another private input. The platform 1001 may initiate the selected assistant operation 1214 only after receiving user confirmation 1218, unless a safety policy 1604 authorizes automatic action when the user 1000 fails to respond or when a severity threshold is exceeded.

In some embodiments, absence of user confirmation 1218 may itself be relevant. For example, if the platform 1001 detects a high-risk alert condition 1306 and outputs a private prompt, failure of the user 1000 to respond within a threshold period may cause escalation under the safety policy 1604. Such escalation may include initiating a trusted contact action 1312, sharing location, increasing sensor sampling, initiating evidence preservation action 1316, or contacting emergency services, depending on the user settings and applicable policy.

In some embodiments, the proactive mode 1302 may use adaptive candor. Adaptive candor may comprise selecting how direct, blunt, gentle, humorous, formal, urgent, or minimal the private assistant output 1070 should be. The communication style profile 1608 may indicate whether the user 1000 prefers direct warnings, gentle prompts, humorous prompts, formal prompts, minimal prompts, or other styles. The platform 1001 may suppress hedging or humorous output when the alert condition 1306 has high confidence and high severity. Conversely, the platform 1001 may use a softer or more tentative prompt when confidence is lower or severity is lower.

In some embodiments, proactive outputs may be suppressed when they would be distracting or socially disruptive. For example, the platform 1001 may delay a low-priority reminder during an active conversation, suppress a non-urgent prompt when the user 1000 is crossing a street, avoid repeated alerts when the user 1000 has recently dismissed similar alerts, or reduce output when the user 1000 is in a meeting. Suppression or delay may be overridden for high-severity alert conditions 1306.

In some embodiments, the platform 1001 may learn from the outcome of proactive interventions. If the user 1000 accepts, rejects, ignores, corrects, or modifies the action proposal 1308, the platform 1001 may store corresponding prior support outcome data 1610. Such data may later be used to adjust confidence thresholds, intervention levels 1310, action proposals 1308, safety policy 1604, or communication style profile 1608.

The embodiments described in this section may be combined with the reactive mode 1300, referent resolution, contextual mapping, private output, translation, communication, safety, evidence preservation, reduced-capacity, and longitudinal companion-state embodiments described elsewhere herein. In particular, the proactive mode 1302 enables the ear-worn contextual companion platform 1001 to identify and act upon user-relevant conditions 1304 without waiting for a contemporaneous command from the user 1000, while preserving privacy by delivering private assistant output 1070 through the ear-worn device 1014 and, where appropriate, receiving private user confirmation 1218 before initiating external actions.

### Context-Disambiguated Silent Interpretation and Translation

In some embodiments, the ear-worn contextual companion platform 1001 may provide interpretation or translation services based on silent or low-audibility user input 1200, contextual representation 1120, and public companion-device output 1072. The platform 1001 may allow the user 1000 to silently or quietly express an utterance in a source language, determine semantic content of the utterance using the silent speech processor 1202, disambiguate the utterance using the contextual representation 1120, translate the utterance using a translation processor 1402, and output target-language output 1406 to a third party.

In some embodiments, the user 1000 may silently or quietly utter a phrase in a source language. The silent or low-audibility user input 1200 may be processed by the silent speech processor 1202 to generate a semantic objective 1204, text, phonemes, words, phrases, language-model output, or other representation of the source-language utterance. The translation processor 1402 may translate the semantic objective 1204 or recognized text into target-language output 1406. The target-language output 1406 may be output as public companion-device output 1072, such as public speaker output 1408 from the companion handheld device 1060, companion wrist-worn device 1062, companion head-mounted device 1064, vehicle system, external speaker, conference device, or another output device.

In some embodiments, the source-language utterance may be silent or substantially private to the user 1000, while the target-language output 1406 is audible or otherwise perceptible to another person. For example, the user 1000 may silently utter an English-language question, and the companion handheld device 1060 may output a Japanese-language, German-language, French-language, Spanish-language, Mandarin-language, Arabic-language, or other target-language version of the question through public speaker output 1408. A reply from the other person may be detected as a foreign-language reply 1410 by the outward microphone 1020, companion handheld device 1060, or another microphone, translated by the translation processor 1402, and output privately to the user 1000 as private return translation 1412 through the ear-worn device 1014.

In some embodiments, the platform 1001 may use the contextual representation 1120 to perform context-disambiguation processing by a context-disambiguation processor 1404. The context-disambiguation processor 1404 may use candidate referents 1122, selected candidate referent 1210, location, point-of-interest data, application context, ambient speech, user history, relationship data 1602, safety policy 1604, or other context to disambiguate semantic content of the silent or low-audibility user input 1200 before translation. This may allow the platform 1001 to select a correct word sense, grammatical structure, politeness level, formality level, domain-specific expression, classifier, gender, honorific, or culturally appropriate phrasing.

For example, if the user 1000 silently utters “is this safe,” the context-disambiguation processor 1404 may determine whether “safe” refers to allergy safety of a food item, medical safety of a medication package, physical safety of a route, safety of a taxi, safety of a payment transaction, or another meaning. If the contextual representation 1120 includes a candidate text-bearing referent 1128 corresponding to a menu and the longitudinal user-specific context 1600 includes dietary restrictions, the platform 1001 may translate the utterance as a dietary-safety question. If the contextual representation 1120 includes a candidate vehicle or hazard referent 1130 or an unsafe route, the platform 1001 may interpret the same utterance as a personal-safety question.

In another example, if the user 1000 silently utters “how much is that,” the context-disambiguation processor 1404 may determine whether the selected candidate referent 1210 is a product, menu item, ticket, taxi ride, hotel service, repair service, or other price-bearing referent. The translation processor 1402 may then generate target-language output 1406 using phrasing appropriate to the context. In another example, if the user 1000 silently utters “can I take this,” the context-disambiguation processor 1404 may distinguish between buying an item, taking a printed brochure, taking a seat, taking a train, taking medicine, or removing an object.

In some embodiments, the contextual representation 1120 may identify the addressee of the translated utterance. For example, the referent resolver 1208 may select a candidate person referent 1124 as the addressee based on head-orientation information 1116, proximity, acoustic source direction, gaze information if available, gesture information, social context, or recent interaction history. The target-language output 1406 may then be directed to the addressee through public speaker output 1408, displayed on the companion handheld device 1060, transmitted to another device, or otherwise output in a manner appropriate for the interaction.

In some embodiments, the context-disambiguation processor 1404 may use text-bearing referents. For example, the contextual representation 1120 may include a candidate text-bearing referent 1128 corresponding to a sign, menu, product label, transport board, warning notice, name badge, ticket machine, payment terminal, or document. The user 1000 may provide silent or low-audibility user input 1200 such as “translate that,” “read that,” “what does that say,” “which one is mine,” “is this vegetarian,” or “does that contain peanuts.” The platform 1001 may resolve the utterance to the candidate text-bearing referent 1128, perform optical character recognition or access stored text, translate or interpret the text, and output private assistant output 1070 or public companion-device output 1072.

In some embodiments, a candidate text-bearing referent 1128 may be selected even when it is a referent outside current field of view 1136. For example, the user 1000 may briefly pass a sign or menu, the optical or infrared sensor 1030 may obtain a usable observation, and the contextual representation 1120 may store features or text associated with that sign or menu. The user 1000 may later silently utter “what did that say” or “translate that.” The platform 1001 may retrieve the candidate text-bearing referent 1128 from the contextual representation 1120 and generate a translation or explanation even though the sign or menu is not currently within the instantaneous sensor field of view 1110.

In some embodiments, the target-language output 1406 may be generated as speech using a voice associated with the user 1000. For example, the translation processor 1402 may generate target-language text, and a voice synthesis processor 1508 may generate speech audio in a voice profile 1506 associated with the user 1000. The resulting target-language output 1406 may be output through public speaker output 1408. In such embodiments, wearer authentication 1502 or another authentication mechanism may be required before generating public output in a user-associated voice.

In some embodiments, the platform 1001 may select a politeness level, formality level, honorific form, tone, or register of the target-language output 1406 based on contextual information. For example, the context-disambiguation processor 1404 may determine whether the addressee is a stranger, service worker, colleague, child, official, elder, friend, family member, or known contact. The platform 1001 may then select a formal, informal, polite, urgent, apologetic, concise, humorous, or deferential translation style. This may be especially useful in languages in which social relationship, hierarchy, age, status, or context affects the proper form of expression.

In some embodiments, the platform 1001 may support two-way interpretation. In a two-way interpretation mode, the user 1000 provides source-language silent or low-audibility user input 1200, the platform 1001 outputs target-language output 1406 publicly, the outward microphone 1020 or other microphone detects foreign-language reply 1410, the translation processor 1402 translates the foreign-language reply 1410 into a preferred language of the user 1000, and the ear-worn device 1014 outputs private return translation 1412 as private assistant output 1070. The user 1000 may thereby conduct a spoken interaction while the user's own source-language utterances remain private or substantially private.

In some embodiments, the platform 1001 may support proactive translation. For example, the outward microphone 1020 may detect ambient speech in a language different from a preferred language of the user 1000. The platform 1001 may determine that the ambient speech is user-relevant based on a name, nickname, pronoun, gesture, pointing event, location, proximity, head-orientation information 1116, relationship data 1602, hostile sentiment, threatening content, reputational content, or another relevance indicator. Without receiving contemporaneous silent or low-audibility user input 1200, the platform 1001 may output private assistant output 1070 indicating that the ambient speech appears user-relevant, offering to translate it, or providing a summary or warning.

In some embodiments, proactive translation may be suppressed when relevance or confidence is low. For example, the platform 1001 may avoid translating ambient conversations that are not user-relevant, may provide only a prompt asking whether translation is desired, or may provide a summary rather than verbatim translation. In other embodiments, when the confidence value 1138 and severity are high, the platform 1001 may output a direct private warning. For example, if the platform 1001 determines that ambient speech concerns the user 1000 and includes hostile, threatening, discriminatory, scam-related, reputational, or safety-relevant content, the platform 1001 may select a higher intervention level 1310 and output a more direct private assistant output 1070.

In some embodiments, the platform 1001 may detect cross-cultural or unfamiliar-environment risks during translation or interpretation. For example, the context-disambiguation processor 1404 may combine translated speech content, local context, location data, approach trajectories, gestures, apparent social signals, candidate person referents 1124, candidate vehicle or hazard referents 1130, and known risk patterns to determine that an interaction may involve distraction, pickpocketing, coercion, overcharging, unsafe transportation, impersonation, following, coordinated approach, or another risk. The platform 1001 may output private assistant output 1070 explaining the detected risk or recommending an action.

In some embodiments, the platform 1001 may translate not only linguistic content but also situational meaning. For example, the platform 1001 may determine that a nearby person's words, tone, gestures, and movement suggest that the person is not merely offering help but attempting to lead the user 1000 away from a safe location. The platform 1001 may output private assistant output 1070 such as a warning, caution, or suggestion to decline, without necessarily providing a full verbatim translation. Such output may be based on the selected intervention level 1310, safety policy 1604, confidence value 1138, and user settings.

In some embodiments, the platform 1001 may perform translation while preserving privacy of the user 1000. The source-language utterance may be silent or low-audibility and therefore not intelligible to nearby persons. The target-language output 1406 may be public only to the extent needed for communication with a third party. Replies may be translated privately to the user 1000 through the ear-worn device 1014. User confirmation 1218 may be requested before outputting target-language output 1406 publicly, especially when confidence is low, when the content is sensitive, when the addressee is uncertain, or when the translation could disclose personal information.

In some embodiments, the translation processor 1402 may be distributed. Portions of translation processing may be performed by the processor 1042 of the ear-worn device 1014, companion handheld device 1060, companion wrist-worn device 1062, companion head-mounted device 1064, or remote assistant system 1066. The system may select local or remote processing based on privacy, latency, network availability, language pair, computational requirements, cost, or user preference. In privacy-sensitive situations, the system may perform at least initial language detection, relevance detection, and user confirmation locally before transmitting data to a remote service.

In some embodiments, the platform 1001 may use the longitudinal user-specific context 1600 to personalize translation. For example, the system may know preferred languages, dialects, formality preferences, dietary restrictions, medical restrictions, travel itinerary, known contacts, calendar events, payment preferences, or prior interactions. Such information may be used by the context-disambiguation processor 1404 to interpret ambiguous utterances, choose a translation style, determine whether a detected sign is relevant, or decide whether proactive translation should occur.

In some embodiments, the platform 1001 may store prior translation outcomes as prior support outcome data 1610. For example, if the user 1000 corrects a translation, selects a different meaning, rejects a proposed translation, or confirms a translation in a given context, the platform 1001 may use such outcome data to improve future translations, context-disambiguation decisions, referent resolution, or intervention-level selection.

The embodiments described in this section may be combined with the reactive mode 1300, proactive mode 1302, referent resolution, contextual mapping, private output, public output, communication session, safety, evidence preservation, and longitudinal companion-state embodiments described elsewhere herein. In particular, the contextual representation 1120 may allow silent or low-audibility user input 1200 to be translated with situational grounding, while the ear-worn device 1014 provides the private input and return-output channel and the companion handheld device 1060 or another device provides public target-language output 1406 where appropriate.

### Social Referent Assistance and Conversational Cueing

In some embodiments, the ear-worn contextual companion platform 1001 may provide social referent assistance. Social referent assistance may comprise identifying, remembering, contextualizing, or providing private information about a candidate person referent 1124 in a social environment. A social environment may include, without limitation, a party, meeting, conference, restaurant, office, reception, classroom, courtroom, shop, transport environment, event venue, street, family gathering, or other environment in which the user 1000 may encounter or interact with other persons.

In some embodiments, the optical or infrared sensor 1030, outward microphone 1020, inertial measurement unit 1040, companion handheld device 1060, companion wrist-worn device 1062, companion head-mounted device 1064, or remote assistant system 1066 may generate or receive information relating to a candidate person referent 1124. Such information may include facial features, body features, clothing features, gait features, voice features, name information, badge information, location information, event information, calendar information, social context, prior interaction information, or another cue that may assist in identifying or contextualizing a person.

In some embodiments, the candidate person referent 1124 may be stored in the contextual representation 1120. The candidate person referent 1124 may be associated with one or more confidence values 1138, relationship data 1602, prior interaction data, event data, location data, communication history, contact data, or other information from the longitudinal user-specific context 1600. The candidate person referent 1124 may be currently within the instantaneous sensor field of view 1110, may have been observed during the preceding time window 1134, or may be a referent outside current field of view 1136 that remains represented in the contextual representation 1120.

In some embodiments, the user 1000 may provide silent or low-audibility user input 1200 comprising a social query. Examples of social queries include “who is that,” “where do I know him from,” “what is her name,” “what did we last discuss,” “what did I promise him,” “is that the investor,” “what should I ask her,” “did I meet him in Zurich,” “what is his company,” “what is her husband's name,” or another query concerning a person, relationship, prior interaction, obligation, or social context. The silent speech processor 1202 may determine a semantic objective 1204 corresponding to the social query, and the referent resolver 1208 may select the candidate person referent 1124 as the selected candidate referent 1210.

In some embodiments, the platform 1001 may generate private assistant output 1070 comprising a name, relationship, social role, prior meeting, prior communication, calendar context, event context, remembered obligation, personal preference, suggested conversation topic, warning about a topic, or other social-context cue associated with the selected candidate referent 1210. The private assistant output 1070 may be delivered through the ear speaker or private output transducer 1018 in a manner perceptible to the user 1000 and not perceptible to nearby persons, including the person represented by the candidate person referent 1124.

In some embodiments, the platform 1001 may provide conversational cueing. Conversational cueing may comprise generating one or more suggested utterances, topics, questions, reminders, warnings, or timing cues to assist the user 1000 in a social interaction. For example, the platform 1001 may output “ask about the Zurich meeting,” “you promised to send the deck,” “avoid discussing the contract,” “she mentioned her daughter's exam,” “he prefers short answers,” “pause, he appears to be speaking,” “you already told that story,” or another conversational prompt. Such conversational cueing may be based on relationship data 1602, prior support outcome data 1610, communication history, event context, acoustic context, visual context, or the current interaction.

In some embodiments, the platform 1001 may operate as a social memory assistant. The platform 1001 may use the longitudinal user-specific context 1600 to retrieve prior interactions between the user 1000 and the selected candidate referent 1210. The prior interactions may include prior meetings, emails, messages, calls, shared calendar events, tasks, promises, documents, transactions, social media interactions, photographs, location history, or other permissioned data. The platform 1001 may summarize the relevant information privately to the user 1000 before or during the social interaction.

In some embodiments, the platform 1001 may support users who have difficulty remembering names, recognizing faces, initiating conversation, interpreting social cues, timing responses, or maintaining conversational context. Such difficulty may arise from stress, fatigue, age, cognitive overload, neurodivergent traits, hearing loss, unfamiliarity, intoxication, emotional state, memory limitations, or ordinary forgetfulness. The platform 1001 may provide private assistant output 1070 comprising name recall, context recall, suggested questions, safe topics, timing cues, or reminders of obligations, without requiring the user 1000 to visibly consult a companion handheld device 1060 or audibly ask for assistance.

In some embodiments, the platform 1001 may detect a social approach condition in proactive mode 1302. The system may identify a candidate person referent 1124 approaching the user 1000, entering a nearby region, moving toward the user 1000, looking toward the user 1000, appearing in the contextual representation 1120, or otherwise becoming socially relevant. The system may determine, using relationship data 1602, calendar data, event information, location information, prior interaction data, or user preferences, that the candidate person referent 1124 satisfies a user-relevant condition 1304. The platform 1001 may then output a private social alert, name cue, relationship cue, warning, or action proposal 1308.

In some embodiments, the social approach condition may be detected before the user 1000 directly visually engages, faces, or interacts with the candidate person referent 1124. For example, the platform 1001 may privately inform the user 1000 that a known person is approaching from the left, that a client is near the entrance, that a host is looking for the user 1000, that a person the user 1000 wanted to avoid is moving toward the user 1000, or that a person the user 1000 wanted to meet is present nearby. This may allow the user 1000 to initiate, avoid, defer, prepare for, or gracefully manage a social interaction.

In some embodiments, the platform 1001 may determine a social opportunity. A social opportunity may include detecting a person the user 1000 wanted to meet, a person associated with an event goal, a person associated with an outstanding task, a person whose presence is relevant to a calendar event, or a person associated with a relationship or business objective. The platform 1001 may output private assistant output 1070 identifying the opportunity and suggesting an action. For example, the platform 1001 may privately output a prompt indicating that a particular contact is nearby and that the user 1000 previously intended to discuss a specific topic.

In some embodiments, the platform 1001 may determine a social risk. A social risk may include detecting a person the user 1000 wanted to avoid, a person associated with a conflict, a person associated with a sensitive topic, a person whose name the user 1000 is likely to forget, a person whose presence may make an ongoing conversation awkward, or a person associated with a user-specific caution. The platform 1001 may output private assistant output 1070 enabling the user 1000 to prepare for, avoid, or manage the social risk.

In some embodiments, the platform 1001 may use ambient speech to assist social interaction. The outward microphone 1020 may detect speech by or near a candidate person referent 1124. The platform 1001 may identify the speaker, transcribe or summarize speech, detect whether the user 1000 is being addressed, detect whether the user 1000 is interrupting, detect whether a person wants to leave, detect whether a person is asking a question, or detect whether a conversation topic has changed. The platform 1001 may privately output a cue to the user 1000, such as a suggested response, reminder to answer, suggestion to pause, or warning that the conversation has shifted.

In some embodiments, the platform 1001 may combine social referent assistance with translation. For example, the selected candidate referent 1210 may be a person speaking a language different from a preferred language of the user 1000. The platform 1001 may identify the person, translate the person's speech into private return translation 1412, and generate private assistant output 1070 comprising both translation and social context. Conversely, the user 1000 may silently express a response in a source language, and the platform 1001 may output target-language output 1406 to the person while privately providing social guidance to the user 1000.

In some embodiments, the platform 1001 may combine social referent assistance with safety or ambient guardian functions. For example, a candidate person referent 1124 may be determined to be approaching too directly, remaining near the user 1000 for an unusual duration, attempting to isolate the user 1000, associated with hostile or threatening ambient speech, or associated with a prior safety concern in the longitudinal user-specific context 1600. The platform 1001 may select an intervention level 1310 and output a private warning, action proposal 1308, trusted contact action 1312, transportation action 1314, or evidence preservation action 1316.

In some embodiments, the platform 1001 may use one or more privacy filters in social referent assistance. For example, the platform 1001 may restrict face recognition, person identification, or relationship lookup to known contacts, persons at a scheduled event, persons previously authorized by the user 1000, or persons whose information is available through permissioned user-specific data. In other embodiments, the platform 1001 may provide generic social assistance without identifying a person by name, such as indicating that the person appears to be addressing the user 1000, that the person appears to be leaving, or that the user 1000 may have interrupted.

In some embodiments, the platform 1001 may request user confirmation 1218 before presenting or acting upon sensitive social information. For example, the platform 1001 may ask whether the user 1000 wants a reminder of the person's name, whether the user 1000 wants prior communication history, whether the user 1000 wants to contact a person, whether the user 1000 wants to avoid a person, or whether the user 1000 wants a suggested response. User confirmation 1218 may be provided by silent or low-audibility user input 1200, click-equivalent sound, head gesture, touch input, or another private input.

In some embodiments, the platform 1001 may update the longitudinal user-specific context 1600 based on social outcomes. For example, if the user 1000 corrects a name, confirms an identity, rejects a suggested topic, accepts a conversational prompt, marks a person as important, marks a person as to be avoided, or indicates that a cue was useful, the platform 1001 may store corresponding prior support outcome data 1610. Such data may be used to improve future candidate person referent identification, social prompt generation, tone selection, and intervention level selection.

In some embodiments, the private assistant output 1070 for social referent assistance may be generated with adaptive candor, brevity, or discretion. For example, the platform 1001 may provide only a name when time is short, provide a longer summary when the user 1000 is not actively speaking, provide a direct warning when a social risk is high, or suppress output when it would distract the user 1000. The communication style profile 1608 may indicate whether the user 1000 prefers concise cues, detailed summaries, direct warnings, humorous reminders, formal phrasing, or minimal interruptions.

In some embodiments, social referent assistance may be provided without a display. The user 1000 may receive all social context through private assistant output 1070 from the ear-worn device 1014. This may be advantageous in social environments where looking at a companion handheld device 1060 or display would be distracting, impolite, revealing, or socially awkward. In other embodiments, more detailed information may be displayed on the companion handheld device 1060, companion wrist-worn device 1062, or companion head-mounted device 1064, while brief cues are output privately through the ear-worn device 1014.

The embodiments described in this section may be combined with the reactive mode 1300, proactive mode 1302, referent resolution, contextual mapping, private output, translation, safety, trusted-contact, reduced-capacity, and longitudinal companion-state embodiments described elsewhere herein. In particular, the platform 1001 may identify a candidate person referent 1124, select that candidate person referent 1124 as a selected candidate referent 1210, retrieve social context from the longitudinal user-specific context 1600, and output private assistant output 1070 comprising social memory, conversational cueing, social opportunity, or social-risk information.

### Personal Safety Assistance and Ambient Guardian Escalation

In some embodiments, the ear-worn contextual companion platform 1001 may provide personal safety assistance. Personal safety assistance may comprise detecting, classifying, explaining, warning about, or responding to a user-relevant safety condition associated with the user 1000, the surroundings of the user 1000, another person, a vehicle, an object, a location, a route, an electronic communication, or an impending user action. In some embodiments, personal safety assistance may be provided in the proactive mode 1302, in the reactive mode 1300, or in a combination of reactive and proactive operation.

In some embodiments, the platform 1001 may detect a safety-relevant user-relevant condition 1304 by using the contextual representation 1120, candidate referents 1122, optical or infrared observations from the optical or infrared sensor 1030, acoustic observations from the outward microphone 1020, inertial data from the inertial measurement unit 1040, location data, route data, point-of-interest data, communication data, user-state data, relationship data 1602, safety policy 1604, or other information. The safety-relevant user-relevant condition 1304 may be evaluated to determine whether it satisfies an alert condition 1306.

In some embodiments, the alert condition 1306 may comprise a detected vehicle, bicycle, scooter, animal, person, obstacle, door, platform edge, roadway, staircase, uneven surface, or other physical hazard. For example, the platform 1001 may detect a candidate vehicle or hazard referent 1130, determine that the candidate vehicle or hazard referent 1130 is approaching the user 1000, and output private assistant output 1070 indicating a direction or urgency. The warning may be output through the ear speaker or private output transducer 1018 and may be spatialized according to the bearing of the hazard.

In some embodiments, the alert condition 1306 may comprise an approaching or persistent person. The platform 1001 may identify a candidate person referent 1124, determine a proximity, trajectory, relative direction, persistence, approach angle, closing rate, repetition pattern, or behavior pattern associated with the candidate person referent 1124, and determine whether the candidate person referent 1124 satisfies a safety-relevant condition. The candidate person referent 1124 may be known or unknown to the user 1000. The platform 1001 may compare the candidate person referent 1124 with relationship data 1602, prior safety events, user preferences, location data, and contextual information to select an intervention level 1310.

In some embodiments, the platform 1001 may detect a following condition. A following condition may be detected when a candidate person referent 1124, candidate vehicle or hazard referent 1130, or other candidate referent 1122 is observed across multiple temporally separated observations 1112, remains within a threshold distance of the user 1000, remains within a threshold angular region relative to the user 1000, appears at multiple locations along a route of the user 1000, changes direction in a manner correlated with the user 1000, or otherwise remains unusually associated with movement of the user 1000. The platform 1001 may determine a persistence score, risk score, confidence value 1138, or other value associated with the following condition.

In some embodiments, the platform 1001 may determine that a following condition satisfies the alert condition 1306 based on a combination of persistence, proximity, trajectory, time of day, location, crowd density, isolation, lighting, route deviation, user state, prior safety policy 1604, or user-specific settings. For example, a person seen repeatedly behind the user 1000 in a busy daytime setting may result in quiet monitoring, whereas the same pattern at night, in an isolated street, while the user 1000 is walking alone, may result in a stronger private warning or action proposal 1308.

In some embodiments, the platform 1001 may detect a personal item separation condition. The contextual representation 1120 may identify a candidate object referent 1126 as a personal item associated with the user 1000. Such personal item may include a bag, phone, wallet, laptop, keys, stroller, luggage, medication package, umbrella, coat, or other object. The platform 1001 may determine that the user 1000 is moving away from the candidate object referent 1126, that the candidate object referent 1126 remains in a previous location, that the candidate object referent 1126 is being approached or moved by another person, or that the candidate object referent 1126 is no longer detected when expected. The platform 1001 may output private assistant output 1070 indicating that the item may have been left behind.

In some embodiments, the platform 1001 may detect an unsafe transportation condition. For example, the platform 1001 may determine that an observed vehicle does not match a booked ride, that a driver or vehicle is inconsistent with booking data, that the user 1000 is being guided toward an unverified vehicle, that a route suggested by another person is inconsistent with a safe route, that a public transport platform has changed, or that an approaching vehicle presents a safety risk. The platform 1001 may output private assistant output 1070 recommending verification, avoidance, route change, transportation action 1314, trusted contact action 1312, or evidence preservation action 1316.

In some embodiments, the platform 1001 may detect a route-safety condition. The platform 1001 may compare a current route of the user 1000 with map data, point-of-interest data, crowd density, lighting data, time of day, transport availability, user preferences, known safe locations, known unsafe locations, and safety policy 1604. The platform 1001 may determine that the user 1000 is walking away from a safe route, moving toward an isolated area, moving away from a hotel, home, vehicle, venue, or trusted contact, repeatedly circling an area, approaching a road or platform edge, or otherwise deviating from an expected or safer route. The platform 1001 may output a private warning, route suggestion, or action proposal 1308.

In some embodiments, the platform 1001 may detect a social-safety condition. A social-safety condition may include detecting that a person is approaching too directly, blocking an exit, attempting to isolate the user 1000, coordinating with another person, repeatedly distracting the user 1000, watching a personal item, looking toward a bag or phone, using hostile language, attempting to coerce the user 1000, or engaging in behavior associated with a tourist scam, pickpocketing, impersonation, or unsafe transportation. The platform 1001 may use optical, infrared, acoustic, location, and contextual data to determine whether the social-safety condition satisfies the alert condition 1306.

In some embodiments, the platform 1001 may provide personal safety assistance in an unfamiliar or foreign-language environment. The platform 1001 may use translation processor 1402, context-disambiguation processor 1404, ambient speech, local context, known scam patterns, route information, and user-specific vulnerability context to determine whether a situation may involve risk despite positive apparent social signals. For example, the platform 1001 may detect that persons appear friendly but are attempting to separate the user 1000 from a safe location, personal item, companion, exit, or verified transport service.

In some embodiments, the platform 1001 may generate an action proposal 1308 in response to a safety-relevant alert condition 1306. The action proposal 1308 may include changing direction, crossing a street, moving toward a public area, entering a shop, returning to a venue, selecting a safer route, initiating a transportation action 1314, initiating a trusted contact action 1312, initiating an evidence preservation action 1316, calling emergency services, sharing location, sending a preconfigured message, increasing sensor sampling, initiating recording under privacy settings, or preparing an emergency action.

In some embodiments, the action proposal 1308 may be output as private assistant output 1070 in a manner not perceptible to a person associated with the alert condition 1306. For example, if the platform 1001 determines that a person may be following the user 1000, the platform 1001 may privately output a prompt asking whether to initiate a transportation action 1314, share location with a trusted contact, or preserve evidence. The prompt may be output through the ear speaker or private output transducer 1018, and the user 1000 may respond using silent or low-audibility user input 1200 or another private input.

In some embodiments, the transportation action 1314 may comprise selecting, requesting, modifying, or monitoring a ride-hailing service, taxi, public transport route, walking route, or rendezvous location. For example, in response to a safety-relevant alert condition 1306, the platform 1001 may select a pickup location ahead of a current direction of travel of the user 1000, select a pickup location in a lit or populated area, avoid requiring the user 1000 to stop or display the companion handheld device 1060, update the pickup location while the user 1000 continues walking, and privately guide the user 1000 to the selected pickup location. The platform 1001 may monitor whether a candidate person referent 1124 or candidate vehicle or hazard referent 1130 continues to follow the user 1000 after the transportation action 1314 is initiated.

In some embodiments, the trusted contact action 1312 may comprise calling, messaging, notifying, or sharing location with a trusted contact. The trusted contact may be selected from trusted contact data 1606 based on relationship, availability, time of day, location, prior support outcome data 1610, type of alert condition 1306, user preference, or safety policy 1604. The platform 1001 may generate a message summarizing a location, detected condition, requested assistance, risk level, or action proposal 1308. The trusted contact action 1312 may be initiated after user confirmation 1218, or automatically under conditions specified by safety policy 1604.

In some embodiments, the evidence preservation action 1316 may comprise preserving selected sensor data, derived features, event metadata, location data, time data, head-orientation information 1116, candidate referent identifiers, trajectory data, audio data, optical or infrared data, user confirmation 1218, or non-response data. The platform 1001 may maintain a rolling buffer of data and may ordinarily delete or overwrite the buffer unless an alert condition 1306, user command, user confirmation 1218, or safety policy 1604 triggers preservation. Upon triggering, the platform 1001 may store pre-event and post-event data in a protected event record.

In some embodiments, the protected event record may be encrypted, stored in secure memory, stored in a secure enclave, signed, hash-chained, time-stamped, location-stamped, uploaded to a trusted remote service, transmitted to a trusted contact, or otherwise protected against tampering. The protected event record may allow the platform 1001 to act as a safety witness if prevention or avoidance fails. The platform 1001 may preserve only data associated with the alert condition 1306, and may discard unrelated data according to privacy settings.

In some embodiments, the platform 1001 may transition from ephemeral contextual awareness to evidence preservation. In an ordinary operating mode, raw optical or infrared data, raw acoustic data, or other raw sensor data may be processed transiently and discarded. In response to a safety-relevant alert condition 1306, user confirmation 1218, non-response under safety policy 1604, or emergency trigger, the platform 1001 may increase retention, sampling rate, encryption, remote backup, or metadata generation. Thus, the platform 1001 may be configured to preserve privacy during ordinary use while enabling evidence preservation when a safety need arises.

In some embodiments, the platform 1001 may provide personal safety assistance without requiring the user 1000 to remove the companion handheld device 1060 from a pocket, bag, or other storage location. This may be advantageous where visible phone use could distract the user 1000, disclose concern to a potential threat, slow the user 1000, or escalate a situation. Private assistant output 1070 and silent or low-audibility user input 1200 may enable the user 1000 to receive warnings, confirm actions, and initiate assistance while continuing to walk or otherwise move normally.

In some embodiments, the platform 1001 may select the intervention level 1310 based on a risk score and a user-state score. The risk score may be based on proximity, persistence, trajectory, speed, location, time, isolation, ambient speech, observed behavior, known risk patterns, and safety policy 1604. The user-state score may be generated by the user-state estimator 1612 based on gait, head motion, speech pattern, reaction time, calendar context, time of day, biometric data, user-declared state, or prior behavior. The intervention level 1310 may increase when risk is high, when user state indicates reduced capacity, or when both conditions are present.

In some embodiments, the platform 1001 may provide safety assistance for a reduced-capacity state of the user 1000. Reduced capacity may include intoxication, fatigue, cognitive overload, sensory overload, panic, anxiety, distress, sleep deprivation, disorientation, medical episode, neurodivergent overload, or another state in which the user 1000 may be less able to monitor the environment or make decisions. The platform 1001 may lower thresholds for alert conditions 1306, increase private prompts, request additional user confirmation 1218, suggest a transportation action 1314, suggest a trusted contact action 1312, or delay risky actions.

In some embodiments, the platform 1001 may implement protective friction. Protective friction may comprise delaying, limiting, confirming, modifying, or discouraging a proposed user action that may create risk. Examples include delaying an outgoing message, asking for confirmation before a payment, pausing or limiting payments, confirming a ride before entry, warning against an unsafe route, recommending not to follow a stranger, or proposing a trusted contact action 1312. Protective friction may be adaptive rather than rule-based, and may depend on risk, user state, confidence, longitudinal user-specific context 1600, and prior support outcome data 1610.

In some embodiments, the platform 1001 may remain in a monitoring mode after a safety action. For example, after initiating a transportation action 1314, the platform 1001 may monitor whether the user 1000 reaches the pickup point, whether a candidate person referent 1124 continues to follow, whether the observed vehicle matches the ride-hailing booking, whether the route remains safe, whether a trusted contact responds, or whether the user 1000 fails to respond to prompts. The platform 1001 may escalate if the condition worsens or if the user 1000 fails to respond under safety policy 1604.

In some embodiments, the platform 1001 may distinguish between advice, warning, and action. Advice may be a low-urgency private suggestion. A warning may indicate a higher urgency or severity. An action may involve an external service or disclosure, such as trusted contact action 1312, transportation action 1314, emergency assistance, or evidence preservation action 1316. The platform 1001 may request user confirmation 1218 before initiating an action unless safety policy 1604 authorizes automatic escalation.

The embodiments described in this section may be combined with the proactive mode 1302, reactive mode 1300, natural head-motion contextual mapping, referent resolution, private output, translation, social referent assistance, reduced-capacity, authentication, and longitudinal companion-state embodiments described elsewhere herein. In particular, the platform 1001 may maintain the contextual representation 1120, identify safety-relevant candidate referents 1122, determine whether the user-relevant condition 1304 satisfies the alert condition 1306, privately output the action proposal 1308, receive user confirmation 1218, and initiate a protective assistant operation 1214 while preserving privacy and user control.

### Reduced-Capacity Detection and User-State-Aware Protective Intervention

In some embodiments, the ear-worn contextual companion platform 1001 may detect or infer a reduced-capacity state of the user 1000 and may adjust operation of the platform 1001 based on that reduced-capacity state. A reduced-capacity state may include, without limitation, intoxication, fatigue, panic, anxiety, emotional distress, cognitive overload, sensory overload, disorientation, sleep deprivation, medical episode, age-related memory lapse, neurodivergent overload, distraction, shock, or another state in which the user 1000 may be less able to monitor surroundings, interpret social or environmental signals, remember obligations, or make decisions consistent with previously expressed preferences.

In some embodiments, the user-state estimator 1612 may determine the reduced-capacity state based on sensor data, contextual data, interaction data, communication data, biometric data, or user-declared information. The user-state estimator 1612 may receive input from the inertial measurement unit 1040, outward microphone 1020, inward microphone 1022, silent-speech sensor 1026, optical or infrared sensor 1030, companion handheld device 1060, companion wrist-worn device 1062, companion head-mounted device 1064, or remote assistant system 1066. The user-state estimator 1612 may also use the longitudinal user-specific context 1600, safety policy 1604, communication style profile 1608, prior support outcome data 1610, calendar data, location data, time-of-day data, route data, payment data, or communication history.

In some embodiments, the reduced-capacity state may be inferred from gait, balance, walking speed, repeated route loops, unusual head motion, delayed response to private prompts, slurred or slowed speech, unusual silent-speech articulation, changes in breathing, elevated or reduced vocal effort, repeated affective utterances, failure to respond to user confirmation 1218, unusual payment behavior, unusual messaging behavior, deviation from a planned route, separation from companions, separation from personal items, or other signals. In some embodiments, the reduced-capacity state may be based on biometric data from the companion wrist-worn device 1062, such as heart rate, heart-rate variability, temperature, movement, fall detection, sleep state, stress indicators, or other physiological data.

In some embodiments, the user 1000 may expressly declare a reduced-capacity state using silent or low-audibility user input 1200. For example, the user 1000 may silently or quietly utter “I am drunk,” “help me get home,” “I feel unsafe,” “I am panicking,” “I cannot think,” “stay with me,” “do not let me send messages,” or another expression indicating a need for assistance. The silent speech processor 1202 may determine a semantic objective 1204 from the utterance, and the platform 1001 may modify safety policy 1604, intervention level 1310, or assistant operation 1214 accordingly.

In some embodiments, detecting a reduced-capacity state may cause the platform 1001 to lower a threshold for alert condition 1306. For example, if the user-state estimator 1612 determines that the user 1000 is intoxicated, fatigued, overloaded, or distressed, a following condition, unsafe route, left-behind item, unverified vehicle, risky payment, outgoing message, or social-risk condition may satisfy the alert condition 1306 at a lower level of confidence than would otherwise be required. In other embodiments, the platform 1001 may increase sampling by the optical or infrared sensor 1030, outward microphone 1020, inertial measurement unit 1040, or other sensors when a reduced-capacity state is detected.

In some embodiments, detecting a reduced-capacity state may cause the platform 1001 to increase confirmation requirements. For example, the platform 1001 may request user confirmation 1218 before payment, messaging, calling, ride selection, route selection, entry into a vehicle, disclosure of location, public companion-device output 1072, or another sensitive assistant operation 1214. In some embodiments, the platform 1001 may require stronger confirmation, repeated confirmation, biometric authentication, confirmation through a companion device, or confirmation by a trusted contact before proceeding with a high-risk operation.

In some embodiments, the platform 1001 may implement protective friction based on the reduced-capacity state. Protective friction may include delaying, limiting, interrupting, confirming, modifying, or discouraging an action proposed by or inferred from the user 1000. Protective friction may be applied to payment transactions, outgoing messages, outgoing calls, social media posts, ride selection, route choice, door unlocking, device control, information disclosure, or other actions. For example, if the user-state estimator 1612 determines that the user 1000 is impaired and the platform 1001 detects an unusually high payment request, the platform 1001 may privately ask whether to pause, limit, or reconfirm the payment.

In some embodiments, protective friction may be adaptive rather than absolute. The platform 1001 may select the intervention level 1310 based on the reduced-capacity state, risk score, confidence value 1138, severity, prior support outcome data 1610, safety policy 1604, communication style profile 1608, and current context. For example, a purchase that is unusual for the user 1000 at night while the user 1000 appears impaired may cause a stronger confirmation prompt, whereas the same purchase during ordinary circumstances may be allowed with a shorter confirmation. In another example, a message to a particular contact after midnight may be delayed or privately flagged because the longitudinal user-specific context 1600 indicates that the user 1000 previously preferred such messages to be delayed in similar circumstances.

In some embodiments, the platform 1001 may provide a sober co-pilot function. The sober co-pilot function may comprise monitoring the current context and user state, identifying risks that the user 1000 may fail to notice, generating private assistant output 1070, receiving user confirmation 1218, and initiating an assistant operation 1214 that helps the user 1000 remain safe, oriented, socially protected, or aligned with prior preferences. Examples include guiding the user 1000 back to a hotel, calling a trusted contact, initiating a transportation action 1314, reminding the user 1000 of a personal item, confirming a booked vehicle, delaying a message, pausing payments, or warning against a risky route.

In some embodiments, the platform 1001 may determine that the user 1000 is disoriented or route-deviating. For example, the user 1000 may pass the same location multiple times, walk away from a destination, miss a transport stop, walk away from a hotel, walk into an isolated area, or repeatedly change direction without progress toward a destination. The platform 1001 may output private assistant output 1070 suggesting a route correction, asking whether the user 1000 wants navigation assistance, proposing a transportation action 1314, or initiating a trusted contact action 1312.

In some embodiments, the platform 1001 may determine that the user 1000 is separated from a companion or trusted person. For example, the platform 1001 may use location data, proximity data, calendar data, communication data, optical or infrared observations, or trusted contact data 1606 to determine that the user 1000 has separated from a friend, family member, group, escort, colleague, or caregiver. If the user-state estimator 1612 also detects reduced capacity or vulnerability, the platform 1001 may privately suggest waiting, returning, calling, messaging, sharing location, or initiating another trusted contact action 1312.

In some embodiments, the platform 1001 may determine that the user 1000 is about to enter an unsafe or unverified vehicle. The contextual representation 1120 may include a candidate vehicle or hazard referent 1130, and the companion handheld device 1060 may include ride-hailing or booking data. The platform 1001 may compare vehicle appearance, license plate, location, driver identity, timing, or route with the booking data. If there is a mismatch, and particularly if a reduced-capacity state is detected, the platform 1001 may output a direct private warning and may prevent or delay navigation or payment actions associated with the vehicle.

In some embodiments, the platform 1001 may detect risky communication. For example, the platform 1001 may determine that the user 1000 is composing, dictating, or preparing to send a message or call while in a reduced-capacity state. The platform 1001 may compare the recipient, message content, time of day, emotional tone, prior support outcome data 1610, and communication style profile 1608 with the current user state. The platform 1001 may privately suggest delaying the communication, rewriting the communication, calling a trusted contact first, or saving a draft rather than sending immediately.

In some embodiments, the platform 1001 may detect risky spending or payment activity. For example, the platform 1001 may detect multiple payments in a short period, an unusually high payment, a payment at a late hour, a payment inconsistent with location context, a payment while the user 1000 appears impaired, or a payment to a merchant associated with risk. The platform 1001 may output private assistant output 1070 asking whether to pause payments, require additional confirmation, impose a temporary limit, use a different payment method, or contact a trusted person. In some embodiments, the platform 1001 may implement a preconfigured safety policy 1604 that temporarily limits or delays payment execution under reduced-capacity conditions.

In some embodiments, the platform 1001 may detect risky social interaction. For example, the platform 1001 may detect that the user 1000 is moving away from a group with an unknown person, that a person is trying to isolate the user 1000, that a person is repeatedly approaching the user 1000, that the user 1000 is being pressured, that ambient speech suggests coercion, or that a social context resembles a prior support event stored in prior support outcome data 1610. The platform 1001 may privately output a warning, propose an exit phrase, suggest returning to a public area, initiate a trusted contact action 1312, or initiate a transportation action 1314.

In some embodiments, the platform 1001 may detect emotional distress and provide protective intervention. Emotional distress may be detected based on affective silent or low-audibility user input 1200, communication content, notification content, biometric data, interaction patterns, silence after a notification, breathing, movement, prior support outcome data 1610, or user-declared state. The platform 1001 may output private assistant output 1070 that summarizes an upsetting communication, contextualizes urgency, suggests waiting before replying, proposes a trusted contact action 1312, initiates a calming routine, or applies protective friction to outgoing communication.

In some embodiments, the platform 1001 may operate according to preconfigured user preferences. The user 1000 may configure the safety policy 1604 to specify preferred protective interventions, trusted contacts, payment restrictions, communication delays, ride-hailing preferences, escalation paths, privacy settings, evidence-preservation settings, or user-state thresholds. The platform 1001 may then apply those preferences when the user-state estimator 1612 detects reduced capacity. In some embodiments, the user 1000 may configure temporary rules before an event, such as “help me get home if I seem impaired,” “do not let me message this person after midnight,” or “share my location with this trusted contact if I do not respond.”

In some embodiments, the platform 1001 may infer what the user 1000 would likely prefer under normal capacity. The platform 1001 may use the longitudinal user-specific context 1600, prior support outcome data 1610, safety policy 1604, and current context to generate a protective intervention that is consistent with prior stated preferences or prior beneficial outcomes. For example, if the user 1000 previously accepted a delay for emotionally charged messages, the platform 1001 may suggest a delay in similar future contexts. If the user 1000 previously accepted transportation assistance when impaired, the platform 1001 may propose a transportation action 1314 in a similar state.

In some embodiments, the platform 1001 may remain user-controlled. Protective friction need not prevent the user 1000 from acting. Instead, the platform 1001 may privately prompt, delay, request confirmation, suggest an alternative, or escalate according to a user-configured safety policy 1604. In some embodiments, the user 1000 may override a protective intervention using authenticated silent or low-audibility user input 1200, biometric authentication, companion device confirmation, or another input. In other embodiments, certain actions may require stronger confirmation when the reduced-capacity state is detected.

In some embodiments, the platform 1001 may adjust output style in view of reduced capacity. The communication style profile 1608 may specify that the user 1000 prefers direct warnings, gentle prompts, minimal prompts, humorous prompts, or formal prompts. However, when a reduced-capacity state and a high-severity alert condition 1306 are detected, the platform 1001 may suppress humor or elaborate explanations and output direct, concise private assistant output 1070. When severity is lower, the platform 1001 may output a softer or more supportive prompt.

In some embodiments, the platform 1001 may update prior support outcome data 1610 after a reduced-capacity intervention. The platform 1001 may store whether the user 1000 accepted a ride suggestion, rejected a payment pause, corrected a user-state estimate, confirmed a safety warning, overrode a message delay, called a trusted contact, or later marked an intervention as useful or not useful. Such prior support outcome data 1610 may be used to adjust future user-state estimation, safety policy 1604, communication style profile 1608, intervention level 1310, or action proposals 1308.

In some embodiments, reduced-capacity detection may be performed locally, remotely, or in distributed fashion. For example, gait and head motion may be processed locally by the processor 1042 using data from the inertial measurement unit 1040, while communication analysis may be performed by the companion handheld device 1060 or remote assistant system 1066. Privacy-sensitive data may be processed locally, while less sensitive contextual or statistical data may be processed remotely, according to user settings.

The embodiments described in this section may be combined with the personal safety assistance embodiments, proactive mode 1302, reactive mode 1300, social referent assistance, translation, evidence preservation, private output, authentication, payment, communication, and longitudinal companion-state embodiments described elsewhere herein. In particular, the user-state estimator 1612 may modify how the platform 1001 interprets the contextual representation 1120, detects alert conditions 1306, selects the intervention level 1310, generates private assistant output 1070, requests user confirmation 1218, and initiates protective assistant operations 1214.

### Evidence Preservation and Privacy-Preserving Safety Witness Operation

In some embodiments, the ear-worn contextual companion platform 1001 may provide evidence preservation in response to a safety-relevant user-relevant condition 1304 or alert condition 1306. Evidence preservation may comprise selectively retaining, protecting, encrypting, authenticating, transmitting, summarizing, or later disclosing sensor data, derived contextual data, event metadata, or other information associated with a safety-relevant event. In some embodiments, such evidence preservation may be implemented as an evidence preservation action 1316.

In some embodiments, the platform 1001 may maintain one or more rolling buffers of data. The rolling buffers may be maintained in memory 1044, in the companion handheld device 1060, in the companion wrist-worn device 1062, in the companion head-mounted device 1064, in a vehicle system, in the remote assistant system 1066, or in a combination of such devices. A rolling buffer may include raw sensor data, derived features, contextual representation data, candidate referent data, head-orientation information 1116, location data, audio data, optical or infrared data, event classifications, confidence values 1138, or other information. In an ordinary operating mode, data in the rolling buffer may be overwritten, discarded, reduced, anonymized, or converted into non-photographic derived features after a retention period.

In some embodiments, the rolling buffer may include pre-event data. Pre-event data may comprise sensor data or derived data captured before the platform 1001 determines that the user-relevant condition 1304 satisfies the alert condition 1306. For example, if the platform 1001 later determines that a candidate person referent 1124 has followed the user 1000, pre-event data may include earlier observations showing the same candidate person referent 1124 at a prior location or prior time. If the platform 1001 later determines that a candidate vehicle or hazard referent 1130 approached the user 1000, pre-event data may include trajectory or acoustic data preceding the warning.

In some embodiments, the evidence preservation action 1316 may be triggered by one or more conditions. Such conditions may include user confirmation 1218, silent or low-audibility user input 1200 requesting recording or preservation, detection of the alert condition 1306, escalation under safety policy 1604, non-response by the user 1000 after a high-severity private prompt, detection of an emergency condition, detection of a persistent-following condition, detection of an unsafe transportation condition, or detection of a personal item theft or loss condition. In some embodiments, evidence preservation may begin automatically when severity and confidence exceed thresholds defined by safety policy 1604.

In some embodiments, the platform 1001 may transition from ephemeral contextual processing to preserved evidence processing. During ephemeral contextual processing, raw optical, infrared, acoustic, location, or inertial data may be processed transiently to generate the contextual representation 1120 and then discarded. During preserved evidence processing, selected data associated with the alert condition 1306 may be retained in a protected event record. This permits the platform 1001 to provide ordinary contextual assistance while reducing unnecessary retention of raw sensor data, and to preserve evidence when a safety need arises.

In some embodiments, the protected event record may include one or more of raw optical or infrared sensor data from the optical or infrared sensor 1030, derived optical features, raw audio from the outward microphone 1020, derived acoustic features, inertial data from the inertial measurement unit 1040, head-orientation information 1116, location data, timestamps, candidate referent identifiers, candidate person referent 1124 descriptors, candidate vehicle or hazard referent 1130 descriptors, trajectory data, proximity data, speed data, confidence values 1138, intervention level 1310, private assistant output 1070, action proposal 1308, user confirmation 1218, user non-response data, or assistant operation 1214 metadata.

In some embodiments, the protected event record may include data showing persistence of a candidate referent 1122 over time. For example, the protected event record may include multiple observations of the same candidate person referent 1124 or candidate vehicle or hazard referent 1130 across multiple temporally separated observations 1112, locations, head orientations, or time intervals. The protected event record may include a computed persistence score, following score, trajectory correlation, proximity history, or route correlation associated with the candidate referent 1122.

In some embodiments, the protected event record may include information relating to a personal item separation condition. For example, if a candidate object referent 1126 associated with the user 1000 is left behind, moved, or taken, the protected event record may include the last observed location of the candidate object referent 1126, time of last observation, image-derived features, object identity, proximity history, movement by another person, private prompt output to the user 1000, and user response or non-response.

In some embodiments, the protected event record may include information relating to an unsafe transportation condition. For example, if the platform 1001 detects that an observed vehicle does not match a booked ride, the protected event record may include features of the observed vehicle, location, time, route, booking data, driver or vehicle identifier where available, private warning output, user confirmation 1218, and subsequent action. Such evidence may be useful for later review, reporting, or dispute resolution.

In some embodiments, the protected event record may be protected cryptographically. For example, the platform 1001 may encrypt the protected event record, store the protected event record in secure memory, store the protected event record in a secure enclave, generate a digital signature, generate a hash, generate a hash chain across event segments, associate a trusted timestamp, or transmit a hash or encrypted copy to the remote assistant system 1066 or a trusted third-party service. Such protection may make later tampering detectable.

In some embodiments, the evidence preservation action 1316 may include remote backup. For example, the protected event record, selected portions of the protected event record, metadata associated with the protected event record, or cryptographic hashes may be transmitted over network connection 1068 to the remote assistant system 1066, a cloud storage service, a trusted-contact device, an emergency service endpoint, an insurer, a legal representative, or another destination authorized by the user 1000 or safety policy 1604. Transmission may occur immediately, after user confirmation 1218, after loss of connectivity is restored, or after a higher severity threshold is reached.

In some embodiments, the platform 1001 may provide user-controlled disclosure. The user 1000 may control whether a protected event record is retained, shared, deleted, summarized, exported, transmitted to a trusted contact, transmitted to emergency services, transmitted to law enforcement, transmitted to an insurer, transmitted to a legal representative, or retained only locally. In some embodiments, user-controlled disclosure may be subject to exceptions defined in safety policy 1604, such as automatic sharing when the user 1000 fails to respond to a high-risk prompt or when an emergency escalation condition is satisfied.

In some embodiments, the protected event record may be summarized before disclosure. For example, the platform 1001 may generate a summary indicating that a candidate person referent 1124 appeared near the user 1000 at several locations, that a candidate vehicle or hazard referent 1130 approached from a certain direction, that a personal item was left behind, that an unsafe route condition was detected, or that a trusted contact action 1312 or transportation action 1314 was initiated. The summary may be generated by the remote assistant system 1066, companion handheld device 1060, or processor 1042, and may include links or references to underlying protected data.

In some embodiments, the platform 1001 may preserve privacy by restricting what data is retained. For example, the platform 1001 may store derived features instead of raw images, store bounding regions instead of full frames, store text strings instead of images of a sign, store object identifiers instead of raw video, store trajectory vectors instead of full video, store speech transcripts or summaries instead of raw audio, or blur, mask, or omit bystanders not associated with the alert condition 1306. In some embodiments, raw data may be retained only when necessary for a protected event record.

In some embodiments, the platform 1001 may apply retention tiers. A first tier may involve short-lived volatile processing with no retained raw data. A second tier may involve retaining derived features for a short preceding time window 1134. A third tier may involve retaining an encrypted event record when the alert condition 1306 is detected. A fourth tier may involve remote backup or trusted-contact disclosure after user confirmation 1218 or non-response under safety policy 1604. A fifth tier may involve emergency disclosure when an emergency threshold is met.

In some embodiments, evidence preservation may be initiated by a private dialogue. For example, the platform 1001 may output private assistant output 1070 such as “Do you want me to preserve evidence?”, “Do you want me to record this interaction?”, “Do you want me to keep the last few minutes?”, or “Do you want me to send this to a trusted contact?” The user 1000 may respond with silent or low-audibility user input 1200, click-equivalent input, head gesture, touch input, or another private input. The platform 1001 may then initiate evidence preservation action 1316.

In some embodiments, evidence preservation may be initiated without a contemporaneous user command. For example, if the platform 1001 detects a high-risk alert condition 1306 and the user 1000 fails to respond to a private prompt, safety policy 1604 may authorize the platform 1001 to preserve evidence automatically. Such automatic preservation may be limited to data associated with the alert condition 1306, may be encrypted, and may be disclosed only according to user settings or emergency escalation rules.

In some embodiments, evidence preservation may be used together with transportation action 1314. For example, if the platform 1001 detects a following condition and the user 1000 confirms a request for transportation, the platform 1001 may preserve pre-event and post-event data while guiding the user 1000 to a pickup location. The platform 1001 may monitor whether the candidate person referent 1124 or candidate vehicle or hazard referent 1130 continues to follow after the transportation action 1314 is initiated, and may update the protected event record accordingly.

In some embodiments, evidence preservation may be used together with trusted contact action 1312. For example, the platform 1001 may share a protected event record, live location, summary, or selected metadata with a trusted contact selected from trusted contact data 1606. The trusted contact may receive information such as location, risk summary, requested action, route, pickup location, or a statement that the user 1000 failed to respond. In some embodiments, the trusted contact may be permitted to request additional information according to safety policy 1604.

In some embodiments, evidence preservation may be used together with public companion-device output 1072. For example, the companion handheld device 1060 may display an emergency interface, a recording indicator, a live-location sharing indicator, or a prompt for the user 1000. In other embodiments, the platform 1001 may avoid visible public output to prevent alerting a person associated with the alert condition 1306, and may instead communicate privately with the user 1000 through private assistant output 1070.

In some embodiments, the protected event record may include authentication information. For example, the protected event record may include wearer authentication 1502, articulation biometric 1504, device identifiers, secure-pairing information, timestamps, or cryptographic signatures indicating that the data was collected by an authenticated ear-worn device 1014 associated with the user 1000. Such authentication information may help distinguish authentic evidence from fabricated or modified records.

In some embodiments, the platform 1001 may prevent misuse of evidence preservation. For example, the platform 1001 may restrict activation to user-authorized modes, safety-relevant contexts, user confirmation 1218, defined alert conditions 1306, or safety policy 1604. The platform 1001 may also limit retention, notify the user 1000, prevent silent long-term recording, discard unrelated bystander data, or require additional authentication before disclosure. Such measures may help preserve privacy while enabling safety-related evidence preservation.

In some embodiments, the platform 1001 may support later review by the user 1000. The user 1000 may review a timeline, summary, map, transcript, sensor-derived event list, candidate referent list, confidence values 1138, private prompts, user confirmations 1218, and actions taken. The review may occur on the companion handheld device 1060, companion wrist-worn device 1062, companion head-mounted device 1064, remote assistant system 1066, or another authorized interface. The user 1000 may then choose whether to keep, delete, export, share, or annotate the protected event record.

In some embodiments, the platform 1001 may support creation of an incident report. The incident report may include a natural-language summary, timeline, location track, relevant candidate referents 1122, selected sensor-derived evidence, user statements, private prompts, confirmations, actions, and cryptographic verification information. The incident report may be generated by the remote assistant system 1066, companion handheld device 1060, or processor 1042 and may be transmitted to a trusted contact, emergency service, insurer, legal representative, employer, school, transport provider, or other authorized recipient.

In some embodiments, evidence preservation settings may be personalized using the longitudinal user-specific context 1600. For example, the user 1000 may specify which trusted contacts may receive preserved evidence, which alert conditions 1306 trigger automatic preservation, how long protected event records are retained, whether raw data or derived features are retained, whether location is included, whether third-party disclosure requires user confirmation 1218, and whether non-response under specified conditions authorizes escalation. These settings may be stored as part of safety policy 1604.

The embodiments described in this section may be combined with the personal safety assistance embodiments, proactive mode 1302, reactive mode 1300, reduced-capacity detection, transportation action 1314, trusted contact action 1312, silent communication, authentication, contextual mapping, private output, and longitudinal companion-state embodiments described elsewhere herein. In particular, the platform 1001 may ordinarily use ephemeral contextual processing to maintain the contextual representation 1120, and may transition to evidence preservation action 1316 when the user-relevant condition 1304, alert condition 1306, user confirmation 1218, non-response, or safety policy 1604 justifies preservation.

### Longitudinal User-Specific Companion State

In some embodiments, the ear-worn contextual companion platform 1001 may maintain, access, update, or use a longitudinal user-specific context 1600. The longitudinal user-specific context 1600 may comprise information associated with the user 1000 over a time period longer than a single command, single session, single location, or single device-use event. In some embodiments, the longitudinal user-specific context 1600 may persist across days, weeks, months, years, replacement ear-worn devices 1014, replacement companion handheld devices 1060, or changes in one or more hardware components.

The longitudinal user-specific context 1600 may include relationship data 1602, safety policy 1604, trusted contact data 1606, communication style profile 1608, prior support outcome data 1610, user preferences, accessibility preferences, translation preferences, payment preferences, navigation preferences, calendar data, contact data, message history, email history, call history, location history, travel plans, medical or dietary restrictions where authorized, known devices, known vehicles, home or work locations, prior social encounters, prior safety events, prior translation events, prior emotional-support events, or other permissioned user-specific information.

In some embodiments, the longitudinal user-specific context 1600 may be used to personalize the interpretation of silent or low-audibility user input 1200. The same utterance may have different meanings depending on the user 1000, the current context, and prior interactions. For example, an affective utterance such as “oh no,” “oh bummer,” “not again,” or “help” may be treated as a minor frustration in one context, as a request for explanation in another context, as a request for trusted contact action 1312 in another context, or as a safety-related request in another context. The platform 1001 may determine the semantic objective 1204 by comparing the current context and contextual representation 1120 with the longitudinal user-specific context 1600.

In some embodiments, the relationship data 1602 may include data identifying or characterizing persons known to the user 1000. The relationship data 1602 may include names, contact records, social roles, family relationships, professional relationships, prior meetings, prior communications, shared events, obligations, preferences, sensitive topics, prior disputes, desired contacts, persons to avoid, or other relationship-associated information. When the contextual representation 1120 includes a candidate person referent 1124, the platform 1001 may compare the candidate person referent 1124 with relationship data 1602 to identify the person, provide private social context, generate a conversational cue, determine whether a social opportunity or social risk exists, or select a trusted contact action 1312.

In some embodiments, the safety policy 1604 may include user-specific rules, preferences, thresholds, permissions, or escalation paths for safety-related operation. The safety policy 1604 may specify when private warnings are generated, when evidence preservation action 1316 is triggered, when transportation action 1314 is proposed, when trusted contact action 1312 is proposed or automatically initiated, when emergency services are contacted, when payment actions are delayed, when outgoing messages are delayed, when additional authentication is required, and when non-response by the user 1000 authorizes escalation. The safety policy 1604 may be manually configured, learned from prior support outcome data 1610, or a combination thereof.

In some embodiments, the trusted contact data 1606 may identify one or more persons or services to contact in response to a user-relevant condition 1304, alert condition 1306, reduced-capacity state, emotional distress state, safety condition, medical condition, travel condition, or other context. Trusted contact data 1606 may include contact identifiers, relationship types, preferred contact order, availability, time-zone data, communication preferences, escalation permissions, prior response history, and message templates. The platform 1001 may select a trusted contact based on context, severity, time of day, location, prior support outcome data 1610, user preference, or safety policy 1604.

In some embodiments, the communication style profile 1608 may define how the platform 1001 communicates privately with the user 1000. The communication style profile 1608 may include preferences for tone, brevity, directness, formality, reassurance level, humor level, nicknames, prior shared references, warning style, confirmation style, translation style, social cue style, or support style. The communication style profile 1608 may indicate that the user 1000 prefers direct warnings in safety contexts, gentle prompts in emotional contexts, short prompts during social events, detailed explanations when alone, humorous language in low-risk contexts, or minimal interruptions during meetings.

In some embodiments, the platform 1001 may adapt the communication style profile 1608 based on context. For example, humorous or informal output may be suppressed when an alert condition 1306 exceeds a severity threshold. Direct language may be used when confidence and severity are high. Tentative language may be used when confidence value 1138 is low. A shorter prompt may be used when the user 1000 is in conversation. A longer explanation may be used when the user 1000 is alone or has requested detail. Such adaptation may be performed by the personalized output generator 1614.

In some embodiments, prior support outcome data 1610 may include data indicating how the user 1000 responded to prior prompts, warnings, translations, social cues, safety alerts, evidence-preservation suggestions, transportation suggestions, payment delays, message delays, trusted-contact suggestions, emotional-support prompts, or other assistant operations 1214. Prior support outcome data 1610 may indicate whether the user 1000 accepted, rejected, ignored, corrected, modified, later praised, or later criticized an assistant operation 1214. Such data may be used to improve future referent resolution, semantic objective determination, service selection, communication style selection, safety-policy adjustment, or intervention-level selection.

In some embodiments, the user-state estimator 1612 may use the longitudinal user-specific context 1600 to interpret the current state of the user 1000. For example, the user-state estimator 1612 may compare current gait, head movement, speech pattern, reaction time, location, time of day, communication context, notification context, payment behavior, or route behavior with prior patterns of the user 1000. Such comparison may indicate whether the user 1000 is impaired, distressed, fatigued, disoriented, anxious, overloaded, or otherwise in a state that should modify alert thresholds, confirmation requirements, or communication style.

In some embodiments, the personalized output generator 1614 may generate private assistant output 1070 based on the longitudinal user-specific context 1600. The personalized output generator 1614 may select the content, tone, urgency, length, directness, or suggested action of the private assistant output 1070 based on relationship data 1602, safety policy 1604, trusted contact data 1606, communication style profile 1608, prior support outcome data 1610, user-state estimator 1612, contextual representation 1120, semantic objective 1204, selected candidate referent 1210, confidence value 1138, and alert condition 1306.

In some embodiments, the longitudinal user-specific context 1600 may be used to determine whether a current context resembles a prior event. For example, the platform 1001 may determine that an incoming communication, location, route, person, payment context, social encounter, or safety condition resembles a prior situation in which the user 1000 benefited from a particular support strategy. The platform 1001 may then privately output a prompt suggesting the same or modified support strategy. For example, the platform 1001 may suggest waiting before sending a response, calling a trusted contact, taking a transportation action 1314, preserving evidence, or using a calming routine.

In some embodiments, the platform 1001 may use the longitudinal user-specific context 1600 to infer an implied user objective from an incomplete or affective utterance. For example, if the user 1000 receives an upsetting notification and then provides silent or low-audibility user input 1200 comprising “oh bummer,” the platform 1001 may determine, based on prior support outcome data 1610 and communication style profile 1608, that the likely semantic objective 1204 is to receive a calm summary, delay a response, or contact a trusted person. In another context, the same utterance may be interpreted as a request for translation, safety assistance, or navigation support.

In some embodiments, the longitudinal user-specific context 1600 may be used to personalize social referent assistance. For example, when the selected candidate referent 1210 is a candidate person referent 1124, the platform 1001 may retrieve relationship data 1602 indicating the name, relationship, prior meeting, recent communication, open task, sensitive topic, or suggested conversation topic associated with the person. The platform 1001 may output the information privately through the ear-worn device 1014, allowing the user 1000 to prepare for or conduct the interaction without visible consultation of another device.

In some embodiments, the longitudinal user-specific context 1600 may be used to personalize translation or interpretation. For example, the platform 1001 may know preferred languages, dialects, formality levels, dietary restrictions, allergies, travel itinerary, payment preferences, hotel location, or recurring travel contexts. Such information may be used by the context-disambiguation processor 1404 to interpret ambiguous utterances, choose target-language output 1406, determine whether a detected sign is relevant, or select whether to provide private return translation 1412.

In some embodiments, the longitudinal user-specific context 1600 may be used to personalize safety assistance. For example, the safety policy 1604 may indicate that the user 1000 prefers a trusted contact action 1312 before emergency escalation, prefers transportation action 1314 when walking alone at night, wants evidence preservation action 1316 when a following condition persists, prefers direct warnings rather than tentative language in personal-safety situations, or wants payment confirmation when a reduced-capacity state is detected. The platform 1001 may apply those preferences when generating private assistant output 1070.

In some embodiments, the longitudinal user-specific context 1600 may be portable across replacement devices. For example, when the user 1000 replaces the ear-worn device 1014, companion handheld device 1060, companion wrist-worn device 1062, or companion head-mounted device 1064, the longitudinal user-specific context 1600 may be transferred, restored, synchronized, or re-associated with the replacement device. The platform 1001 may preserve relationship data 1602, safety policy 1604, trusted contact data 1606, communication style profile 1608, prior support outcome data 1610, voice profiles, authentication settings, and other personalized settings across hardware changes.

In some embodiments, the longitudinal user-specific context 1600 may be stored locally, remotely, or in distributed form. For example, privacy-sensitive portions may be stored locally on the companion handheld device 1060 or ear-worn device 1014, while less sensitive preference data may be stored by the remote assistant system 1066. Encrypted backups may be used to preserve continuity. In some embodiments, user consent may be required before synchronizing or restoring the longitudinal user-specific context 1600 to a replacement device.

In some embodiments, the platform 1001 may maintain separate memory scopes. A short-term memory scope may correspond to the contextual representation 1120 and preceding time window 1134. A medium-term memory scope may correspond to an event, trip, meeting, conversation, commute, or night out. A long-term memory scope may correspond to the longitudinal user-specific context 1600. The platform 1001 may use different retention rules, privacy rules, and access rules for each memory scope.

In some embodiments, the longitudinal user-specific context 1600 may be updated based on explicit user input. For example, the user 1000 may instruct the platform 1001 to remember a preference, forget information, mark a person as trusted, mark a person as to be avoided, designate a trusted contact, set a safety policy, change communication style, disable a category of proactive alert, or modify a translation preference. Such instructions may be provided through silent or low-audibility user input 1200, companion handheld device 1060, companion wrist-worn device 1062, companion head-mounted device 1064, or another interface.

In some embodiments, the longitudinal user-specific context 1600 may be updated based on implicit outcomes. For example, if the user 1000 repeatedly accepts a certain type of prompt, rejects a certain type of prompt, asks for more detail, asks for shorter output, corrects a referent, accepts a transportation action 1314, declines a trusted contact action 1312, or confirms that an intervention was helpful, the platform 1001 may update prior support outcome data 1610 or communication style profile 1608 accordingly. In some embodiments, the platform 1001 may ask for confirmation before making a durable change.

In some embodiments, the platform 1001 may provide transparency or review of the longitudinal user-specific context 1600. The user 1000 may inspect, edit, delete, export, import, or restrict portions of relationship data 1602, safety policy 1604, trusted contact data 1606, communication style profile 1608, and prior support outcome data 1610. Such review may be performed through the companion handheld device 1060, companion wrist-worn device 1062, companion head-mounted device 1064, remote assistant system 1066, or another authorized interface.

In some embodiments, the platform 1001 may restrict use of sensitive longitudinal data. For example, sensitive health, safety, relationship, location, financial, or communication data may be processed locally, encrypted, access-controlled, or excluded from certain services. The platform 1001 may require authentication before accessing sensitive portions of the longitudinal user-specific context 1600. The authentication may include wearer authentication 1502, articulation biometric 1504, companion device authentication, passcode, biometric input, or another authentication mechanism.

In some embodiments, the platform 1001 may use the longitudinal user-specific context 1600 to decide when to involve a human trusted contact. The platform 1001 may determine that a detected user state, safety condition, emotional condition, or non-response condition exceeds a threshold for AI-only support. The platform 1001 may then propose or initiate a trusted contact action 1312 using trusted contact data 1606. In some embodiments, the platform 1001 may generate a concise context summary for the trusted contact, including location, detected condition, recent prompts, user confirmation 1218, or requested assistance.

In some embodiments, the platform 1001 may use the longitudinal user-specific context 1600 to preserve continuity of a personalized assistant experience. For example, the platform 1001 may maintain a persistent persona, voice, tone, prompting style, preferred name for the user 1000, relationship memories, safety preferences, and prior support strategies across time. Such continuity may cause the private assistant output 1070 to be more efficient, contextually appropriate, and trusted by the user 1000. The platform 1001 may nevertheless allow the user 1000 to reset, modify, export, or delete such continuity.

In some embodiments, the platform 1001 may use the longitudinal user-specific context 1600 to avoid over-intervention. For example, the platform 1001 may learn that a user 1000 does not want frequent social prompts, does not want translation of ambient speech unless directly relevant, prefers only high-confidence safety alerts, or prefers not to receive emotional-support prompts during work hours. The platform 1001 may adjust proactive mode 1302 accordingly.

The embodiments described in this section may be combined with the ear-worn optical and infrared contextual sensing embodiments, natural head-motion contextual mapping embodiments, referent resolution embodiments, reactive mode 1300, proactive mode 1302, social referent assistance, translation, personal safety, reduced-capacity detection, evidence preservation, authentication, and communication-session embodiments described elsewhere herein. In particular, the longitudinal user-specific context 1600 may provide the long-term personalization layer that allows the ear-worn contextual companion platform 1001 to interpret current sensor data, silent or low-audibility user input 1200, alert conditions 1306, and assistant operations 1214 in a manner specific to the user 1000.

Silent Communication Session with Authenticated User-Voice Synthesis

In some embodiments, the ear-worn contextual companion platform 1001 may enable the user 1000 to participate in a communication session 1500 using silent or low-audibility user input 1200. The communication session 1500 may comprise a telephone call, video call, conference call, voice message, push-to-talk session, online meeting, game chat, workplace communication, emergency communication, interpreted call, or another communication session involving a remote participant 1510 or another receiving party.

In some embodiments, during the communication session 1500, the user 1000 may provide silent or low-audibility user input 1200 instead of speaking audibly. The silent or low-audibility user input 1200 may comprise silent speech, subvocal speech, mouthed speech, whispered speech, low-volume speech, low-audibility speech, or another input that is not intelligible or not readily intelligible to nearby persons. The silent or low-audibility user input 1200 may be detected by the silent-speech sensor 1026, outward microphone 1020, inward microphone 1022, bone-conduction, cartilage-conduction, vibration, or body-conducted-signal sensor 1024, optical or infrared sensor 1030, inertial measurement unit 1040, companion handheld device 1060, companion wrist-worn device 1062, companion head-mounted device 1064, or a combination thereof.

In some embodiments, the silent speech processor 1202 may convert the silent or low-audibility user input 1200 into linguistic content. The linguistic content may include phonemes, visemes, words, text, semantic content, prosodic information, emotion information, urgency information, speaking style information, or another representation. The linguistic content may be generated locally by processor 1042, by the companion handheld device 1060, by the companion wrist-worn device 1062, by the companion head-mounted device 1064, by the remote assistant system 1066, or by a combination thereof.

In some embodiments, the voice synthesis processor 1508 may generate generated user-voice audio 1512 from the linguistic content. The generated user-voice audio 1512 may be generated using a user voice profile 1506 associated with the user 1000. The user voice profile 1506 may represent a normal speaking voice, a selected voice, a user-approved synthetic voice, a translated voice, a professional voice, an anonymized voice, or another voice associated with or selected by the user 1000. The generated user-voice audio 1512 may then be transmitted to the remote participant 1510 as part of the communication session 1500.

In some embodiments, the remote participant 1510 hears generated user-voice audio 1512 while nearby persons do not hear the source-language or original utterance by the user 1000. Thus, the user 1000 may participate in the communication session 1500 in a public or quiet environment without broadcasting the user's words to nearby persons. This may be advantageous on public transport, in offices, in waiting rooms, in hotels, in hospitals, in shared homes, in libraries, in restaurants, in unsafe walking situations, in noisy environments, or in any environment where audible speech by the user 1000 would be private, distracting, embarrassing, confidential, or unsafe.

In some embodiments, audio from the remote participant 1510 is output privately to the user 1000 through the ear-worn device 1014. The audio may be output as private assistant output 1070 through the ear speaker or private output transducer 1018. In some embodiments, the audio from the remote participant 1510 may be enhanced, summarized, translated, transcribed, or otherwise processed before being output to the user 1000. In some embodiments, the platform 1001 may provide private prompts, confidence warnings, suggested replies, or contextual information during the communication session 1500.

In some embodiments, the generated user-voice audio 1512 may preserve or approximate prosody, emotion, emphasis, urgency, pace, tone, or speaking style inferred from the silent or low-audibility user input 1200. For example, the platform 1001 may infer that the user 1000 intends a question, apology, warning, urgent statement, calm statement, formal statement, or informal statement. The voice synthesis processor 1508 may generate generated user-voice audio 1512 consistent with that inferred prosody or tone. In other embodiments, prosody or tone may be selected based on context, communication style profile 1608, user preference, or the communication session 1500.

In some embodiments, the platform 1001 may perform translation during the communication session 1500. For example, the user 1000 may provide silent or low-audibility user input 1200 in a source language. The translation processor 1402 may translate the source-language content into a target language, and the voice synthesis processor 1508 may generate generated user-voice audio 1512 in the target language using the user voice profile 1506 or another selected voice. Audio from the remote participant 1510 may be translated and output privately to the user 1000 as private return translation 1412. Thus, the communication session 1500 may support silent source-language input, translated user-voice output, and private translated reply output.

In some embodiments, contextual representation 1120 may be used during the communication session 1500 to disambiguate the silent or low-audibility user input 1200. For example, if the user 1000 silently says “tell him I am here,” the referent resolver 1208 may determine whether “him” refers to the remote participant 1510, a candidate person referent 1124 near the user 1000, a contact from relationship data 1602, or another person. In another example, if the user 1000 silently says “send this,” the referent resolver 1208 may determine whether “this” refers to a document, image, location, message, payment request, candidate text-bearing referent 1128, or another selected candidate referent 1210.

In some embodiments, user confirmation 1218 may be requested before transmitting generated user-voice audio 1512. For example, if the silent speech processor 1202 has a confidence value 1138 below a threshold, if the voice synthesis processor 1508 is about to transmit sensitive content, if translation confidence is low, if the recipient or remote participant 1510 is uncertain, or if the communication session 1500 involves a sensitive action, the platform 1001 may output a private prompt asking the user 1000 to confirm, modify, or cancel transmission. Such user confirmation 1218 may be provided by silent or low-audibility user input 1200, a click-equivalent sound, a head gesture, touch input, biometric input, or another private input.

In some embodiments, wearer authentication 1502 is required before generated user-voice audio 1512 is produced or transmitted. Wearer authentication 1502 may determine that the ear-worn device 1014 is being worn by an authorized user. Wearer authentication 1502 may be based on an ear-canal acoustic signature, ear shape, fit signature, skin contact, pressure, impedance, temperature, heart signal, bone-conduction signature, cartilage-conduction signature, vibration signature, proximity to the companion handheld device 1060, proximity to the companion wrist-worn device 1062, biometric authentication on a companion device, secure pairing, or another wearer-specific signal.

In some embodiments, the platform 1001 may use an articulation biometric 1504. The articulation biometric 1504 may be based on the manner in which the user 1000 produces silent or low-audibility user input 1200. For example, the articulation biometric 1504 may be derived from jaw movement, cheek movement, mouth movement, tongue movement, tooth-click pattern, bone-conduction pattern, cartilage-conduction pattern, in-ear acoustic signature, silent-speech timing, viseme sequence, phoneme sequence, vibration pattern, or another user-specific articulation feature. The platform 1001 may compare the articulation biometric 1504 with an enrolled user-specific articulation model before permitting generated user-voice audio 1512 to be transmitted.

In some embodiments, wearer authentication 1502 and articulation biometric 1504 may be used together. For example, wearer authentication 1502 may determine that the ear-worn device 1014 appears to be worn by the authorized user 1000, while articulation biometric 1504 may determine that the silent or low-audibility user input 1200 appears to have been produced by the authorized user 1000. Generated user-voice audio 1512 may be generated or transmitted only if both wearer authentication 1502 and articulation biometric 1504 satisfy respective thresholds.

In some embodiments, authentication may be continuous, periodic, event-triggered, or session-based. For example, the platform 1001 may perform wearer authentication 1502 at the beginning of the communication session 1500, periodically during the communication session 1500, when the ear-worn device 1014 is removed, when the ear-worn device 1014 is reinserted, when sensor fit changes, when proximity to a companion device changes, when the confidence value of authentication drops, or when a sensitive utterance or action is detected. The platform 1001 may inhibit or disable generated user-voice audio 1512 when authentication confidence falls below a threshold.

In some embodiments, the platform 1001 may require a challenge-response authentication. For example, the platform 1001 may privately output a challenge through the ear speaker or private output transducer 1018, such as a random phrase, number, gesture request, or silent-speech phrase. The user 1000 may respond using silent or low-audibility user input 1200. The platform 1001 may evaluate the response using silent speech recognition and articulation biometric 1504. Challenge-response authentication may be required before generating user-voice audio 1512 for high-risk communication sessions, sensitive recipients, payment authorization, emergency escalation, or other sensitive actions.

In some embodiments, if the platform 1001 detects that the ear-worn device 1014 is worn by an unauthenticated wearer, the platform 1001 may disable voice synthesis using the user voice profile 1506, disable transmission of generated user-voice audio 1512, disable silent-call functions, output a notification to the companion handheld device 1060 or trusted contact, require re-authentication, or limit the device to non-personal functions. This may prevent a person possessing a stolen or borrowed ear-worn device 1014 from using the user voice profile 1506 to impersonate the user 1000.

In some embodiments, the user voice profile 1506 may be stored securely. The user voice profile 1506 may be stored locally on the ear-worn device 1014, companion handheld device 1060, companion wrist-worn device 1062, companion head-mounted device 1064, remote assistant system 1066, secure enclave, or encrypted storage. Access to the user voice profile 1506 may require wearer authentication 1502, articulation biometric 1504, companion-device authentication, passcode, biometric input, or another authentication mechanism. In some embodiments, the user voice profile 1506 may be unavailable to third-party applications unless authorized by the user 1000.

In some embodiments, the platform 1001 may distinguish between local private synthesis and transmitted synthesis. For example, the platform 1001 may generate private assistant output 1070 locally for the user 1000 without transmitting generated user-voice audio 1512 to a remote participant 1510. Higher authentication thresholds may be required when generated user-voice audio 1512 is transmitted externally or used to authenticate, authorize, contract, pay, or otherwise act on behalf of the user 1000.

In some embodiments, the platform 1001 may maintain a transcript, summary, or protected event record of the communication session 1500. The transcript or summary may include silent or low-audibility user input 1200, generated user-voice audio 1512, remote participant audio, translations, confidence values 1138, user confirmations 1218, or authentication events. The transcript or summary may be stored only if authorized by the user 1000, required by safety policy 1604, or triggered by evidence preservation action 1316.

In some embodiments, the platform 1001 may provide real-time correction. If the silent speech processor 1202 misrecognizes a portion of the silent or low-audibility user input 1200, the platform 1001 may privately display or output a candidate transcript, request correction, or allow the user 1000 to silently modify the content before generated user-voice audio 1512 is transmitted. In time-sensitive communication sessions, the platform 1001 may proceed when confidence value 1138 is sufficiently high and may request confirmation when confidence is below a threshold.

In some embodiments, the platform 1001 may provide selective muting. For example, the communication session 1500 may remain connected while the user 1000 silently formulates a response, receives private assistant output 1070, consults the contextual representation 1120, requests a suggested reply, or delays transmission. The remote participant 1510 may hear silence, background audio, generated filler speech, or another indication, depending on user settings and communication context.

In some embodiments, the platform 1001 may generate user-voice audio 1512 for a voice message rather than a real-time call. For example, the user 1000 may silently dictate a message in public, review it privately, and then transmit generated user-voice audio 1512 to a recipient. The recipient may receive the message as if spoken by the user 1000, while nearby persons did not hear the user's original input.

In some embodiments, the platform 1001 may support accessibility use cases. For example, a user 1000 who has lost the ability to speak audibly, who is in a noisy environment, who is in a quiet environment, who has speech anxiety, or who must preserve vocal rest may use silent or low-audibility user input 1200 and user voice profile 1506 to communicate. The platform 1001 may allow the user 1000 to communicate using a voice that is recognizable, preferred, translated, anonymized, or otherwise appropriate.

In some embodiments, the platform 1001 may prevent accidental transmission. For example, if silent or low-audibility user input 1200 appears to be self-talk, affective utterance, private note, or unintended speech, the platform 1001 may refrain from generating or transmitting generated user-voice audio 1512 until the user 1000 confirms. The determination may be based on context, activation mode, semantic objective 1204, communication session state, confidence value 1138, user settings, or prior support outcome data 1610.

In some embodiments, the communication session 1500 may be integrated with the assistant service selector 1212. For example, during a call, the user 1000 may silently request “summarize what he said,” “draft a polite answer,” “translate that,” “send him the file,” “schedule a meeting,” or “do not say that yet.” The assistant service selector 1212 may select summarization, translation, messaging, calendar, file-sharing, or protective-friction services while maintaining the communication session 1500.

The embodiments described in this section may be combined with the silent speech embodiments, reactive mode 1300, private output embodiments, translation embodiments, authentication embodiments, evidence preservation embodiments, longitudinal user-specific context embodiments, and payment or security embodiments described elsewhere herein. In particular, wearer authentication 1502, articulation biometric 1504, user voice profile 1506, and voice synthesis processor 1508 may enable the user 1000 to communicate privately through the ear-worn device 1014 while preventing unauthorized persons from using the ear-worn device 1014 to generate speech in a voice associated with the user 1000.

### User Authentication, Wearer Authentication, and Permissioned Silent Intent Capture

In some embodiments, the ear-worn contextual companion platform 1001 may authenticate the user 1000 before executing one or more assistant operations 1214. Authentication may be particularly useful when the assistant operation 1214 involves payment, unlocking, access control, communication with a remote participant 1510, generation of generated user-voice audio 1512, trusted contact action 1312, transportation action 1314, evidence preservation action 1316, emergency escalation, disclosure of personal information, or another sensitive action.

In some embodiments, authentication may include wearer authentication 1502. Wearer authentication 1502 may determine whether the ear-worn device 1014 is being worn by an authorized user 1000. Wearer authentication 1502 may be based on one or more physical, biometric, physiological, acoustic, inertial, electrical, optical, behavioral, or contextual signatures associated with the user 1000 or the manner in which the ear-worn device 1014 is worn.

In some embodiments, wearer authentication 1502 may be based on an ear-canal acoustic signature. For example, the ear speaker or private output transducer 1018 may output a probe signal, and the inward microphone 1022 may detect a response shaped by the ear canal, eardrum, fit, seal, tissue, or geometry of the user 1000. The processor 1042 may compare the detected response with an enrolled acoustic signature associated with the user 1000. If the detected response matches the enrolled signature within a threshold, wearer authentication 1502 may succeed.

In some embodiments, wearer authentication 1502 may be based on fit, pressure, skin contact, impedance, temperature, heart signal, pulse signal, tissue response, or other physiological or contact-based information. For example, one or more authentication sensors or authentication modules 1048 may detect whether the housing 1016 is seated in the ear in a manner consistent with the authorized user 1000. A change in fit, pressure, contact, impedance, or temperature may indicate removal, replacement, transfer to another wearer, or a need for re-authentication.

In some embodiments, wearer authentication 1502 may be based on bone-conduction, cartilage-conduction, vibration, or body-conducted-signal characteristics detected by the sensor 1024. Such characteristics may include transfer functions, resonance patterns, jaw vibration patterns, tooth-click transmission patterns, tongue-click transmission patterns, bone-conducted speech patterns, or other signals that depend on anatomy or wearing configuration of the user 1000. The platform 1001 may compare such characteristics with enrolled user-specific patterns.

In some embodiments, authentication may include articulation biometric 1504. The articulation biometric 1504 may characterize the way in which the user 1000 produces silent or low-audibility user input 1200. For example, articulation biometric 1504 may be based on timing, amplitude, sequence, rhythm, jaw movement, cheek movement, tongue movement, tooth-contact pattern, mouth movement, viseme sequence, phoneme sequence, vibration pattern, bone-conduction pattern, cartilage-conduction pattern, in-ear acoustic pattern, optical feature sequence, or inertial feature sequence associated with silent or low-audibility user input 1200.

In some embodiments, articulation biometric 1504 may be text-dependent. For example, the platform 1001 may ask the user 1000 to silently or quietly articulate a particular word, phrase, number, or challenge. The silent speech processor 1202 may determine whether the content matches the challenge, while the authentication module 1048 may determine whether the manner of articulation matches an enrolled articulation biometric 1504 of the user 1000. In other embodiments, articulation biometric 1504 may be text-independent and may operate on ordinary silent or low-audibility user input 1200.

In some embodiments, authentication may include proximity or possession authentication. For example, the platform 1001 may require that the ear-worn device 1014 be paired with, proximate to, or in secure communication with the companion handheld device 1060, companion wrist-worn device 1062, companion head-mounted device 1064, or another trusted device. The platform 1001 may use secure pairing, cryptographic keys, short-range communication, device proximity, motion correlation, or another technique to determine that the ear-worn device 1014 is possessed by or associated with the user 1000.

In some embodiments, authentication may include companion-device biometric authentication. For example, the companion handheld device 1060 or companion wrist-worn device 1062 may authenticate the user 1000 using facial recognition, fingerprint recognition, passcode, watch unlock state, skin contact, heart signal, device possession, or another authentication technique. The ear-worn contextual companion platform 1001 may rely on such companion-device authentication alone or in combination with wearer authentication 1502 and articulation biometric 1504.

In some embodiments, authentication may be continuous. The platform 1001 may monitor one or more authentication signals during use and may determine whether authentication confidence remains above a threshold. Continuous authentication may be useful because the ear-worn device 1014 can be removed, transferred, stolen, borrowed, or fitted differently after an initial authentication. If authentication confidence falls below the threshold, the platform 1001 may disable sensitive assistant operations 1214, request re-authentication, reduce available functions, or notify the user 1000 through another trusted device.

In some embodiments, authentication may be session-based. For example, wearer authentication 1502 and articulation biometric 1504 may be performed at the start of a communication session 1500, payment session, access session, transportation session, evidence-preservation session, or other sensitive session. The platform 1001 may maintain authentication for the session while monitoring whether the ear-worn device 1014 remains worn, whether fit changes, whether articulation remains consistent, whether companion-device proximity remains valid, or whether a risk condition requires re-authentication.

In some embodiments, authentication may be event-triggered. For example, the platform 1001 may require authentication when the user 1000 attempts to initiate a payment, unlock a device, enter a PIN, transmit generated user-voice audio 1512, send a message, initiate a trusted contact action 1312, preserve evidence, share location, access sensitive longitudinal user-specific context 1600, or override protective friction. The required level of authentication may depend on the sensitivity of the assistant operation 1214, user state, risk level, safety policy 1604, or confidence value 1138.

In some embodiments, authentication may be adaptive. The platform 1001 may select an authentication level based on context. For example, a low-risk private output may require no additional authentication beyond wearer detection. A payment action may require wearer authentication 1502 and user confirmation 1218. A generated user-voice call to a remote participant 1510 may require wearer authentication 1502 and articulation biometric 1504. An override of a safety policy 1604 during a reduced-capacity state may require stronger authentication or confirmation through a companion device.

In some embodiments, permissioned silent intent capture may be used.

Permissioned silent intent capture means that silent or low-audibility user input 1200 is treated as assistant input only under conditions indicating user authorization. Such conditions may include an authenticated wearer, activation of a listening mode, a wake phrase, a silent wake sound, a click-equivalent input, a head gesture, a touch input, contextual readiness, a private prompt requesting a response, or a user setting authorizing continuous or semi-continuous silent input. This may help distinguish intentional assistant input from private self-talk, involuntary sounds, breathing, or ambient noise.

In some embodiments, the platform 1001 may classify silent or low-audibility user input 1200 as intended input, private self-talk, affective utterance, accidental utterance, or non-user signal. The classification may be based on authentication, articulation biometric 1504, content, timing, prior private prompt, head motion, context, confidence value 1138, user settings, or prior support outcome data 1610. For example, a low-content utterance following a private prompt may be treated as user confirmation 1218, while a similar utterance during unrelated conversation may be treated as private self-talk or ignored.

In some embodiments, permissioned silent intent capture may include user controls. The user 1000 may select modes in which silent or low-audibility user input 1200 is processed continuously, processed only after a wake signal, processed only after a private prompt, processed only for safety conditions, processed only locally, processed only for translation, processed only during communication sessions, or not processed at all. The user 1000 may configure such controls using the companion handheld device 1060, companion wrist-worn device 1062, companion head-mounted device 1064, remote assistant system 1066, or silent or low-audibility user input 1200.

In some embodiments, authentication may be used to protect the longitudinal user-specific context 1600. The platform 1001 may require authentication before accessing relationship data 1602, safety policy 1604, trusted contact data 1606, communication style profile 1608, prior support outcome data 1610, payment settings, medical or dietary restrictions, communication history, location history, or other sensitive information. Authentication may be required before such information is used, displayed, output, transmitted, modified, exported, or deleted.

In some embodiments, authentication may be used to protect public companion-device output 1072. For example, before outputting target-language output 1406 publicly, transmitting generated user-voice audio 1512, sending a message, making a call, sharing a location, or making a payment, the platform 1001 may confirm that the user 1000 is authenticated and that the content or action is authorized. If authentication fails or confidence is low, the platform 1001 may output private assistant output 1070 requesting re-authentication or may inhibit the public output or external action.

In some embodiments, authentication may be used to protect the user voice profile 1506. The platform 1001 may store the user voice profile 1506 in encrypted form, in secure memory, or in a secure enclave. Access to the user voice profile 1506 may require wearer authentication 1502, articulation biometric 1504, companion-device authentication, passcode, or another authentication. If the ear-worn device 1014 is worn by an unauthenticated wearer, the platform 1001 may disable voice synthesis using the user voice profile 1506, disable communication session 1500 transmission, or output a notification to a trusted device or trusted contact.

In some embodiments, authentication may be used to protect evidence preservation action 1316. For example, before disclosing a protected event record, exporting an incident report, sharing sensor data, transmitting evidence to a trusted contact, or deleting preserved evidence, the platform 1001 may require authentication. In some embodiments, safety policy 1604 may allow preservation to occur without authentication in a high-risk condition but may require authentication for later disclosure, deletion, or modification.

In some embodiments, the platform 1001 may detect unauthorized use. Unauthorized use may be detected when wearer authentication 1502 fails, articulation biometric 1504 fails, fit signature changes, the ear-worn device 1014 is removed and reinserted by a different wearer, the ear-worn device 1014 is separated from trusted companion devices, or silent or low-audibility user input 1200 does not match the authorized user 1000. Upon detecting unauthorized use, the platform 1001 may disable sensitive functions, require re-authentication, output a notification, erase or lock local sensitive data, or switch to a limited mode.

In some embodiments, the platform 1001 may use multi-factor authentication. Multi-factor authentication may require two or more of wearer authentication 1502, articulation biometric 1504, companion-device biometric authentication, passcode, proximity to a trusted device, location consistency, gesture, click-equivalent input, or challenge-response input. Multi-factor authentication may be required for high-risk assistant operations 1214, including payment, voice synthesis transmission, access control, emergency escalation, evidence disclosure, or modification of safety policy 1604.

In some embodiments, authentication may be privacy-preserving. For example, authentication templates may be stored locally, encrypted, never transmitted, or transmitted only as cryptographic proofs. The platform 1001 may compare current biometric features with stored templates locally on the processor 1042, companion handheld device 1060, or secure enclave. In some embodiments, authentication may produce only a confidence value and not expose raw biometric data to applications or services.

In some embodiments, authentication may be combined with confidence scoring for referent resolution. For example, a low authentication confidence may reduce confidence values 1138 associated with semantic objectives 1204, user confirmations 1218, or assistant operations 1214. The platform 1001 may refrain from executing sensitive actions when authentication confidence is low, even if referent-resolution confidence is high.

In some embodiments, user confirmation 1218 may itself be authenticated. For example, the platform 1001 may require that a confirmation be provided by the authenticated user 1000 using silent or low-audibility user input 1200 that satisfies articulation biometric 1504, rather than by an ambient speaker or unauthorized wearer. This may be useful for confirming payment, outgoing communications, ride-hailing, evidence preservation, or safety-policy overrides.

In some embodiments, the platform 1001 may log authentication events. An authentication event log may include authentication success, authentication failure, re-authentication, removal detection, fit change, companion-device proximity loss, challenge-response result, user confirmation 1218, or disabling of sensitive functions. Such logs may be used for security review, evidence preservation action 1316, fraud detection, or user notification, subject to privacy settings.

In some embodiments, the user 1000 may configure authentication sensitivity. For example, the user 1000 may choose lower-friction authentication for low-risk private assistant output 1070 and stronger authentication for payments, calls, generated user-voice audio 1512, access control, evidence disclosure, or trusted-contact escalation. The platform 1001 may recommend authentication settings based on use patterns, safety policy 1604, and available sensors.

The embodiments described in this section may be combined with the silent communication session embodiments, payment embodiments, safety embodiments, evidence preservation embodiments, private output embodiments, reactive mode 1300, proactive mode 1302, referent resolution, contextual mapping, and longitudinal companion-state embodiments described elsewhere herein. In particular, authentication may ensure that the ear-worn contextual companion platform 1001 treats silent or low-audibility user input 1200 as authorized input from the user 1000, protects sensitive user-specific data, prevents unauthorized use of the user voice profile 1506, and enables private but secure assistant operations 1214.

Assistant Service Selection and Intent-Level Routing without Explicit Application Selection

In some embodiments, the ear-worn contextual companion platform 1001 may select one or more assistant services based on a semantic objective 1204, a selected candidate referent 1210, the contextual representation 1120, and the longitudinal user-specific context 1600. The platform 1001 may perform such selection using an assistant service selector 1212. The assistant service selector 1212 may determine which application, service, device, workflow, or combination of workflows should be used to satisfy the semantic objective 1204, without requiring the user 1000 to explicitly select an application.

In some embodiments, the user 1000 may express an objective rather than an application command. For example, the user 1000 may provide silent or low-audibility user input 1200 such as “ask him if this train goes to Kyoto,” “pay for this,” “get me there,” “tell her I am late,” “translate that,” “what does this say,” “call Jayson,” “send this to him,” “get me out,” or “do not let me send this yet.” The assistant service selector 1212 may determine that the objective requires translation, navigation, payment, messaging, calling, contact identification, calendar access, ride-hailing, evidence preservation, protective friction, or another assistant service.

In some embodiments, the assistant service selector 1212 may select among a plurality of services including translation, navigation, payment, messaging, calling, contact identification, social cueing, calendar, ride-hailing, public transport, emergency services, trusted contact action 1312, transportation action 1314, evidence preservation action 1316, device control, search, note-taking, summarization, object identification, optical character recognition, text-to-speech, speech-to-text, voice synthesis, or another service. The selected service may be executed by the ear-worn device 1014, companion handheld device 1060, companion wrist-worn device 1062, companion head-mounted device 1064, remote assistant system 1066, external service, or a combination thereof.

In some embodiments, the assistant service selector 1212 may use the contextual representation 1120 to determine which service is appropriate. For example, if the selected candidate referent 1210 is a candidate text-bearing referent 1128, the assistant service selector 1212 may select optical character recognition, translation, reading, summarization, or interpretation. If the selected candidate referent 1210 is a candidate person referent 1124, the assistant service selector 1212 may select person identification, relationship lookup, messaging, calling, translation, social cueing, or trusted contact action 1312. If the selected candidate referent 1210 is a candidate vehicle or hazard referent 1130, the assistant service selector 1212 may select safety alerting, route change, transportation action 1314, trusted contact action 1312, or evidence preservation action 1316.

In some embodiments, the assistant service selector 1212 may determine a service chain rather than a single service. A service chain may comprise an ordered or partially ordered set of services that together satisfy the semantic objective 1204. For example, the semantic objective 1204 “ask him if this is vegetarian” may require person or addressee selection by the referent resolver 1208, food or menu-item identification from the contextual representation 1120, dietary-context disambiguation by the context-disambiguation processor 1404, translation by the translation processor 1402, public companion-device output 1072, detection of a foreign-language reply 1410, and private return translation 1412. The user 1000 need not select each service explicitly.

In another example, the semantic objective 1204 “get me out” may cause the assistant service selector 1212 to select route evaluation, safety evaluation, transportation action 1314, trusted contact action 1312, location sharing, and private navigation output. The platform 1001 may select a pickup point ahead of the user 1000, initiate a ride-hailing request, guide the user 1000 privately to the pickup point, and monitor whether an alert condition 1306 persists. The user 1000 may provide user confirmation 1218 through silent or low-audibility user input 1200 before external services are initiated.

In another example, the semantic objective 1204 “pay for this” may cause the assistant service selector 1212 to select payment-terminal identification, amount recognition, merchant identification, payment-method selection, authentication, and confirmation. The platform 1001 may output private assistant output 1070 asking the user 1000 to confirm the amount, merchant, and payment method. The platform 1001 may require wearer authentication 1502, articulation biometric 1504, or companion-device authentication before initiating the payment.

In another example, the semantic objective 1204 “tell her I am sorry I am late” may require the assistant service selector 1212 to determine whether “her” refers to a candidate person referent 1124 physically near the user 1000, a person in relationship data 1602, a remote participant 1510, or a person associated with a calendar event. The assistant service selector 1212 may select public translated speech, a text message, a phone call, or a calendar-related message depending on the selected candidate referent 1210 and context.

In some embodiments, the assistant service selector 1212 may select a service based on a user-relevant condition 1304 detected in proactive mode 1302. For example, if the platform 1001 detects that a sign contains a platform change, the assistant service selector 1212 may select translation, route update, and private navigation output. If the platform 1001 detects that a personal item is left behind, the assistant service selector 1212 may select private alerting and route reversal. If the platform 1001 detects that a person has followed the user 1000, the assistant service selector 1212 may select private warning, transportation action 1314, trusted contact action 1312, and evidence preservation action 1316.

In some embodiments, the assistant service selector 1212 may select a service based on a reduced-capacity state determined by the user-state estimator 1612. For example, if the user-state estimator 1612 determines that the user 1000 appears impaired, fatigued, distressed, disoriented, or overloaded, the assistant service selector 1212 may prefer safer, lower-risk services. The assistant service selector 1212 may select transportation action 1314 instead of walking directions, trusted contact action 1312 before emergency escalation, message delay rather than immediate sending, or payment confirmation rather than immediate payment.

In some embodiments, the assistant service selector 1212 may select a service based on safety policy 1604. The safety policy 1604 may specify preferred services or escalation paths. For example, the safety policy 1604 may specify that when the platform 1001 detects a following condition at night, the platform 1001 should first output a private warning, then propose a transportation action 1314, then propose a trusted contact action 1312, and then initiate evidence preservation action 1316 if the condition persists or if the user 1000 fails to respond.

In some embodiments, the assistant service selector 1212 may select a service based on trusted contact data 1606. For example, when the semantic objective 1204 or user-relevant condition 1304 indicates distress, safety risk, emotional crisis, travel difficulty, or reduced capacity, the assistant service selector 1212 may select a trusted contact action 1312 using a trusted contact determined from trusted contact data 1606. The trusted contact may be selected based on time of day, location, relationship, availability, prior response history, or type of situation.

In some embodiments, the assistant service selector 1212 may select a service based on communication style profile 1608. For example, if the user 1000 prefers concise confirmations, the platform 1001 may output a short private confirmation before routine actions. If the user 1000 prefers detailed explanations in unfamiliar environments, the platform 1001 may provide a longer private explanation. If the user 1000 prefers direct warnings in safety contexts, the platform 1001 may select a more direct private output style when the alert condition 1306 has high severity.

In some embodiments, the assistant service selector 1212 may select a service based on prior support outcome data 1610. For example, if the user 1000 previously accepted ride-hailing assistance in similar late-night walking contexts, the assistant service selector 1212 may propose a transportation action 1314 earlier in a similar future context. If the user 1000 repeatedly rejects a certain category of proactive alert, the assistant service selector 1212 may reduce or suppress that category except when severity is high.

In some embodiments, the assistant service selector 1212 may select a service based on service availability. For example, translation may require a language model or remote assistant system 1066, ride-hailing may require network connection 1068, payment may require a payment credential, emergency services may depend on location, and evidence preservation may depend on storage availability. The assistant service selector 1212 may select a fallback service when a preferred service is unavailable. For example, if ride-hailing is unavailable, the platform 1001 may select walking navigation to a safer location and trusted contact action 1312.

In some embodiments, the assistant service selector 1212 may select among local, companion-device, and remote processing. For low-latency safety alerts, the platform 1001 may perform hazard detection and private output locally using processor 1042. For context-disambiguated translation, the platform 1001 may use the companion handheld device 1060 or remote assistant system 1066. For privacy-sensitive data, the assistant service selector 1212 may select local processing or derived-feature processing rather than transmitting raw sensor data.

In some embodiments, the assistant service selector 1212 may request user confirmation 1218 before executing an assistant operation 1214. Confirmation may be required when the assistant operation 1214 involves public companion-device output 1072, financial transaction, outgoing communication, location sharing, trusted contact action 1312, transportation action 1314, evidence preservation action 1316, emergency escalation, voice synthesis transmission, access control, or another sensitive operation. The confirmation may be obtained privately through silent or low-audibility user input 1200, click-equivalent input, biometric input, touch input, or head gesture.

In some embodiments, the assistant service selector 1212 may support action previews. For example, before performing the assistant operation 1214, the platform 1001 may privately output a summary of the intended action: “Pay £18.40 to this merchant?”, “Send Cora your location?”, “Book a ride to the next lit pickup point?”, “Tell the waiter in Japanese that you cannot eat shellfish?”, or “Transmit this sentence to your boss in your voice?” The user 1000 may then confirm, reject, or modify the action.

In some embodiments, the assistant service selector 1212 may support silent modification of an action. For example, after the platform 1001 proposes target-language output 1406, the user 1000 may silently modify the politeness level, add a phrase, remove a detail, change the addressee, or cancel public output. After the platform 1001 proposes transportation action 1314, the user 1000 may silently request a different destination, pickup point, ride type, or trusted contact. After the platform 1001 proposes a message, the user 1000 may silently ask for a calmer version or a delayed send.

In some embodiments, the assistant service selector 1212 may choose between private assistant output 1070 and public companion-device output 1072. If the semantic objective 1204 is to obtain information for the user 1000, private assistant output 1070 may be selected. If the semantic objective 1204 is to communicate with another person, public companion-device output 1072, generated user-voice audio 1512, or a transmitted message may be selected. If the semantic objective 1204 is both informational and communicative, both private and public outputs may be used.

In some embodiments, the assistant service selector 1212 may operate across multiple turns. A first assistant operation 1214 may generate private assistant output 1070 asking a clarification question. A second silent or low-audibility user input 1200 may provide user confirmation 1218 or modification. The assistant service selector 1212 may then update the selected service or service chain. This multi-turn process may occur privately and may require no visible device interaction.

In some embodiments, the assistant service selector 1212 may be constrained by user preferences, regulatory requirements, safety requirements, or privacy settings. For example, the platform 1001 may be prohibited from making certain payments without biometric confirmation, prohibited from recording raw optical data except under evidence preservation conditions, prohibited from sharing location except with trusted contacts, or prohibited from outputting public translated speech without confirmation. Such constraints may be stored in safety policy 1604 or other user settings.

In some embodiments, the assistant service selector 1212 may log service-selection outcomes. The platform 1001 may store whether a service was selected, confirmed, rejected, modified, completed, failed, or later marked useful. Such data may be stored as prior support outcome data 1610 and used to improve future service selection. In some embodiments, sensitive logs may be encrypted or retained only for limited periods.

In some embodiments, the assistant service selector 1212 may support service selection in the absence of a verbal command. For example, in proactive mode 1302, the platform 1001 may detect an alert condition 1306 and select a service without the user 1000 first issuing a command. The platform 1001 may nevertheless request user confirmation 1218 before initiating external actions. For example, the platform 1001 may detect that a person is following the user 1000, select a transportation action 1314, and privately ask whether to book a ride.

The embodiments described in this section may be combined with the reactive mode 1300, proactive mode 1302, contextual mapping, referent resolution, private output, public output, translation, silent communication, personal safety, evidence preservation, authentication, and longitudinal user-specific context embodiments described elsewhere herein. In particular, the assistant service selector 1212 may enable the platform 1001 to operate as an intent-level assistant layer, where the user 1000 expresses an objective and the platform 1001 determines the service, device, workflow, output mode, confirmation requirement, and action needed to satisfy that objective.

### Affective Micro-Utterance Interpretation and Supportive Contextual Response

In some embodiments, the ear-worn contextual companion platform 1001 may interpret affective, incomplete, or low-content silent or low-audibility user input 1200. Such input may include an exclamation, sigh, hesitation, whispered phrase, mouthed phrase, subvocalized phrase, low-volume phrase, silent sound, breath pattern, or other expression that does not itself contain a complete explicit command. Examples include “oh,” “oh no,” “oh bummer,” “damn,” “not again,” “please no,” “help,” “I cannot,” “what now,” “no,” “wait,” or similar expressions.

In some embodiments, the silent speech processor 1202 may detect the affective, incomplete, or low-content silent or low-audibility user input 1200 using one or more silent-speech sensors 1026, outward microphones 1020, inward microphones 1022, bone-conduction, cartilage-conduction, vibration, or body-conducted-signal sensors 1024, optical or infrared sensors 1030, inertial measurement units 1040, or other sensors. The silent speech processor 1202 may output an utterance classification, affective classification, semantic fragment, confidence value 1138, or other representation.

In some embodiments, the platform 1001 may determine the semantic objective 1204 from the affective, incomplete, or low-content input by combining the detected input with the contextual representation 1120 and the longitudinal user-specific context 1600. The same expression may be interpreted differently depending on the current context. For example, an expression such as “oh bummer” may be treated as a minor frustration when associated with a parking ticket, as a request for calm summary when associated with a distressing communication, as a safety request when associated with an unsafe route, or as a trusted-contact prompt when associated with a severe personal notification.

In some embodiments, the platform 1001 may compare a current context with prior contexts stored in prior support outcome data 1610. A current context may include a notification, message, email, call, calendar event, payment, route, location, person, detected hazard, candidate referent 1122, user-state estimate, or other situation. If the current context resembles a prior context in which the user 1000 benefited from a specific type of assistance, the platform 1001 may generate a corresponding private assistant output 1070 or action proposal 1308. For example, the platform 1001 may suggest delaying a response, calling a trusted contact, generating a calm summary, preserving evidence, selecting a safer route, or initiating a transportation action 1314.

In some embodiments, the platform 1001 may determine that an affective or incomplete utterance indicates distress. Distress may be inferred from the utterance content, acoustic features, articulation features, breathing pattern, head movement, gait, biometric data, recent notification content, location, time of day, social context, or prior support outcome data 1610. If distress is inferred, the platform 1001 may output private assistant output 1070 comprising reassurance, a summary, a context explanation, an urgency assessment, a proposed next step, a trusted contact action 1312, or another supportive assistant operation 1214.

In some embodiments, the platform 1001 may determine that an affective or incomplete utterance indicates a need for immediate safety assistance. For example, if the user 1000 silently or quietly utters “help” or “oh no” while the contextual representation 1120 includes a following condition, candidate vehicle or hazard referent 1130, unsafe route condition, hostile ambient speech, or other alert condition 1306, the platform 1001 may select a higher intervention level 1310 and output private assistant output 1070 proposing a protective action. The protective action may include trusted contact action 1312, transportation action 1314, evidence preservation action 1316, route change, or emergency escalation.

In some embodiments, the platform 1001 may determine that an affective or incomplete utterance indicates a need for translation or interpretation. For example, if the user 1000 quietly utters “what now” or “oh no” while the contextual representation 1120 includes a candidate text-bearing referent 1128 corresponding to a transport announcement, warning sign, menu item, ticket machine, or foreign-language message, the platform 1001 may interpret the utterance as a request to translate, summarize, or explain the candidate text-bearing referent 1128.

In some embodiments, the platform 1001 may determine that an affective or incomplete utterance indicates a need for social assistance. For example, if the user 1000 quietly utters “oh no” when a candidate person referent 1124 is approaching, the platform 1001 may determine that the user 1000 needs a name reminder, social context cue, warning, avoidance suggestion, or conversational prompt. The platform 1001 may output private assistant output 1070 using relationship data 1602 and communication style profile 1608.

In some embodiments, the platform 1001 may determine that an affective or incomplete utterance indicates a need for protective friction. For example, if the user 1000 quietly utters “damn” or “not again” while composing an outgoing message, making a payment, entering a vehicle, or responding to a notification, the platform 1001 may infer that the user 1000 may benefit from delaying, reconsidering, confirming, modifying, or obtaining support before completing the action. The platform 1001 may generate private assistant output 1070 asking whether to delay, rewrite, cancel, confirm, or contact a trusted person.

In some embodiments, the platform 1001 may interpret the affective or incomplete utterance by using a user-state estimator 1612. For example, the user-state estimator 1612 may indicate that the user 1000 is tired, intoxicated, anxious, overloaded, disoriented, or otherwise in a reduced-capacity state. In such circumstances, the platform 1001 may treat an affective or incomplete utterance as more likely to require supportive or protective intervention. Conversely, if the user-state estimator 1612 indicates that the user 1000 is in an ordinary state and the context is low risk, the platform 1001 may ignore the utterance, provide only a low-priority prompt, or wait for further input.

In some embodiments, the platform 1001 may generate a private prompt asking whether assistance is desired. For example, the platform 1001 may output private assistant output 1070 such as “Do you want a summary?”, “Do you want me to call a trusted contact?”, “Do you want to wait before replying?”, “Do you want me to translate that?”, “Do you want an extraction route?”, or “Do you want me to preserve evidence?” The user 1000 may provide user confirmation 1218 using silent or low-audibility user input 1200, click-equivalent input, head gesture, touch input, or another private input.

In some embodiments, the platform 1001 may generate a supportive response without initiating an external action. For example, the platform 1001 may output private assistant output 1070 that summarizes a situation, identifies a deadline, explains that no immediate action is required, reminds the user 1000 of a prior successful strategy, suggests taking time before responding, or provides a calming prompt. Such supportive response may be generated by the personalized output generator 1614 using the communication style profile 1608 and prior support outcome data 1610.

In some embodiments, the platform 1001 may generate a supportive response that references a prior event stored in the longitudinal user-specific context 1600. For example, if the current context resembles a prior event, the platform 1001 may privately output a prompt indicating that a similar situation occurred previously and identifying a support strategy that was previously effective. The prior event may be referenced in a manner controlled by the user 1000 and consistent with privacy settings.

In some embodiments, the platform 1001 may select whether to respond at all. Not every affective or incomplete utterance requires action. The platform 1001 may determine, based on context, user preferences, communication style profile 1608, prior support outcome data 1610, and confidence value 1138, whether to ignore the utterance, monitor silently, output a low-priority prompt, output a direct warning, request confirmation, or initiate an action proposal 1308. This may reduce over-intervention while preserving the ability to provide support when the utterance is meaningful.

In some embodiments, the platform 1001 may distinguish between bystander speech and user speech. The silent or low-audibility user input 1200 may be authenticated using wearer authentication 1502, articulation biometric 1504, microphone direction, in-ear acoustic signature, bone-conduction signature, proximity, or other signals. This may prevent the platform 1001 from interpreting a bystander's utterance as an affective utterance of the user 1000.

In some embodiments, the platform 1001 may adapt to the user 1000 over time. If the user 1000 repeatedly accepts assistance after certain affective utterances, the platform 1001 may become more likely to respond in similar contexts. If the user 1000 repeatedly dismisses assistance, the platform 1001 may reduce prompts in similar contexts. Such adaptation may be stored as prior support outcome data 1610.

In some embodiments, the platform 1001 may treat certain affective utterances as emergency triggers when combined with high-risk context. For example, “help,” “no,” “stop,” or “please no” may cause the platform 1001 to increase sensing, output a private prompt, preserve evidence, share location, or initiate trusted contact action 1312 when the contextual representation 1120 indicates an unsafe situation. In lower-risk contexts, the same utterance may cause a clarification prompt instead of immediate escalation.

In some embodiments, affective micro-utterance interpretation may operate with permissioned silent intent capture. The user 1000 may configure whether affective utterances are monitored, ignored, processed only locally, processed only after a wake signal, processed only in safety mode, processed only in private dialogue, or processed only under reduced-capacity conditions. Such settings may be included in safety policy 1604 or other user settings.

In some embodiments, affective micro-utterance interpretation may be used together with notification analysis. For example, if a message, email, call, legal notice, medical notice, financial alert, or other communication is received and the user 1000 produces an affective utterance, the platform 1001 may determine that the utterance relates to the communication. The platform 1001 may privately offer to summarize, explain urgency, draft a response, delay a response, call a trusted contact, schedule a follow-up, or otherwise assist.

In some embodiments, affective micro-utterance interpretation may be used together with environmental context. For example, if the user 1000 produces an affective utterance while walking in an unfamiliar area and the contextual representation 1120 includes a persistent candidate person referent 1124, the platform 1001 may determine that safety assistance is more appropriate than emotional support. If the contextual representation 1120 instead includes a candidate text-bearing referent 1128, the platform 1001 may determine that translation or explanation is more appropriate.

In some embodiments, the platform 1001 may generate different private assistant outputs 1070 for the same affective utterance based on severity and confidence. A low-severity, low-confidence situation may produce no output or a gentle prompt. A moderate-severity situation may produce a clarifying question. A high-severity, high-confidence situation may produce a direct warning or action proposal 1308. The intervention level 1310 may be determined dynamically using confidence value 1138, severity, user-state estimator 1612, and safety policy 1604.

The embodiments described in this section may be combined with the reactive mode 1300, proactive mode 1302, reduced-capacity detection, longitudinal user-specific context, private output, personal safety assistance, evidence preservation, trusted contact action, translation, communication session, and authentication embodiments described elsewhere herein. In particular, affective micro-utterance interpretation may allow the platform 1001 to infer a semantic objective 1204 or support need from a small, private expression of the user 1000 by combining that expression with contextual representation 1120 and longitudinal user-specific context 1600.

### Figure Descriptions for Ear-Worn Contextual Companion Embodiments

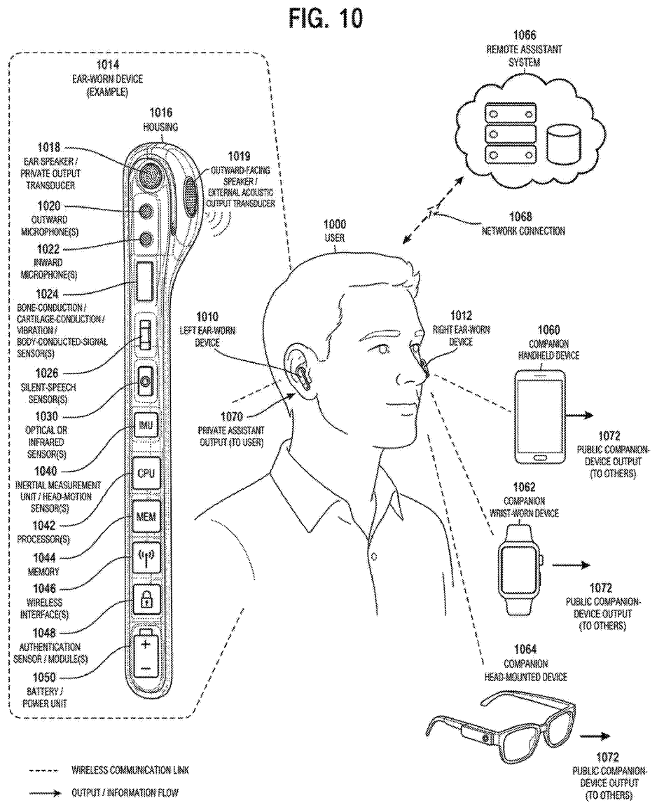

FIG. 10 illustrates an embodiment of an ear-worn contextual companion platform 1001. A user 1000 may wear a left ear-worn device 1010 and a right ear-worn device 1012, each of which may be an example of an ear-worn device 1014. The ear-worn device 1014 may comprise a housing 1016, an ear speaker or private output transducer 1018, one or more outward microphones 1020, one or more inward microphones 1022, one or more bone-conduction, cartilage-conduction, vibration, or body-conducted-signal sensors 1024, one or more silent-speech sensors 1026, one or more optical or infrared sensors 1030, one or more inertial measurement units or head-motion sensors 1040, one or more processors 1042, memory 1044, one or more wireless interfaces 1046, one or more authentication sensors or modules 1048, and a battery or power unit 1050.

In the embodiment of FIG. 10, the ear-worn device 1014 may communicate with one or more companion devices or remote systems. Such companion devices or remote systems may include a companion handheld device 1060, a companion wrist-worn device 1062, a companion head-mounted device 1064, and a remote assistant system 1066 accessible over a network connection 1068. The ear-worn device 1014 may output private assistant output 1070 to the user 1000 through the ear speaker or private output transducer 1018. In some embodiments, the platform 1001 may also cause public companion-device output 1072, such as translated speech, generated user-voice audio, visual output, or another output through the companion handheld device 1060, companion wrist-worn device 1062, companion head-mounted device 1064, vehicle system, external speaker, or remote communication service.

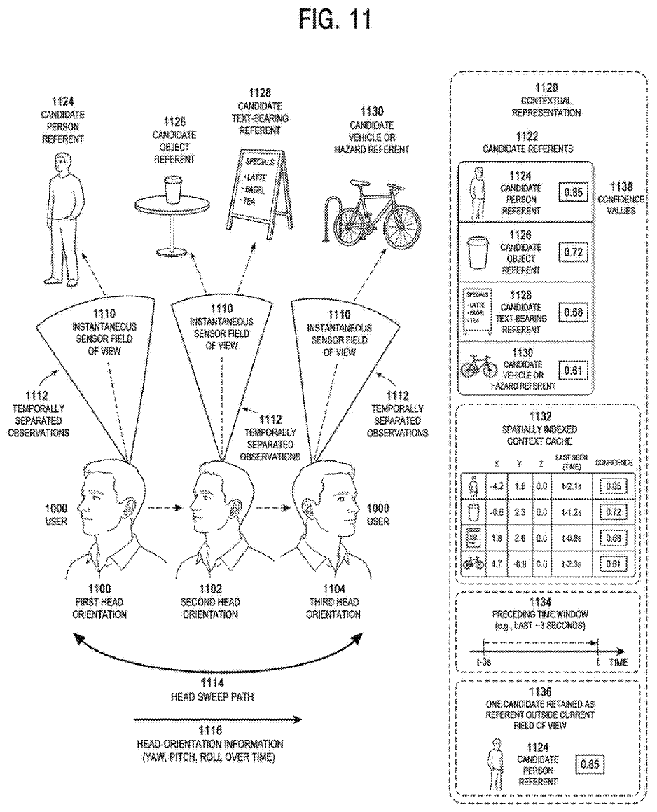

FIG. 11 illustrates an embodiment of natural head-motion contextual mapping. The user 1000 may turn the head through a sequence of orientations, including a first head orientation 1100, a second head orientation 1102, and a third head orientation 1104. At each head orientation, the optical or infrared sensor 1030 may have an instantaneous sensor field of view 1110 and may acquire a temporally separated observation 1112. The sequence of head orientations may define a head sweep path 1114. Head-orientation information 1116 from the inertial measurement unit 1040 or another sensor may be associated with the temporally separated observations 1112.

In the embodiment of FIG. 11, the platform 1001 may generate or update a contextual representation 1120 using the temporally separated observations 1112 and head-orientation information 1116. The contextual representation 1120 may comprise candidate referents 1122, including a candidate person referent 1124, a candidate object referent 1126, a candidate text-bearing referent 1128, and a candidate vehicle or hazard referent 1130. The contextual representation 1120 may include or be implemented as a spatially indexed context cache 1132 over a preceding time window 1134. A candidate referent 1122 may be a referent outside current field of view 1136 when the user 1000 later provides input. Each candidate referent 1122 may be associated with one or more confidence values 1138.

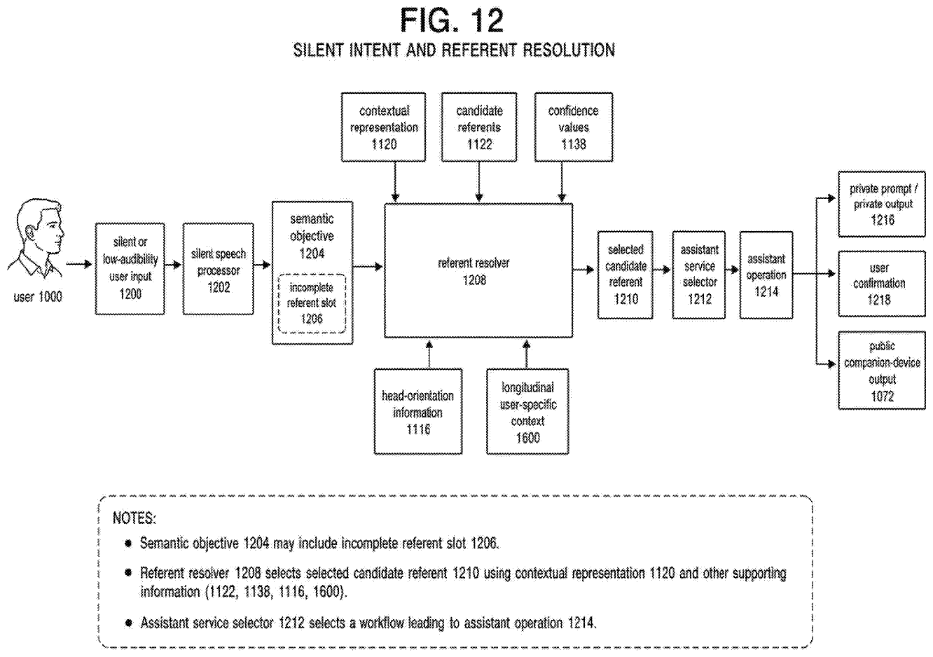

FIG. 12 illustrates an embodiment of silent intent and referent resolution. Silent or low-audibility user input 1200 may be processed by a silent speech processor 1202 to determine a semantic objective 1204. In some embodiments, the semantic objective 1204 may include an incomplete referent slot 1206. A referent resolver 1208 may use the contextual representation 1120, candidate referents 1122, confidence values 1138, head-orientation information 1116, and longitudinal user-specific context 1600 to select a selected candidate referent 1210. An assistant service selector 1212 may then select a service or workflow, and the platform 1001 may cause an assistant operation 1214. The assistant operation 1214 may produce a private prompt or private output 1216, request user confirmation 1218, initiate public companion-device output 1072, or initiate another action.

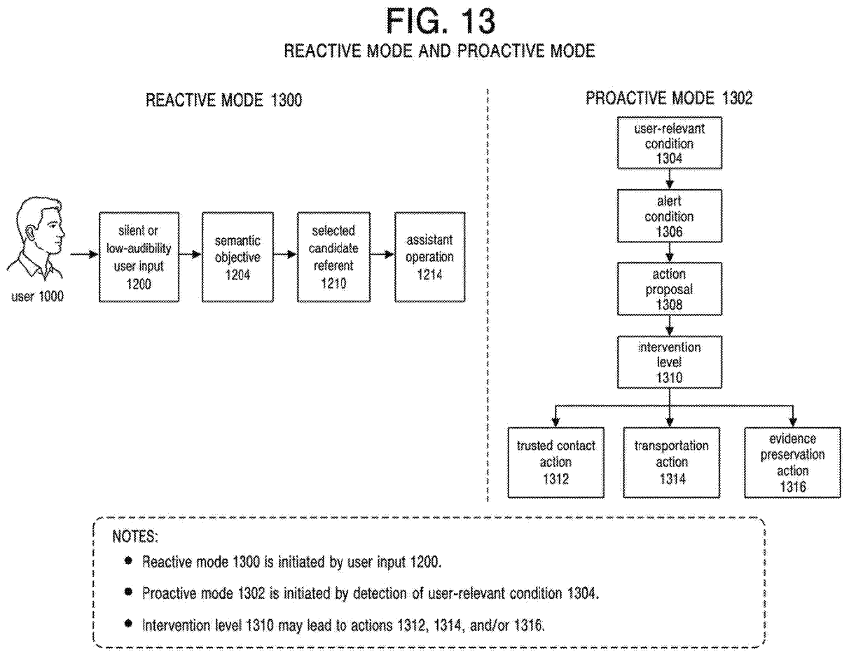

FIG. 13 illustrates an embodiment in which the ear-worn contextual companion platform 1001 supports both a reactive mode 1300 and a proactive mode 1302. In the reactive mode 1300, the user 1000 may provide silent or low-audibility user input 1200, which may be resolved to a semantic objective 1204 and a selected candidate referent 1210. In the proactive mode 1302, the platform 1001 may detect a user-relevant condition 1304 without receiving contemporaneous silent or low-audibility user input 1200. The user-relevant condition 1304 may satisfy an alert condition 1306. The platform 1001 may generate an action proposal 1308, select an intervention level 1310, and, where appropriate, initiate a trusted contact action 1312, transportation action 1314, or evidence preservation action 1316.

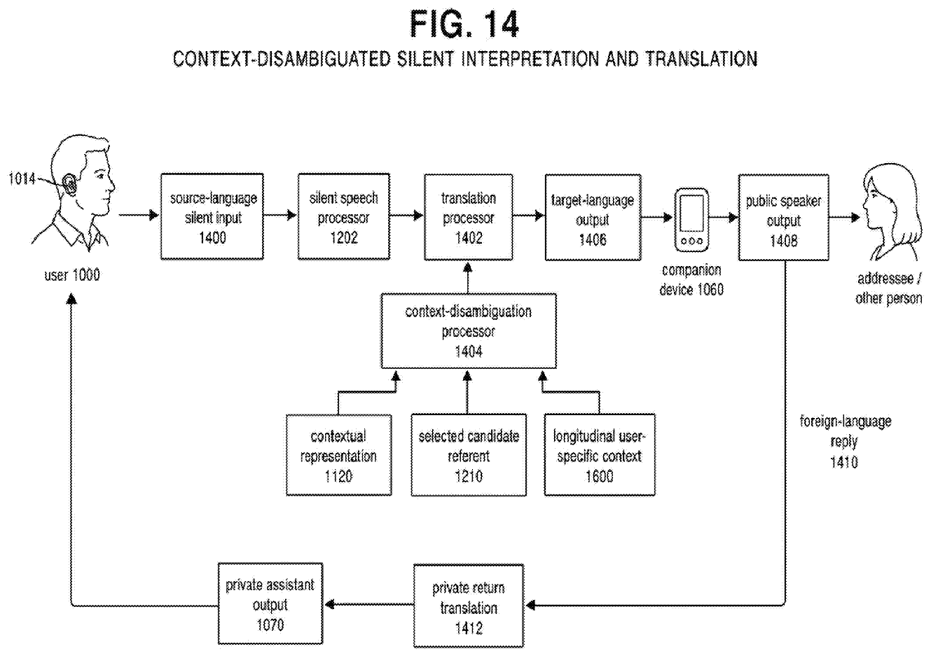

FIG. 14 illustrates an embodiment of context-disambiguated silent interpretation and translation. Source-language silent input 1400 may be processed by the silent speech processor 1202. The translation processor 1402 may translate the source-language silent input 1400. A context-disambiguation processor 1404 may use the contextual representation 1120, selected candidate referent 1210, location, social context, addressee identity, text-bearing referents, or longitudinal user-specific context 1600 to disambiguate the source-language silent input 1400 before or during translation. Target-language output 1406 may be output as public speaker output 1408, for example through the companion handheld device 1060. A foreign-language reply 1410 may be detected and translated into a private return translation 1412, which may be output as private assistant output 1070 through the ear-worn device 1014.

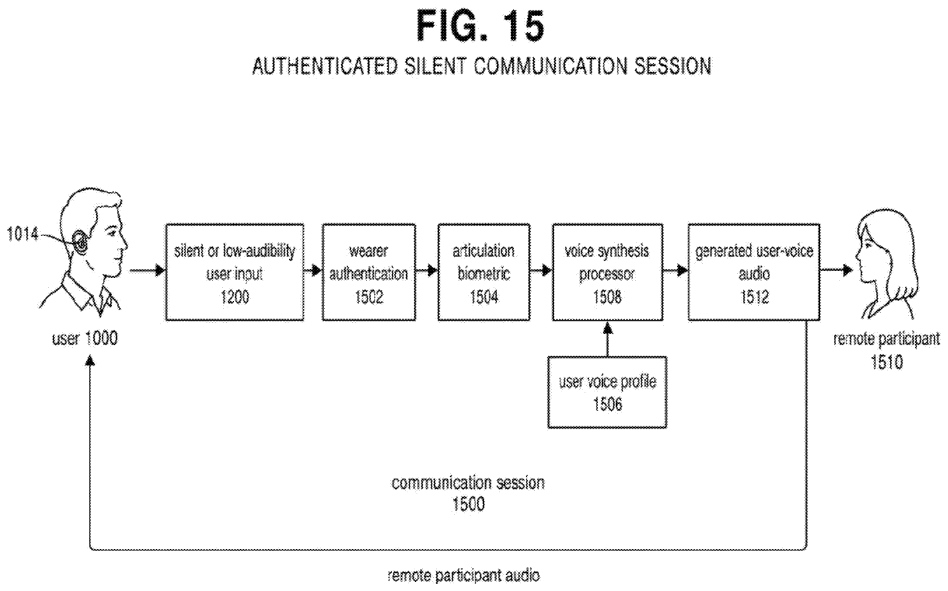

FIG. 15 illustrates an embodiment of an authenticated silent communication session. A communication session 1500 may involve the user 1000 and a remote participant 1510. During the communication session 1500, the user 1000 may provide silent or low-audibility user input 1200. Wearer authentication 1502 and articulation biometric 1504 may be used to determine whether the input is authorized. A user voice profile 1506 may be used by a voice synthesis processor 1508 to generate generated user-voice audio 1512. The generated user-voice audio 1512 may be transmitted to the remote participant 1510, while audio from the remote participant 1510 may be output privately to the user 1000 through the ear-worn device 1014.

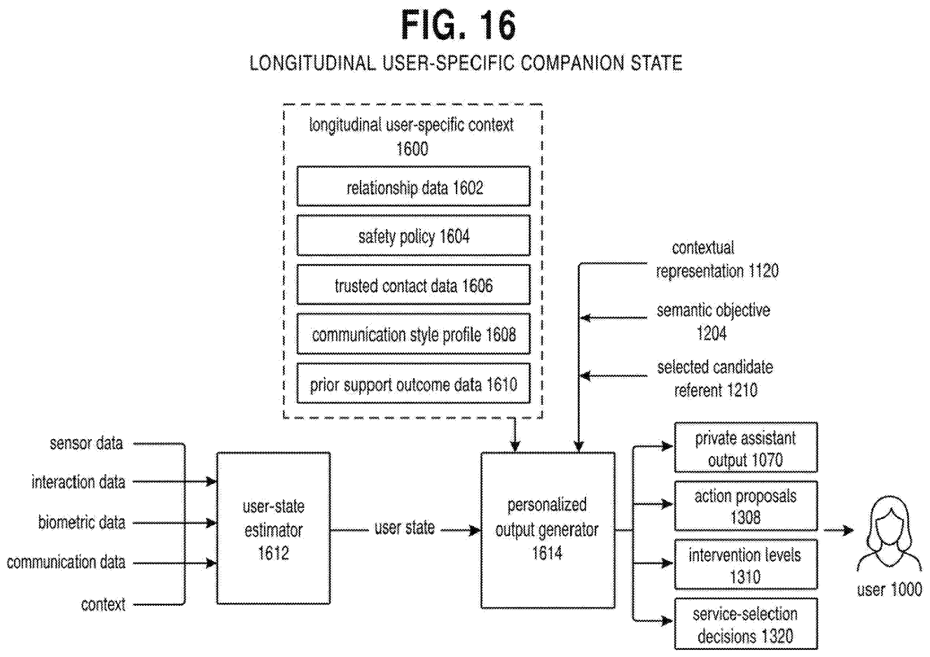

FIG. 16 illustrates an embodiment of a longitudinal user-specific companion state. The platform 1001 may maintain longitudinal user-specific context 1600, including relationship data 1602, safety policy 1604, trusted contact data 1606, communication style profile 1608, and prior support outcome data 1610. A user-state estimator 1612 may determine a current state of the user 1000 using sensor data, interaction data, biometric data, communication data, context, or other information. A personalized output generator 1614 may generate private assistant output 1070, action proposals 1308, intervention levels 1310, or service-selection decisions using the longitudinal user-specific context 1600, contextual representation 1120, semantic objective 1204, selected candidate referent 1210, and user state.

FIGS. 10-16 are intended to illustrate example embodiments only. Components shown separately may be combined, and components shown together may be separated. Functions associated with one device may be performed by another device. For example, processing described with respect to the processor 1042 may be performed by the companion handheld device 1060, companion wrist-worn device 1062, companion head-mounted device 1064, remote assistant system 1066, or a combination thereof. Likewise, a component shown in the left ear-worn device 1010 may instead be provided in the right ear-worn device 1012, in both devices, or in a companion device. The figures are therefore not intended to limit the physical placement, distribution, or number of components.

### Example Use Cases for Ear-Worn Contextual Companion Embodiments

The following examples illustrate non-limiting use cases for the ear-worn contextual companion platform 1001. The examples may be practiced individually or in combination. Features described with respect to one example may be combined with features described in another example. The examples are intended to show how the ear-worn device 1014, contextual representation 1120, silent or low-audibility user input 1200, private assistant output 1070, and assistant operation 1214 may cooperate in different real-world contexts.

In a first example, the user 1000 may attend a social event while wearing the ear-worn device 1014. The optical or infrared sensor 1030, outward microphone 1020, and inertial measurement unit 1040 may generate temporally separated observations 1112 as the user 1000 naturally turns the head. The platform 1001 may store a candidate person referent 1124 in the contextual representation 1120. The user 1000 may provide silent or low-audibility user input 1200, such as “who is that.” The referent resolver 1208 may select the candidate person referent 1124 as the selected candidate referent 1210, and the platform 1001 may output private assistant output 1070 identifying the person, the relationship, or a prior interaction.

In a second example, the user 1000 may see a person briefly, then look away. The candidate person referent 1124 may become a referent outside current field of view 1136 but remain represented in the contextual representation 1120 over the preceding time window 1134. The user 1000 may silently ask “where do I know him from.” The platform 1001 may retrieve relationship data 1602 from the longitudinal user-specific context 1600 and output private assistant output 1070 indicating a prior meeting, event, company, family relationship, or communication.

In a third example, the platform 1001 may provide conversational cueing. The selected candidate referent 1210 may be a known person. The platform 1001 may retrieve prior support outcome data 1610, relationship data 1602, or message history, and may output private assistant output 1070 such as a suggested question, a reminder of a promise, a warning to avoid a sensitive topic, or an indication that the user 1000 may have already told a story. Such output may assist the user 1000 without requiring visible consultation of the companion handheld device 1060.

In a fourth example, the platform 1001 may provide proactive social navigation. The platform 1001 may identify a candidate person referent 1124 approaching the user 1000 before direct engagement occurs. The platform 1001 may determine that the candidate person referent 1124 corresponds to a person the user 1000 wanted to meet, avoid, prepare for, or remember. The platform 1001 may output private assistant output 1070 indicating the person's name, direction, relationship, or suggested action.

In a fifth example, the user 1000 may pass a sign, menu, label, transport board, or other candidate text-bearing referent 1128. One of the left ear-worn device 1010 or right ear-worn device 1012 may obtain a usable observation of the candidate text-bearing referent 1128 using the optical or infrared sensor 1030. The platform 1001 may store text, text-region features, language information, or a semantic category in the contextual representation 1120. Later, the user 1000 may provide silent or low-audibility user input 1200, such as “translate that” or “what did that say.” The platform 1001 may output a translation, reading, summary, or explanation through private assistant output 1070.

In a sixth example, the platform 1001 may provide context-disambiguated translation. The user 1000 may silently utter “is this safe.” The contextual representation 1120 may include a menu item, medication package, route, vehicle, or payment terminal. The context-disambiguation processor 1404 may determine the relevant meaning of “safe” using the selected candidate referent 1210, location, user preferences, and longitudinal user-specific context 1600. The translation processor 1402 may generate target-language output 1406 or private assistant output 1070 appropriate to the context.

In a seventh example, the user 1000 may conduct a face-to-face interpreted conversation. The user 1000 may provide source-language silent input 1400 in a language preferred by the user 1000. The translation processor 1402 may generate target-language output 1406, and the companion handheld device 1060 may output the target-language output 1406 as public speaker output 1408 to another person. The other person may reply with foreign-language reply 1410, which may be translated and output to the user 1000 as private return translation 1412 through the ear-worn device 1014.

In an eighth example, the platform 1001 may provide proactive translation. The outward microphone 1020 may detect ambient speech in a language different from a preferred language of the user 1000. The platform 1001 may determine that the ambient speech concerns the user 1000, is directed at the user 1000, includes the name of the user 1000, includes hostile or relevant content, or is otherwise user-relevant. The platform 1001 may output private assistant output 1070 offering a summary, translation, warning, or explanation.

In a ninth example, the platform 1001 may provide local-context interpretation while the user 1000 is abroad. The contextual representation 1120 may include candidate person referents 1124, gestures, speech, route information, location information, and candidate vehicle or hazard referents 1130. The platform 1001 may determine that an apparent social approach is inconsistent with local safety patterns or is associated with a tourist scam, unsafe transportation, coercion, distraction, pickpocketing, or another risk. The platform 1001 may output a private warning or action proposal 1308.

In a tenth example, the platform 1001 may detect a physical hazard. The optical or infrared sensor 1030, outward microphone 1020, and inertial measurement unit 1040 may detect a candidate vehicle or hazard referent 1130, such as a vehicle, bicycle, scooter, animal, or obstacle approaching from an oblique or rear direction. The platform 1001 may determine trajectory, speed, proximity, and urgency, and may output private assistant output 1070 indicating a direction or action, such as “left,” “behind,” or “stop.”

In an eleventh example, the platform 1001 may detect a persistent-following condition. The contextual representation 1120 may include repeated temporally separated observations 1112 of a candidate person referent 1124 or candidate vehicle or hazard referent 1130. The platform 1001 may determine that the candidate referent remains near the user 1000 across multiple locations or times. The platform 1001 may privately output a warning, propose a transportation action 1314, propose a trusted contact action 1312, or initiate evidence preservation action 1316 after user confirmation 1218.

In a twelfth example, the platform 1001 may detect that the user 1000 has left a personal item behind. The contextual representation 1120 may identify a candidate object referent 1126 as associated with the user 1000, such as a bag, phone, wallet, keys, laptop, or medication. The platform 1001 may detect that the user 1000 is moving away from the candidate object referent 1126. The platform 1001 may output private assistant output 1070 reminding the user 1000 to retrieve the item.

In a thirteenth example, the platform 1001 may initiate a transportation action 1314. The platform 1001 may detect an alert condition 1306, unsafe route, reduced-capacity state, or user request such as “get me out.” The platform 1001 may select a pickup location based on current direction of travel, location, route safety, lighting, crowd density, proximity to road access, and risk condition. The platform 1001 may privately ask for user confirmation 1218, initiate a ride-hailing request, and privately guide the user 1000 to the pickup point while monitoring whether the alert condition 1306 persists.

In a fourteenth example, the platform 1001 may initiate a trusted contact action 1312. The user 1000 may silently say “call Anna,” “send my location,” or “help.” Alternatively, the platform 1001 may detect distress, reduced capacity, or a safety-relevant alert condition 1306. The platform 1001 may select a trusted contact from trusted contact data 1606, privately request user confirmation 1218, and initiate a call, message, live-location sharing, or context-summary transmission.

In a fifteenth example, the platform 1001 may initiate evidence preservation action 1316. The platform 1001 may detect an alert condition 1306, such as a following condition, unsafe transportation condition, physical hazard, theft, assault risk, or other safety event. The platform 1001 may preserve selected data from a rolling buffer, including pre-event and post-event data, head-orientation information 1116, location, candidate referents 1122, confidence values 1138, private prompts, user confirmations 1218, and actions taken. The protected event record may be encrypted, hash-chained, stored securely, or transmitted according to safety policy 1604.

In a sixteenth example, the platform 1001 may provide reduced-capacity assistance. The user-state estimator 1612 may determine that the user 1000 appears intoxicated, fatigued, panicked, overloaded, disoriented, distressed, or otherwise reduced in capacity. The platform 1001 may lower thresholds for alert conditions 1306, increase private prompts, require additional confirmation for risky actions, suggest a transportation action 1314, suggest a trusted contact action 1312, delay an outgoing message, or pause a payment according to safety policy 1604.

In a seventeenth example, the platform 1001 may provide protective friction for communications. The user 1000 may begin composing, dictating, or silently formulating an outgoing communication while the user-state estimator 1612 detects distress or reduced capacity. The platform 1001 may compare the communication context with prior support outcome data 1610 and may output private assistant output 1070 asking whether to wait, rewrite, call a trusted contact first, or save a draft. The user 1000 may confirm, reject, or modify the proposed action.

In an eighteenth example, the platform 1001 may provide protective friction for payments. The user-state estimator 1612 may detect a reduced-capacity state, and the platform 1001 may detect an unusual payment, repeated payment, late-night payment, payment in an unfamiliar location, or payment inconsistent with user preferences. The platform 1001 may output private assistant output 1070 asking whether to pause, limit, confirm, or delay the payment, and may require additional authentication or user confirmation 1218.

In a nineteenth example, the platform 1001 may provide emotional first response. The companion handheld device 1060 may receive an upsetting message, legal notice, medical notice, financial alert, family message, or other emotionally significant communication. The user 1000 may produce an affective utterance such as “oh bummer” or “not again.” The platform 1001 may compare the current context with prior support outcome data 1610 and may output private assistant output 1070 summarizing the message, assessing urgency, suggesting not to reply immediately, or proposing a trusted contact action 1312.

In a twentieth example, the platform 1001 may infer meaning from an affective micro-utterance. The user 1000 may make a short private expression such as “help,” “oh no,” “damn,” or “I cannot.” The platform 1001 may combine the expression with the contextual representation 1120, user-state estimator 1612, and longitudinal user-specific context 1600 to determine whether the semantic objective 1204 is emotional support, translation, safety assistance, social assistance, navigation, or another assistant operation 1214.

In a twenty-first example, the platform 1001 may support a silent communication session 1500. The user 1000 may silently participate in a telephone call, video call, conference call, or voice-message exchange. The platform 1001 may authenticate the user 1000 using wearer authentication 1502 and articulation biometric 1504, generate generated user-voice audio 1512 using user voice profile 1506, and transmit the generated user-voice audio 1512 to a remote participant 1510. The user 1000 may hear the remote participant 1510 privately through the ear-worn device 1014.

In a twenty-second example, the platform 1001 may support a silent translated communication session 1500. The user 1000 may provide silent or low-audibility user input 1200 in a source language. The platform 1001 may translate the input using translation processor 1402, generate generated user-voice audio 1512 in a target language using voice synthesis processor 1508, and transmit the generated user-voice audio 1512 to the remote participant 1510 or output it as public speaker output 1408. A reply may be translated into private return translation 1412.

In a twenty-third example, the platform 1001 may prevent unauthorized use of personal voice synthesis. If the ear-worn device 1014 is stolen, borrowed, or worn by an unauthenticated person, wearer authentication 1502 or articulation biometric 1504 may fail. The platform 1001 may then disable generated user-voice audio 1512, disable silent communication session 1500 transmission, disable payment authorization, disable access to sensitive longitudinal user-specific context 1600, or notify a trusted device or contact.

In a twenty-fourth example, the platform 1001 may preserve continuity across replacement devices. The user 1000 may replace the ear-worn device 1014 or companion handheld device 1060. The longitudinal user-specific context 1600, including relationship data 1602, safety policy 1604, trusted contact data 1606, communication style profile 1608, and prior support outcome data 1610, may be restored or synchronized to the replacement device. The platform 1001 may thereby maintain continuity of personalized output, social assistance, safety policy, and preferred assistant behavior.

In a twenty-fifth example, the platform 1001 may provide mixed private and public output. The user 1000 may silently ask a question, the platform 1001 may privately provide context or confirmation, and then may publicly output translated speech, generated user-voice audio 1512, or another public companion-device output 1072 to a third party. For example, the platform 1001 may privately confirm “ask the waiter whether this contains peanuts?” and, after user confirmation 1218, output the question aloud in a target language through the companion handheld device 1060.

The examples described in this section are non-limiting. The same hardware, software, and process components may support many other assistant operations 1214. In particular, the ear-worn contextual companion platform 1001 may combine the ear-worn device 1014, optical or infrared sensor 1030, inertial measurement unit 1040, contextual representation 1120, silent speech processor 1202, referent resolver 1208, assistant service selector 1212, private assistant output 1070, public companion-device output 1072, proactive mode 1302, safety policy 1604, and longitudinal user-specific context 1600 in different ways to support future real-world contextual assistant use cases.

### Apparatus Embodiments for Ear-Worn Contextual Companion Platform

In some embodiments, the ear-worn contextual companion platform 1001 may be embodied as an apparatus comprising at least one ear-worn device 1014. The ear-worn device 1014 may be configured to be worn at, in, on, around, or adjacent to an ear of the user 1000. The ear-worn device 1014 may be an earbud, smart earplug, hearing-aid-type device, hearable device, headphone, behind-the-ear device, in-ear device, over-ear device, on-ear device, cartilage-mounted device, bone-conduction device, or other earpiece.

In some embodiments, the apparatus may comprise a pair of ear-worn devices, including the left ear-worn device 1010 and the right ear-worn device 1012. The left ear-worn device 1010 and the right ear-worn device 1012 may each comprise one or more components described herein. In some embodiments, the left ear-worn device 1010 and right ear-worn device 1012 may be substantially symmetrical. In other embodiments, the left ear-worn device 1010 and right ear-worn device 1012 may have different sensor orientations, different optical or infrared sensors 1030, different microphone arrangements, different power capacities, or different processing responsibilities.

In some embodiments, the housing 1016 of the ear-worn device 1014 may support, enclose, align, orient, protect, or mechanically couple one or more components. The housing 1016 may be configured to position the ear speaker or private output transducer 1018 relative to the ear canal of the user 1000. The housing 1016 may also be configured to position the outward microphone 1020 toward the surrounding environment, the inward microphone 1022 toward an ear canal or body-internal sound path, the silent-speech sensor 1026 toward a signal source associated with speech production, and the optical or infrared sensor 1030 toward an environmental, facial, jaw, mouth, hand, or body region.

In some embodiments, the ear speaker or private output transducer 1018 may comprise an acoustic speaker, balanced armature driver, dynamic driver, bone-conduction transducer, cartilage-conduction transducer, haptic transducer, vibration transducer, or another output device. The ear speaker or private output transducer 1018 may output private assistant output 1070, remote participant audio, private return translation 1412, navigation instructions, warnings, confirmations, social-context cues, or other private output.

In some embodiments, the outward microphone 1020 may be configured to detect environmental sound. Environmental sound may include speech by other persons, transport announcements, vehicle sounds, footsteps, alarms, sirens, horns, impact sounds, ambient noise, restaurant noise, crowd noise, or other sounds originating outside the body of the user 1000. The outward microphone 1020 may be omnidirectional, directional, beamforming, pressure-gradient, MEMS-based, or another microphone type. In some embodiments, a plurality of outward microphones 1020 may be distributed across the left ear-worn device 1010, right ear-worn device 1012, companion handheld device 1060, or companion head-mounted device 1064.

In some embodiments, the inward microphone 1022 may be configured to detect sounds, vibrations, pressure changes, or acoustic signals originating within, or conducted through, the body of the user 1000. Such signals may include silent speech, low-audibility speech, subvocal speech, whispered speech, tooth-click sounds, tongue-click sounds, breath sounds, jaw movement sounds, swallowing sounds, or other body-conducted signals. The inward microphone 1022 may face the ear canal, eardrum, concha, pinna, or another ear-adjacent region.

In some embodiments, the bone-conduction, cartilage-conduction, vibration, or body-conducted-signal sensor 1024 may comprise a bone-conduction transducer, cartilage-conduction transducer, accelerometer, contact microphone, vibration sensor, piezoelectric sensor, pressure sensor, laser microphone, optical vibrometer, or other sensor configured to detect signals conducted through bone, cartilage, skin, tissue, ear canal, eardrum, jaw, teeth, tongue, cheek, neck, or skull. The sensor 1024 may assist in detection of silent or low-audibility user input 1200, wearer authentication 1502, articulation biometric 1504, or user-state estimation.

In some embodiments, the silent-speech sensor 1026 may comprise one or more sensors selected from the outward microphone 1020, inward microphone 1022, sensor 1024, optical or infrared sensor 1030, inertial measurement unit 1040, EMG electrode, EOG electrode, skin-contact electrode, pressure sensor, strain sensor, ultrasonic sensor, laser microphone, or other sensor. The silent-speech sensor 1026 may be configured to capture features associated with silent speech, subvocal speech, whispered speech, mouthed speech, low-audibility speech, tongue movement, tooth movement, jaw movement, cheek movement, neck movement, mouth movement, or another intentional user input.

In some embodiments, the optical or infrared sensor 1030 may be positioned on the housing 1016 to acquire environmental observations. The optical or infrared sensor 1030 may be outward-facing, side-facing, rear-oblique, forward-oblique, downward-facing, upward-facing, or otherwise oriented. In some embodiments, the first optical or infrared sensor 1032 may be oriented differently from the second optical or infrared sensor 1034. For example, the first optical or infrared sensor 1032 may be environment-facing and the second optical or infrared sensor 1034 may be face-facing, jaw-facing, mouth-facing, hand-facing, or downward-facing.

In some embodiments, the infrared emitter or illumination source 1036 may be positioned to illuminate a region imaged or sensed by the optical or infrared sensor 1030. The infrared emitter or illumination source 1036 may illuminate an environmental region, person, object, sign, menu, surface, hand, cheek, jaw, mouth, or other target. The infrared emitter or illumination source 1036 may operate continuously, intermittently, in pulses, in structured-light patterns, in response to detected head movement, in response to silent or low-audibility user input 1200, or in response to a suspected user-relevant condition 1304.

In some embodiments, the inertial measurement unit 1040 may comprise one or more accelerometers, gyroscopes, magnetometers, barometers, or other motion sensors. The inertial measurement unit 1040 may generate head-orientation information 1116, motion information, gait information, impact information, fall information, user-state information, or other movement-related data. The inertial measurement unit 1040 may be used to associate temporally separated observations 1112 with a head sweep path 1114, estimate a current attention direction, detect reduced-capacity states, detect gestures, or stabilize sensor data.

In some embodiments, the processor 1042 may be any suitable processing circuit, microcontroller, digital signal processor, neural processing unit, application processor, sensor hub, secure processor, or other processing device. The processor 1042 may execute program instructions stored in memory 1044. The processor 1042 may perform local signal processing, noise reduction, silent-speech detection, feature extraction, authentication, head-motion estimation, contextual mapping, private output generation, wireless communication, or other processing.

In some embodiments, the memory 1044 may store firmware, software, models, configuration data, user settings, authentication templates, short-term buffers, derived features, contextual representation 1120, safety policy 1604, communication style profile 1608, or other data. The memory 1044 may include volatile memory, non-volatile memory, secure memory, encrypted memory, or another computer-readable storage medium.

In some embodiments, the wireless interface 1046 may support communication with one or more other devices. The wireless interface 1046 may support Bluetooth, Bluetooth Low Energy, Wi-Fi, ultra-wideband, cellular communication, near-field communication, optical communication, body-area network communication, or another communication protocol. The wireless interface 1046 may communicate with the companion handheld device 1060, companion wrist-worn device 1062, companion head-mounted device 1064, vehicle system, remote assistant system 1066, trusted contact device, payment terminal, or other external system.

In some embodiments, the authentication sensor or module 1048 may perform or support wearer authentication 1502, articulation biometric 1504, device authentication, secure pairing, encryption, or secure execution. The authentication sensor or module 1048 may comprise a contact sensor, impedance sensor, temperature sensor, pressure sensor, ear-canal acoustic response module, secure enclave, cryptographic processor, biometric processor, or other authentication-related component.

In some embodiments, the battery or power unit 1050 may provide electrical power to one or more components of the ear-worn device 1014. The platform 1001 may manage power consumption by selectively activating the optical or infrared sensor 1030, infrared emitter or illumination source 1036, processor 1042, wireless interface 1046, or other components. For example, the platform 1001 may operate the optical or infrared sensor 1030 at a low rate during ordinary operation and increase sensing when a head sweep path 1114, silent or low-audibility user input 1200, alert condition 1306, or other trigger is detected.

In some embodiments, components of the apparatus may be distributed among devices. For example, the ear-worn device 1014 may provide sensors and private output, the companion handheld device 1060 may provide processing, display, public speaker output 1408, payment credentials, location services, or network access, the companion wrist-worn device 1062 may provide biometric data or gesture input, the companion head-mounted device 1064 may provide an additional optical field of view or display, and the remote assistant system 1066 may provide language models, translation, voice synthesis, object recognition, or long-term memory services.

In some embodiments, the apparatus may be configured to function even when not all components are present or active. For example, the platform 1001 may operate with a single ear-worn device 1014, with only the left ear-worn device 1010, with only the right ear-worn device 1012, without the companion head-mounted device 1064, without remote assistant system 1066 connectivity, without an active optical or infrared sensor 1030, or without public companion-device output 1072. The assistant operations 1214 available at a given time may depend on which components are present, authenticated, powered, permitted, and connected.

In some embodiments, the apparatus may be configured for privacy-preserving operation. For example, raw optical or infrared data may be processed locally and discarded, only derived features may be transmitted, private assistant output 1070 may be provided through the ear speaker or private output transducer 1018, and public companion-device output 1072 may require user confirmation 1218. The apparatus may also implement evidence preservation action 1316 only under conditions defined by safety policy 1604 or user confirmation 1218.

In some embodiments, the apparatus may be configured to operate as a context sensor even when the optical or infrared sensor 1030 is not a photographic camera. The optical or infrared sensor 1030 may generate only derived sensor data, such as motion vectors, object detections, depth values, text detections, face embeddings, gesture detections, or contextual embeddings. The apparatus may therefore support contextual representation 1120 and referent resolution without storing or displaying conventional video.

In some embodiments, the apparatus may be configured to receive silent or low-audibility user input 1200 and output private assistant output 1070 without requiring the user 1000 to look at or touch another device. This may allow the user 1000 to interact with the platform 1001 while walking, carrying items, speaking to another person, riding transport, standing in a queue, attending a meeting, or navigating an unfamiliar environment.

In some embodiments, the apparatus may be configured for modularity. For example, an optical or infrared sensor module may be included in one product version and omitted in another. A second optical or infrared sensor 1034 may be included in a higher-capability version. The infrared emitter or illumination source 1036 may be included only in embodiments requiring depth sensing or low-light operation. The user voice profile 1506 may be stored on a companion device rather than on the ear-worn device 1014. Such variations do not depart from the ear-worn contextual companion platform 1001 as long as at least one ear-worn component participates in sensing, input, output, authentication, or contextual operation.

In some embodiments, the apparatus may include a charging case, wearable case, necklace, pendant, clothing-mounted device, or other accessory. Such accessory may provide additional battery power, processing, storage, wireless relay, optical sensing, location sensing, or security functions. The accessory may communicate with the ear-worn device 1014 through the wireless interface 1046. In some embodiments, the accessory may store portions of the contextual representation 1120 or longitudinal user-specific context 1600.

In some embodiments, the apparatus may include one or more mode controls. A mode control may allow the user 1000 to enable or disable optical sensing, proactive mode 1302, translation, safety monitoring, evidence preservation, social referent assistance, silent communication session 1500, or other functions. The mode control may be a touch input, silent or low-audibility user input 1200, click-equivalent input, gesture, companion-device setting, scheduled setting, location-based setting, or another control.

In some embodiments, the apparatus may include hardware or software indicators of sensing state. For example, the ear-worn device 1014 or companion handheld device 1060 may indicate whether optical sensing, translation, communication, or evidence preservation is active. In other embodiments, the platform 1001 may operate optical or infrared sensing as non-photographic contextual sensing without a conventional camera-recording indicator, while still providing user controls, permissions, and retention settings.

The embodiments described in this section may be combined with the ear-worn optical and infrared contextual sensing embodiments, natural head-motion contextual mapping embodiments, referent resolution embodiments, private output embodiments, reactive mode 1300, proactive mode 1302, translation embodiments, safety embodiments, evidence preservation embodiments, authentication embodiments, silent communication-session embodiments, and longitudinal companion-state embodiments described elsewhere herein. In particular, the apparatus may provide the physical and distributed hardware structure for implementing the ear-worn contextual companion platform 1001.

### Method Embodiments for Ear-Worn Contextual Companion Operation

In some embodiments, a method of operating the ear-worn contextual companion platform 1001 may comprise receiving sensor data from the ear-worn device 1014, generating or updating the contextual representation 1120, receiving silent or low-audibility user input 1200, determining the semantic objective 1204, resolving a selected candidate referent 1210, selecting an assistant operation 1214, and outputting private assistant output 1070 or initiating another action.

In some embodiments, the method may comprise receiving optical or infrared sensor data from the optical or infrared sensor 1030 of the ear-worn device 1014. The optical or infrared sensor data may comprise temporally separated observations 1112 acquired as the head orientation of the user 1000 changes. The method may further comprise receiving head-orientation information 1116 from the inertial measurement unit 1040 or another motion sensor. The method may further comprise associating the temporally separated observations 1112 with the head-orientation information 1116.

In some embodiments, the method may comprise generating or updating the contextual representation 1120 from the temporally separated observations 1112 and head-orientation information 1116. The contextual representation 1120 may comprise candidate referents 1122 in the surroundings of the user 1000. The candidate referents 1122 may include a candidate person referent 1124, candidate object referent 1126, candidate text-bearing referent 1128, candidate vehicle or hazard referent 1130, or referent outside current field of view 1136. The contextual representation 1120 may be stored locally in memory 1044, on the companion handheld device 1060, on the remote assistant system 1066, or in distributed form.

In some embodiments, the method may comprise receiving silent or low-audibility user input 1200 from the user 1000. The silent or low-audibility user input 1200 may be detected using the silent-speech sensor 1026, outward microphone 1020, inward microphone 1022, bone-conduction, cartilage-conduction, vibration, or body-conducted-signal sensor 1024, optical or infrared sensor 1030, inertial measurement unit 1040, or a combination thereof. The method may comprise processing the silent or low-audibility user input 1200 using the silent speech processor 1202 to determine the semantic objective 1204.

In some embodiments, the method may comprise determining that the semantic objective 1204 includes an incomplete referent slot 1206. The incomplete referent slot 1206 may correspond to a deictic or context-dependent expression, such as “this,” “that,” “it,” “there,” “him,” “her,” “that one,” “over there,” or an implicit object slot in a command such as “open,” “send,” “pay,” “translate,” “read,” “call,” or “get me there.” The method may further comprise filling the incomplete referent slot 1206 by selecting the selected candidate referent 1210 from the contextual representation 1120 using the referent resolver 1208.

In some embodiments, selecting the selected candidate referent 1210 may comprise comparing the semantic objective 1204 with candidate referents 1122 in the contextual representation 1120. The comparison may use semantic compatibility, head-orientation information 1116, recency of observation, confidence values 1138, proximity, trajectory, object class, text content, person identity, user-specific context, gesture information, acoustic direction, application context, location, or other information. The selected candidate referent 1210 may be selected even when it is not currently within the instantaneous sensor field of view 1110 of the optical or infrared sensor 1030.

In some embodiments, the method may comprise selecting an assistant operation 1214 using the assistant service selector 1212. The assistant operation 1214 may be selected from translation, navigation, payment, messaging, calling, social referent assistance, object identification, text recognition, ride-hailing, trusted contact action 1312, transportation action 1314, evidence preservation action 1316, emergency escalation, device control, search, summarization, or another operation. The assistant operation 1214 may be selected without the user 1000 explicitly selecting an application.

In some embodiments, the method may comprise outputting private assistant output 1070 through the ear speaker or private output transducer 1018 of the ear-worn device 1014. The private assistant output 1070 may comprise an answer, translation, warning, explanation, identity cue, conversational prompt, navigation cue, confirmation request, emotional-support prompt, safety prompt, or another output. The private assistant output 1070 may be perceptible to the user 1000 and not perceptible or not intelligible to nearby persons.

In some embodiments, the method may comprise outputting public companion-device output 1072. Public companion-device output 1072 may comprise target-language output 1406, public speaker output 1408, generated user-voice audio 1512, displayed information, transmitted message, or another output perceptible to a third party or remote participant 1510. The method may comprise requesting user confirmation 1218 before outputting public companion-device output 1072.

In some embodiments, the method may comprise operating in the reactive mode 1300. In the reactive mode 1300, the method may be initiated by silent or low-audibility user input 1200. The method may comprise processing the input, resolving a referent, selecting an assistant service, requesting user confirmation 1218 where appropriate, and initiating an assistant operation 1214.

In some embodiments, the method may comprise operating in the proactive mode 1302. In the proactive mode 1302, the method may comprise detecting a user-relevant condition 1304 without receiving contemporaneous silent or low-audibility user input 1200. The method may comprise determining whether the user-relevant condition 1304 satisfies an alert condition 1306, selecting an intervention level 1310, generating an action proposal 1308, outputting private assistant output 1070, receiving user confirmation 1218, and initiating an assistant operation 1214 where appropriate.

In some embodiments, detecting the user-relevant condition 1304 may comprise detecting a hazard, approaching vehicle, following condition, unsafe route, left-behind object, known person approaching, translation opportunity, emotionally significant notification, reduced-capacity state, payment risk, communication risk, or transportation need. The method may comprise using the contextual representation 1120, longitudinal user-specific context 1600, safety policy 1604, user-state estimator 1612, or other information to determine whether the user-relevant condition 1304 should result in private assistant output 1070.

In some embodiments, the method may comprise detecting a reduced-capacity state using the user-state estimator 1612. The reduced-capacity state may include intoxication, fatigue, distress, disorientation, anxiety, cognitive overload, sensory overload, sleep deprivation, or another state. The method may comprise adjusting an alert threshold, intervention level 1310, confirmation requirement, service-selection rule, or protective action based on the reduced-capacity state.

In some embodiments, the method may comprise implementing protective friction. The method may comprise detecting a proposed or imminent action by the user 1000, determining that the action is associated with risk in view of the reduced-capacity state, safety policy 1604, prior support outcome data 1610, or current context, outputting a private prompt, receiving user confirmation 1218, and delaying, modifying, confirming, cancelling, or allowing the action. The action may comprise a payment, message, call, route choice, ride choice, social interaction, device-control action, or information disclosure.

In some embodiments, the method may comprise context-disambiguated translation. The method may comprise receiving source-language silent input 1400, using the context-disambiguation processor 1404 to disambiguate the source-language silent input 1400 based on the contextual representation 1120, selected candidate referent 1210, location, addressee, or longitudinal user-specific context 1600, translating the disambiguated content using the translation processor 1402, and outputting target-language output 1406 as public companion-device output 1072 or private assistant output 1070.

In some embodiments, the method may comprise two-way interpretation. The method may comprise receiving source-language silent input 1400 from the user 1000, outputting target-language output 1406 to a third party as public speaker output 1408, receiving foreign-language reply 1410, translating the foreign-language reply 1410, and outputting private return translation 1412 to the user 1000 through the ear-worn device 1014.

Outward Ear-Worn Target-Language Output with User-Side Cancellation

In some embodiments, the target-language output 1406 may be output by an outward-facing or externally audible speaker of the ear-worn device 1014. For example, the ear-worn device 1014 may comprise an outward-facing speaker, vented speaker, directional speaker, ultrasonic parametric speaker, beamforming speaker, bone-independent external acoustic transducer, or other external output transducer configured to output public companion-device output 1072 toward an interlocutor or nearby third party. In such embodiments, the user 1000 may provide source-language silent input 1400, the translation processor 1402 may generate target-language output 1406, and the ear-worn device 1014 may output the target-language output 1406 as externally audible speech while the user 1000 maintains eye contact with the interlocutor.

In some embodiments, the outward-facing speaker of the ear-worn device 1014 may be oriented or acoustically shaped to preferentially direct target-language output 1406 away from the ear canal of the user 1000 and toward an interlocutor. In some embodiments, the platform 1001 may use beamforming, directional audio, acoustic shielding, phase cancellation, active noise cancellation, adaptive filtering, or anti-phase audio through the ear speaker or private output transducer 1018 to reduce perception by the user 1000 of the target-language output 1406 generated by the outward-facing speaker. The attenuation need not be complete; it may be sufficient to reduce distraction, echo, self-monitoring discomfort, or cognitive interference caused by the user 1000 hearing the translated speech in a language not intended for private monitoring.

In some embodiments, the ear speaker or private output transducer 1018 may output a cancellation signal, masking signal, comfort noise, private monitoring signal, or private return translation 1412 while the outward-facing speaker outputs target-language output 1406. The cancellation or masking may be based on the known waveform of the target-language output 1406, a microphone signal from the inward microphone 1022, a microphone signal from the outward microphone 1020, an estimate of acoustic leakage into the user's ear canal, or an adaptive filter. In such embodiments, the interlocutor may hear the translated speech while the user 1000 hears reduced leakage, a private confirmation, or the interlocutor's reply.

In some embodiments, the platform 1001 may select among different target-language output devices. The assistant service selector 1212 may select the outward-facing speaker or external acoustic output transducer 1019 of the ear-worn device 1014, the companion handheld device 1060, companion wrist-worn device 1062, companion head-mounted device 1064, vehicle speaker, conference device, or another public speaker based on distance to the interlocutor, ambient noise, privacy setting, social context, battery state, acoustic feedback, eye-contact context, or user preference. For close face-to-face conversation, the outward-facing speaker 1019 of the ear-worn device 1014 may be selected so that the interlocutor hears speech emanating from the vicinity of the head of the user 1000, while the user 1000 remains able to interact silently and privately.

In some embodiments, the method may comprise proactive translation. The method may comprise detecting ambient speech using the outward microphone 1020, determining that the ambient speech is in a language different from a preferred language of the user 1000, determining that the ambient speech is user-relevant, generating a translation, summary, warning, or social-risk indication, and outputting private assistant output 1070 through the ear-worn device 1014.

In some embodiments, the method may comprise social referent assistance. The method may comprise detecting or identifying a candidate person referent 1124, selecting the candidate person referent 1124 as the selected candidate referent 1210, retrieving relationship data 1602 or prior interaction data from the longitudinal user-specific context 1600, and outputting private assistant output 1070 comprising a name, relationship, prior interaction, remembered obligation, social-context cue, or conversational prompt.

In some embodiments, the method may comprise personal safety assistance. The method may comprise detecting an alert condition 1306, outputting a private warning, generating an action proposal 1308, receiving user confirmation 1218, and initiating a trusted contact action 1312, transportation action 1314, evidence preservation action 1316, emergency escalation, or route guidance. The method may comprise selecting the intervention level 1310 based on severity, confidence value 1138, user state, location, time, or safety policy 1604.

In some embodiments, the method may comprise initiating a transportation action 1314. The method may comprise selecting a pickup or rendezvous location based on current location, direction of travel, route safety, lighting, crowd density, road access, or risk condition; requesting user confirmation 1218; initiating a ride-hailing or transport request; privately guiding the user 1000 to the pickup location; and monitoring whether an alert condition 1306 persists.

In some embodiments, the method may comprise initiating a trusted contact action 1312. The method may comprise selecting a trusted contact from trusted contact data 1606, generating a message or call context, privately requesting user confirmation 1218, contacting the trusted contact, sharing location, or providing a context summary. In some embodiments, non-response by the user 1000 under a high-severity alert condition 1306 may trigger trusted contact action 1312 according to safety policy 1604.

In some embodiments, the method may comprise initiating evidence preservation action 1316. The method may comprise maintaining a rolling buffer, detecting an alert condition 1306, receiving user confirmation 1218 or detecting non-response under safety policy 1604, preserving selected pre-event and post-event data, encrypting or signing a protected event record, storing or transmitting the protected event record, and controlling disclosure according to user settings.

In some embodiments, the method may comprise operating a silent communication session 1500. The method may comprise receiving silent or low-audibility user input 1200 during the communication session 1500, authenticating the user 1000 using wearer authentication 1502 or articulation biometric 1504, converting the input into linguistic content, generating generated user-voice audio 1512 using the voice synthesis processor 1508 and user voice profile 1506, transmitting the generated user-voice audio 1512 to the remote participant 1510, and outputting audio from the remote participant 1510 privately through the ear-worn device 1014.

In some embodiments, the method may comprise performing wearer authentication 1502. The method may comprise detecting an ear-canal acoustic signature, fit signature, contact signal, impedance, temperature, bone-conduction signature, cartilage-conduction signature, articulation biometric 1504, companion-device proximity, biometric authentication on a companion device, or another authentication signal. The method may comprise inhibiting a sensitive assistant operation 1214 if authentication confidence is below a threshold.

In some embodiments, the method may comprise updating the longitudinal user-specific context 1600. The method may comprise storing or updating relationship data 1602, safety policy 1604, trusted contact data 1606, communication style profile 1608, prior support outcome data 1610, or other user-specific information based on user input, user confirmation 1218, correction, rejection, acceptance, outcome, or explicit settings. The method may comprise using the updated longitudinal user-specific context 1600 in a later operation.

In some embodiments, the method may comprise preserving continuity across devices. The method may comprise transferring, restoring, synchronizing, encrypting, or re-associating longitudinal user-specific context 1600 when the user 1000 replaces or changes the ear-worn device 1014, companion handheld device 1060, companion wrist-worn device 1062, or another device. The method may comprise requiring authentication before restoring sensitive portions of the longitudinal user-specific context 1600.

In some embodiments, the method may comprise selecting a communication style for private assistant output 1070. The method may comprise using the communication style profile 1608, user-state estimator 1612, alert condition 1306, semantic objective 1204, selected candidate referent 1210, confidence value 1138, or intervention level 1310 to select whether the private assistant output 1070 is direct, gentle, formal, brief, detailed, humorous, urgent, calming, or minimal. In some embodiments, humorous or non-urgent output may be suppressed when severity is high.

In some embodiments, the method may comprise discarding or reducing data for privacy. The method may comprise converting raw optical or infrared data into derived features, discarding raw images, retaining text strings instead of images, retaining trajectory vectors instead of video, retaining confidence values 1138 instead of raw sensor data, or applying retention tiers. In some embodiments, raw data may be retained only when evidence preservation action 1316 is triggered.

In some embodiments, the order of steps may vary. For example, the contextual representation 1120 may be generated before, during, or after receiving silent or low-audibility user input 1200. The referent resolver 1208 may operate before, during, or after the assistant service selector 1212. User confirmation 1218 may occur before or after service selection. Authentication may occur before input capture, before service execution, before public output, or continuously. Steps may also be performed concurrently or in distributed fashion.

The embodiments described in this section may be combined with the apparatus embodiments and with all other embodiments described herein. In particular, the methods may be performed by the ear-worn device 1014, companion handheld device 1060, companion wrist-worn device 1062, companion head-mounted device 1064, remote assistant system 1066, or any combination thereof, and may be embodied in computer-readable instructions stored in memory 1044 or another computer-readable storage medium.

### System Embodiments and Distributed Processing Architecture

In some embodiments, the ear-worn contextual companion platform 1001 may be implemented as a distributed system comprising the ear-worn device 1014, one or more companion devices, and one or more remote computing systems. The companion devices may include the companion handheld device 1060, companion wrist-worn device 1062, companion head-mounted device 1064, vehicle system, home device, computer, tablet, payment terminal, conference device, or another computing device. The remote computing systems may include the remote assistant system 1066, cloud service, language model service, translation service, object recognition service, speech recognition service, authentication service, storage service, emergency service, or another network-accessible system.

In some embodiments, the ear-worn device 1014 may perform low-latency sensing and private output functions. For example, the ear-worn device 1014 may collect silent or low-audibility user input 1200, obtain optical or infrared observations using the optical or infrared sensor 1030, detect head movement using the inertial measurement unit 1040, detect environmental sound using the outward microphone 1020, detect body-conducted signals using the inward microphone 1022 or sensor 1024, perform wearer authentication 1502, output private assistant output 1070, and communicate with other devices using wireless interface 1046.

In some embodiments, the companion handheld device 1060 may provide processing, storage, user interface, network access, public output, location data, payment credentials, application context, contact data, message data, calendar data, or other resources. For example, the companion handheld device 1060 may execute portions of the silent speech processor 1202, referent resolver 1208, assistant service selector 1212, translation processor 1402, context-disambiguation processor 1404, voice synthesis processor 1508, user-state estimator 1612, personalized output generator 1614, or another module. The companion handheld device 1060 may also provide public companion-device output 1072, such as public speaker output 1408 for translated speech.

In some embodiments, the companion wrist-worn device 1062 may provide biometric data, motion data, haptic output, user confirmation 1218, location data, device authentication, or other contextual data. For example, the companion wrist-worn device 1062 may provide heart rate, heart-rate variability, skin temperature, skin contact, motion, gait, fall detection, stress indicators, sleep indicators, or other physiological or behavioral data to the user-state estimator 1612. The companion wrist-worn device 1062 may also provide an additional private or semi-private output channel.

In some embodiments, the companion head-mounted device 1064 may provide additional visual sensing, gaze sensing, display, spatial mapping, or augmented-reality output. The ear-worn contextual companion platform 1001 need not require the companion head-mounted device 1064, but may use it when available. For example, the companion head-mounted device 1064 may provide a forward-facing image sensor, eye tracking, display output, spatial anchors, or additional contextual data. The ear-worn device 1014 may still provide private input, private output, authentication, and ear-worn contextual sensing.

In some embodiments, the remote assistant system 1066 may provide computationally intensive processing. The remote assistant system 1066 may execute large language models, translation models, speech recognition models, object recognition models, face recognition models, text recognition models, route analysis, safety-risk models, evidence-preservation services, longitudinal memory services, or other services. The remote assistant system 1066 may communicate with the ear-worn device 1014 or companion devices via network connection 1068.

In some embodiments, processing may be partitioned according to latency. Low-latency functions, such as hazard detection, private warning output, wearer authentication 1502, local wake detection, detection of silent or low-audibility user input 1200, and immediate private assistant output 1070, may be performed locally by processor 1042 or by a nearby companion device. Higher-latency functions, such as detailed translation, long-form summarization, object search, relationship lookup, or cloud-based reasoning, may be performed by the remote assistant system 1066.

In some embodiments, processing may be partitioned according to privacy. Privacy-sensitive functions, such as processing raw optical or infrared data, processing raw audio, accessing relationship data 1602, accessing safety policy 1604, accessing trusted contact data 1606, accessing communication history, using user voice profile 1506, or performing wearer authentication 1502, may be performed locally or in a secure environment. Derived features, embeddings, summaries, or anonymized data may be transmitted to remote services when permitted by user settings.

In some embodiments, processing may be partitioned according to power consumption. The ear-worn device 1014 may perform low-power sensing and preliminary feature extraction, while the companion handheld device 1060 or remote assistant system 1066 performs more power-intensive analysis. For example, the ear-worn device 1014 may detect a head sweep path 1114, store temporally separated observations 1112, or detect a candidate alert condition 1306, while a companion device performs full referent resolution or translation.

In some embodiments, processing may be partitioned according to connectivity. When network connection 1068 is available, the platform 1001 may use the remote assistant system 1066 for translation, reasoning, or recognition. When network connection 1068 is unavailable, the platform 1001 may use local models, cached maps, local language models, local safety policy 1604, local trusted contact data 1606, local route data, or local voice synthesis. The assistant service selector 1212 may select fallback assistant operations 1214 when a preferred remote service is unavailable.

In some embodiments, the contextual representation 1120 may be distributed. A short-term portion of the contextual representation 1120 may be stored on the ear-worn device 1014 in memory 1044. A larger or medium-term portion may be stored on the companion handheld device 1060. A long-term or synchronized portion may be stored by the remote assistant system 1066. The platform 1001 may synchronize, merge, prune, encrypt, or summarize portions of the contextual representation 1120 across devices.

In some embodiments, the longitudinal user-specific context 1600 may be distributed. For example, sensitive portions of relationship data 1602, safety policy 1604, trusted contact data 1606, communication style profile 1608, and prior support outcome data 1610 may be encrypted and stored locally, while less sensitive preference data may be synchronized through the remote assistant system 1066. The platform 1001 may preserve continuity across replacement ear-worn devices 1014 by restoring the longitudinal user-specific context 1600 after authentication.

In some embodiments, the system may include a synchronization module. The synchronization module may synchronize sensor-derived features, contextual representation 1120, prior support outcome data 1610, safety policy 1604, trusted contact data 1606, user voice profile 1506, authentication templates, or other data among the ear-worn device 1014, companion handheld device 1060, companion wrist-worn device 1062, companion head-mounted device 1064, and remote assistant system 1066. Synchronization may be continuous, periodic, event-triggered, or user-initiated.

In some embodiments, the system may include a privacy manager. The privacy manager may determine whether raw sensor data, derived features, contextual representation 1120, longitudinal user-specific context 1600, protected event records, or other data may be stored, transmitted, summarized, shared, or deleted. The privacy manager may enforce user settings, safety policy 1604, application permissions, jurisdictional restrictions, retention limits, evidence preservation settings, or authentication requirements.

In some embodiments, the system may include a secure execution environment. The secure execution environment may protect authentication templates, user voice profile 1506, payment credentials, protected event records, safety policy 1604, trusted contact data 1606, or other sensitive data. The secure execution environment may be implemented in the ear-worn device 1014, companion handheld device 1060, companion wrist-worn device 1062, remote assistant system 1066, or a combination thereof.

In some embodiments, the system may include a model-selection module. The model-selection module may select among models for silent speech recognition, translation, object recognition, person recognition, text recognition, user-state estimation, safety-risk classification, service selection, or personalized output generation. Model selection may be based on context, language, location, user state, power budget, device availability, privacy setting, latency requirement, or confidence value 1138.

In some embodiments, the system may include a confidence manager. The confidence manager may receive confidence values 1138 from the silent speech processor 1202, referent resolver 1208, assistant service selector 1212, translation processor 1402, wearer authentication 1502, articulation biometric 1504, user-state estimator 1612, and other modules. The confidence manager may determine whether to proceed, request user confirmation 1218, ask a clarification question, choose a safer assistant operation 1214, increase sensing, or suppress output.

In some embodiments, the system may include an interruption manager. The interruption manager may determine when to output private assistant output 1070. The interruption manager may consider conversation state, user motion, alert condition 1306, intervention level 1310, communication style profile 1608, prior support outcome data 1610, and user preferences. The interruption manager may suppress low-priority prompts, deliver urgent warnings immediately, or queue non-urgent outputs.

In some embodiments, the system may include a service-execution manager. The service-execution manager may initiate assistant operations 1214 selected by the assistant service selector 1212. Such operations may include translation, navigation, payment, messaging, calling, trusted contact action 1312, transportation action 1314, evidence preservation action 1316, emergency escalation, device control, search, or another service. The service-execution manager may enforce confirmation, authentication, privacy, and safety requirements before execution.

In some embodiments, the system may include a local-first safety layer. The local-first safety layer may perform at least some safety-related detection and private warning output without requiring network connection 1068. For example, approaching vehicle detection, left-behind item detection, unsafe route deviation using cached map data, following pattern detection over short time windows, or private user confirmation 1218 may be performed locally or on nearby companion devices.

In some embodiments, the system may include an event recorder. The event recorder may support evidence preservation action 1316 by maintaining rolling buffers, detecting preservation triggers, generating protected event records, encrypting data, producing hashes, producing timestamps, synchronizing records, and enforcing disclosure rules. The event recorder may operate across the ear-worn device 1014, companion handheld device 1060, and remote assistant system 1066.

In some embodiments, the system may include a device capability manager. The device capability manager may determine which sensors, processors, memories, communication links, outputs, and services are available at a given time. The device capability manager may adapt operation when the left ear-worn device 1010 is unavailable, when the right ear-worn device 1012 is unavailable, when the battery or power unit 1050 is low, when network connection 1068 is unavailable, when the companion handheld device 1060 is locked, or when an optical or infrared sensor 1030 is disabled.

In some embodiments, the system may include an energy manager. The energy manager may control sampling rates, sensor activation, wireless communication, model execution, local processing, remote processing, and output modes to conserve power. For example, the energy manager may reduce optical sensing during low-risk contexts, increase optical sensing during head movement, increase acoustic sensing during foreign-language environments, increase inertial sensing during walking, or increase sensor sampling when an alert condition 1306 is suspected.

In some embodiments, the system may include an accessibility manager. The accessibility manager may adapt private assistant output 1070, silent or low-audibility user input 1200, confirmation mechanisms, social cueing, translation, safety alerts, or output style to accessibility needs of the user 1000. For example, the platform 1001 may use haptic output instead of speech, provide shorter prompts, provide more explicit social cues, support users with speech impairment, or support users with hearing impairment.

In some embodiments, the system may operate as a platform layer rather than as a single application. The platform 1001 may receive user objectives, contextual data, and user-specific data, and then route actions to multiple applications or services. The user 1000 may interact with the platform 1001 through silent or low-audibility user input 1200 and private assistant output 1070, while the platform 1001 selects applications, services, devices, and workflows behind the scenes.

In some embodiments, the system may include application programming interfaces. The application programming interfaces may allow external services to request or receive selected assistant operations 1214, subject to user permissions. For example, a ride-hailing service may receive a transportation action 1314, a payment service may receive a payment request, a translation service may receive text, a messaging service may receive a message, or a safety service may receive an alert. The platform 1001 may avoid exposing raw contextual representation 1120 or raw sensor data to third-party services unless authorized.

In some embodiments, the system may include a user-review interface. The user-review interface may allow the user 1000 to review recent contextual representations 1120, prior support outcome data 1610, protected event records, service selections, privacy settings, safety policy 1604, communication style profile 1608, trusted contact data 1606, authentication logs, or other data. The user-review interface may be presented on the companion handheld device 1060, companion wrist-worn device 1062, companion head-mounted device 1064, remote assistant system 1066, or another device.

In some embodiments, the system may include parental, caregiver, enterprise, or delegated administration modes. Such modes may allow a parent, caregiver, employer, clinician, guardian, or other authorized administrator to configure limited aspects of the platform 1001, such as trusted contact data 1606, emergency escalation, accessibility settings, safety policy 1604, or evidence preservation settings. Such administration may be subject to user consent, legal authority, age, capacity, enterprise policy, or other constraints.

The embodiments described in this section may be combined with the apparatus embodiments, method embodiments, contextual mapping embodiments, referent resolution embodiments, private output embodiments, reactive mode 1300, proactive mode 1302, translation embodiments, safety embodiments, evidence preservation embodiments, authentication embodiments, silent communication-session embodiments, and longitudinal companion-state embodiments described elsewhere herein. In particular, the distributed processing architecture may allow the ear-worn contextual companion platform 1001 to operate across multiple devices while preserving the ear-worn device 1014 as a private sensing, input, authentication, and output interface for the user 1000.

### Privacy, Consent, Data Retention, and User Control

In some embodiments, the ear-worn contextual companion platform 1001 may include privacy, consent, data retention, and user-control mechanisms. Such mechanisms may govern how sensor data, derived features, contextual representation 1120, longitudinal user-specific context 1600, protected event records, translations, communication data, authentication data, and assistant operations 1214 are collected, processed, stored, transmitted, output, disclosed, deleted, or otherwise used.

In some embodiments, the platform 1001 may distinguish between raw sensor data and derived contextual data. Raw sensor data may include raw optical or infrared data from the optical or infrared sensor 1030, raw acoustic data from the outward microphone 1020 or inward microphone 1022, raw inertial data from the inertial measurement unit 1040, raw biometric data, raw location data, or other raw data. Derived contextual data may include object identifiers, text strings, face or person embeddings, candidate referents 1122, confidence values 1138, semantic labels, trajectory vectors, acoustic bearings, speech transcripts, summaries, risk scores, or portions of the contextual representation 1120.

In some embodiments, the platform 1001 may process raw sensor data transiently and retain only derived contextual data. For example, the platform 1001 may process an optical observation of a sign, extract text from the sign, store the extracted text as a candidate text-bearing referent 1128, and discard the raw optical image. In another example, the platform 1001 may process an optical observation of a vehicle, store a trajectory vector and candidate vehicle or hazard referent 1130, and discard raw frames. In another example, the platform 1001 may process ambient speech, store a summary or user-relevance classification, and discard raw audio.

In some embodiments, the platform 1001 may implement retention tiers. A first retention tier may comprise ephemeral processing in which data is processed and discarded substantially immediately. A second retention tier may comprise short-term retention for the preceding time window 1134, such as retaining candidate referents 1122 in the contextual representation 1120 for seconds, minutes, or another limited time. A third retention tier may comprise event-based retention, in which selected data is retained when a user-relevant condition 1304 or alert condition 1306 is detected. A fourth retention tier may comprise protected retention for evidence preservation action 1316. A fifth retention tier may comprise long-term retention in the longitudinal user-specific context 1600.

In some embodiments, the user 1000 may configure retention settings. The user 1000 may select whether raw optical or infrared data, raw acoustic data, derived features, contextual representation 1120, translation data, communication transcripts, social referent data, safety data, protected event records, or prior support outcome data 1610 are stored, for how long they are stored, where they are stored, whether they are encrypted, whether they may be synchronized with the remote assistant system 1066, and whether they may be used for personalization or model improvement.

In some embodiments, the platform 1001 may apply different retention settings to different modes. For example, in an ordinary contextual assistant mode, raw sensor data may be discarded after feature extraction. In a translation mode, source-language silent input 1400 and target-language output 1406 may be retained only temporarily unless the user 1000 requests saving. In a communication session 1500, transcripts may be retained only with consent. In personal safety mode, rolling buffers may be retained only when evidence preservation action 1316 is triggered. In longitudinal companion mode, prior support outcome data 1610 may be retained to personalize future support.

In some embodiments, the platform 1001 may provide consent controls for optical or infrared sensing. The user 1000 may enable or disable optical or infrared sensor 1030 operation generally, by location, by time, by mode, by application, by alert category, or by service. The user 1000 may allow optical or infrared sensing for safety assistance but not social referent assistance, for translation but not evidence preservation, or for local processing but not remote processing. Such consent controls may be stored in safety policy 1604 or other user settings.

In some embodiments, the platform 1001 may provide consent controls for ambient audio processing. The user 1000 may enable or disable processing of ambient speech, foreign-language speech, acoustic hazards, vehicle sounds, social speech, or other sounds. The platform 1001 may process acoustic data locally to detect only user-relevant conditions 1304 and may avoid transmitting raw ambient audio unless the user 1000 permits transmission, a high-severity alert condition 1306 exists, or evidence preservation action 1316 is triggered under safety policy 1604.

In some embodiments, the platform 1001 may provide consent controls for social referent assistance. The user 1000 may enable social referent assistance only for known contacts, scheduled events, persons associated with relationship data 1602, persons who have opted in, persons whose identity is available in user-permissioned sources, or generic non-identifying social cues. The platform 1001 may allow the user 1000 to disable person identification while still permitting conversational cueing, translation, or safety detection.

In some embodiments, the platform 1001 may provide consent controls for longitudinal user-specific context 1600. The user 1000 may inspect, edit, export, import, restrict, or delete relationship data 1602, safety policy 1604, trusted contact data 1606, communication style profile 1608, prior support outcome data 1610, and other user-specific information. The platform 1001 may provide a user-review interface on the companion handheld device 1060, companion wrist-worn device 1062, companion head-mounted device 1064, or another authorized interface.

In some embodiments, the platform 1001 may support local-only processing. In local-only processing, selected data may be processed by the ear-worn device 1014, companion handheld device 1060, companion wrist-worn device 1062, or companion head-mounted device 1064 without transmission to the remote assistant system 1066. Local-only processing may be used for silent or low-audibility user input 1200, contextual representation 1120, authentication, safety detection, translation, user-state estimation, or private output generation, depending on available local processing capacity.

In some embodiments, the platform 1001 may support derived-feature transmission. In derived-feature transmission, raw optical, infrared, acoustic, biometric, or location data may be converted into derived features before transmission. For example, a raw image may be converted into a text string, bounding box, object label, contextual embedding, or confidence value 1138. A raw audio segment may be converted into a transcript, language label, acoustic bearing, or relevance score. Such derived features may be transmitted to the remote assistant system 1066 instead of raw data.

In some embodiments, the platform 1001 may support user-visible privacy modes. Example modes may include a private mode, local-only mode, travel mode, safety mode, social mode, interpreter mode, communication mode, evidence mode, and low-power mode. Each mode may define which sensors are active, which data may be retained, whether public companion-device output 1072 is permitted, whether proactive mode 1302 is enabled, whether evidence preservation action 1316 may occur, and whether remote assistant system 1066 processing is permitted.

In some embodiments, the platform 1001 may provide just-in-time consent prompts. For example, before outputting target-language output 1406 publicly, before initiating evidence preservation action 1316, before sharing location with a trusted contact, before transmitting generated user-voice audio 1512, before accessing sensitive relationship data 1602, before using a user voice profile 1506, or before storing a protected event record, the platform 1001 may output private assistant output 1070 requesting user confirmation 1218.

In some embodiments, consent may be implied by context and prior settings. For example, if the user 1000 has enabled safety mode and safety policy 1604 authorizes automatic evidence preservation for high-severity alert conditions 1306, the platform 1001 may initiate evidence preservation action 1316 without a contemporaneous confirmation when the user 1000 fails to respond. In another example, if the user 1000 has enabled two-way interpretation mode, the platform 1001 may process foreign-language reply 1410 and provide private return translation 1412 without asking for confirmation each time.

In some embodiments, the platform 1001 may support emergency exceptions. An emergency exception may permit selected processing, retention, or disclosure when an alert condition 1306 exceeds a severity threshold, when the user 1000 fails to respond, when the platform 1001 detects a fall, assault risk, medical risk, persistent-following condition, unsafe transportation condition, or other emergency condition, and when safety policy 1604 authorizes such escalation. Emergency exceptions may be limited to selected data and selected recipients.

In some embodiments, the platform 1001 may use privacy-preserving evidence preservation. For example, the platform 1001 may preserve only data associated with candidate referents 1122 linked to the alert condition 1306, blur or mask bystanders, store derived features rather than raw data, encrypt protected event records, restrict access, require authentication for disclosure, and delete protected event records after a retention period unless the user 1000 chooses to keep them. Such privacy-preserving evidence preservation may allow the platform 1001 to act as a safety witness while reducing unnecessary surveillance.

In some embodiments, the platform 1001 may distinguish between sensing, recording, and retention. Sensing may involve temporary collection of data to generate features or immediate outputs. Recording may involve storing raw or substantial sensor data. Retention may involve keeping raw or derived data after a processing interval. The platform 1001 may perform sensing without recording, recording without long-term retention, or retention only under user-approved or safety-approved conditions.

In some embodiments, the platform 1001 may include indicators or logs for sensor and retention activity. The user 1000 may review when optical or infrared sensing occurred, when ambient audio was processed, when proactive mode 1302 generated prompts, when evidence preservation action 1316 was triggered, when public companion-device output 1072 occurred, when generated user-voice audio 1512 was transmitted, or when longitudinal user-specific context 1600 was accessed. Such logs may be stored locally, encrypted, summarized, or made available through a user-review interface.

In some embodiments, the platform 1001 may include permissions for third-party services. A third-party translation service, ride-hailing service, payment service, messaging service, safety service, emergency service, or other service may receive only the information necessary for the assistant operation 1214 selected by the assistant service selector 1212. For example, a ride-hailing service may receive a pickup location and destination but not raw optical data. A translation service may receive text but not a raw image. A payment service may receive payment credentials or authorization but not unrelated contextual representation 1120 data.

In some embodiments, the platform 1001 may use data minimization. Data minimization may comprise collecting, processing, transmitting, or retaining only data needed for a specific assistant operation 1214, user-relevant condition 1304, alert condition 1306, or personalization function. For example, for a simple private reminder, the platform 1001 may not need to transmit any optical data. For a translation of a sign, the platform 1001 may transmit only recognized text. For a safety alert, the platform 1001 may store only trajectory and timestamp data unless evidence preservation action 1316 is triggered.

In some embodiments, the platform 1001 may support deletion and forgetting. The user 1000 may request deletion of a protected event record, prior support outcome data 1610, relationship data 1602, translation history, communication transcript, candidate referent data, authentication logs, or other data. The platform 1001 may delete the data locally and, where applicable, request deletion from the remote assistant system 1066 or third-party services. Some deletion may be subject to legal, safety, enterprise, caregiver, or evidence-preservation constraints.

In some embodiments, the platform 1001 may support export or portability. The user 1000 may export portions of the longitudinal user-specific context 1600, safety policy 1604, trusted contact data 1606, communication style profile 1608, prior support outcome data 1610, protected event records, or other data to a replacement device or service. Export may be encrypted and may require wearer authentication 1502, articulation biometric 1504, companion-device authentication, passcode, or another authentication mechanism.

In some embodiments, the platform 1001 may support restricted profiles. A restricted profile may be used for a child, elderly user, enterprise user, caregiver-supported user, temporary travel mode, guest user, shared device, or user with limited capacity. The restricted profile may limit sensing, retention, public output, service selection, proactive alerts, payment actions, or disclosure. Such restrictions may be set by the user 1000, parent, guardian, caregiver, enterprise administrator, or other authorized party.

In some embodiments, the platform 1001 may avoid storing or using sensitive context unless needed. For example, medical, dietary, financial, relationship, safety, or emotional-history data may be stored only if the user 1000 authorizes such storage. The platform 1001 may still provide generic contextual assistance without such sensitive data. For example, the platform 1001 may translate a menu without knowing dietary restrictions, or warn of a physical hazard without accessing relationship data 1602.

### Locating Personal Items Using Contextual Memory

In some embodiments, the ear-worn contextual companion platform 1001 may assist the user 1000 in locating personal items. A personal item may include keys, car keys, wallet, phone, bag, glasses, medication, passport, ticket, document, laptop, umbrella, coat, or another object associated with the user 1000. The platform 1001 may detect such an item as a candidate object referent 1126 using the optical or infrared sensor 1030, companion handheld device 1060, companion wrist-worn device 1062, wireless identifier, acoustic identifier, visual identifier, user input, or another sensor or data source.

The platform 1001 may store a last-observed location, last-observed time, direction, room, vehicle, venue, table, seat, bag, pocket, or other contextual association for the candidate object referent 1126 in the contextual representation 1120, spatially indexed context cache 1132, location-bounded memory, event-bounded memory, or longitudinal user-specific context 1600. The platform 1001 may update such information when the candidate object referent 1126 is observed again or when the confidence value 1138 changes.

In some embodiments, the user 1000 may provide silent or low-audibility user input 1200 such as “where are my car keys,” “where did I leave my wallet,” “find my phone,” “where is my bag,” or “did I forget anything.” The silent speech processor 1202 may determine a semantic objective 1204 corresponding to locating a personal item. The referent resolver 1208 may identify the relevant candidate object referent 1126 or a long-term known personal item from the longitudinal user-specific context 1600. The platform 1001 may then output private assistant output 1070 identifying the last-observed location, likely location, direction, time, or retrieval route.

In some embodiments, the platform 1001 may proactively remind the user 1000 of a personal item without a contemporaneous command. For example, if the platform 1001 detects that the user 1000 is leaving a restaurant, vehicle, train, hotel room, meeting room, airport gate, shop, or other location while a candidate object referent 1126 associated with the user 1000 remains behind, the platform 1001 may detect an alert condition 1306 and output private assistant output 1070 such as a reminder that keys, wallet, bag, phone, document, passport, or other personal item may have been left behind.

In some embodiments, the platform 1001 may separate model improvement from user-specific functionality. Data used for personal operation of the platform 1001 may be kept separate from data used to improve general models. The user 1000 may permit or prohibit use of data for general model improvement. In some embodiments, only anonymized, aggregated, or derived features may be used for model improvement, and raw data may remain local.

In some embodiments, the platform 1001 may provide a private explanation of why an action proposal 1308 or private assistant output 1070 was generated. For example, the platform 1001 may privately explain that a following condition was detected because the same candidate person referent 1124 appeared behind the user 1000 at three locations, that a payment was flagged because the user-state estimator 1612 detected reduced capacity, or that a translation was offered because a candidate text-bearing referent 1128 contained a relevant warning. Such explanation may help the user 1000 calibrate trust and modify settings.

In some embodiments, the platform 1001 may provide different privacy defaults depending on age, jurisdiction, enterprise setting, caregiver setting, safety mode, or user preference. For example, a child mode may default to more trusted-contact escalation and less social-person identification. An enterprise mode may limit communication logging. A travel mode may increase translation and safety alerts. A high-privacy mode may disable remote processing and raw-data retention.

In some embodiments, the platform 1001 may be configured so that private assistant output 1070 does not disclose sensitive information aloud to bystanders. For example, if an output concerns a medical condition, relationship issue, safety condition, payment, or private message, the platform 1001 may output the information only through the ear speaker or private output transducer 1018, may use coded or abbreviated language, or may request user confirmation 1218 before outputting more detail.

In some embodiments, the platform 1001 may include controls for public companion-device output 1072. The user 1000 may configure when target-language output 1406, public speaker output 1408, generated user-voice audio 1512, displayed text, or other public output may occur. The platform 1001 may prevent accidental public output of private thoughts, silent self-talk, affective utterances, or sensitive content by requiring user confirmation 1218 or authentication for public output.

In some embodiments, privacy settings may be context-sensitive. For example, the platform 1001 may apply different settings at home, at work, in public, during travel, during a communication session 1500, during a safety event, during a social event, or during a medical appointment. Context-sensitive privacy settings may be defined by the user 1000, learned from prior behavior, or selected by the assistant service selector 1212 according to policy.

In some embodiments, the platform 1001 may use privacy-safe defaults while still enabling powerful assistant operation. For example, by default, the platform 1001 may process optical or infrared data locally, store derived features only for the preceding time window 1134, require confirmation before public output, require authentication before sensitive actions, and use evidence preservation action 1316 only when an alert condition 1306 or user command justifies retention. The user 1000 may relax or tighten such defaults.

The embodiments described in this section may be combined with the apparatus, method, system, authentication, evidence preservation, safety, translation, communication, contextual mapping, referent resolution, private output, proactive mode 1302, reactive mode 1300, and longitudinal companion-state embodiments described elsewhere herein. In particular, privacy and consent mechanisms may govern how the platform 1001 uses the ear-worn device 1014, optical or infrared sensor 1030, contextual representation 1120, silent or low-audibility user input 1200, private assistant output 1070, public companion-device output 1072, evidence preservation action 1316, and longitudinal user-specific context 1600.

### Additional Dependent Embodiments and Optional Variations

In some embodiments, the ear-worn contextual companion platform 1001 may operate with a single ear-worn device 1014. In other embodiments, the platform 1001 may operate with both the left ear-worn device 1010 and the right ear-worn device 1012. Use of both the left ear-worn device 1010 and the right ear-worn device 1012 may provide improved spatial coverage, improved acoustic localization, improved redundancy, improved authentication, improved private output, improved context mapping, or improved confidence values 1138. Use of a single ear-worn device 1014 may provide reduced cost, reduced power consumption, reduced complexity, or improved user comfort.

In some embodiments, the optical or infrared sensor 1030 may be omitted from one of the left ear-worn device 1010 or right ear-worn device 1012. For example, the left ear-worn device 1010 may comprise the optical or infrared sensor 1030, while the right ear-worn device 1012 may comprise additional battery capacity, additional microphone capability, additional processing capability, or another component. In other embodiments, both the left ear-worn device 1010 and the right ear-worn device 1012 may comprise one or more optical or infrared sensors 1030.

In some embodiments, the optical or infrared sensor 1030 may be configured to capture only low-resolution sensor data. The low-resolution sensor data may be sufficient for detecting motion, optical flow, proximity, object class, text region, gesture, light pattern, or hazard trajectory, even if the low-resolution sensor data is insufficient to generate a conventional photograph. This may reduce power consumption, reduce bandwidth, reduce privacy concerns, and still allow generation of the contextual representation 1120.

In some embodiments, the optical or infrared sensor 1030 may be configured as an event-based sensor. An event-based sensor may output changes in brightness, movement, edges, or other events rather than conventional image frames. Such event-based sensing may be useful for detecting motion, gestures, approaching vehicles, head-sweep observations, sudden changes, or other contextual features while reducing data volume and power consumption.

In some embodiments, the optical or infrared sensor 1030 may be configured as a depth or range sensor. The depth or range sensor may provide depth, distance, proximity, structure, or surface information for candidate referents 1122. Such information may be used to determine whether a person is approaching, whether a vehicle or bicycle is closing distance, whether a personal item has been left behind, whether a door or obstacle is nearby, or whether a text-bearing referent is close enough to be read.

In some embodiments, the infrared emitter or illumination source 1036 may be operated at different power levels based on context. For example, the infrared emitter or illumination source 1036 may be operated at a low power during normal contextual sensing, at a higher power during low-light sensing, at a pulsed power level during depth sensing, or turned off during high-privacy or low-power modes. The platform 1001 may adjust operation of the infrared emitter or illumination source 1036 based on battery state, ambient light, privacy setting, safety condition, or user preference.

In some embodiments, the platform 1001 may use companion-device sensors instead of, or in addition to, sensors of the ear-worn device 1014. For example, the companion handheld device 1060 may provide a camera, microphone, location sensor, display, or processor. The companion wrist-worn device 1062 may provide biometric sensors, motion sensors, or haptic output. The companion head-mounted device 1064 may provide a forward-facing camera, eye tracker, display, or spatial sensor. The platform 1001 may fuse such data with data from the ear-worn device 1014.

In some embodiments, the contextual representation 1120 may include confidence decay over time. A confidence value 1138 associated with a candidate referent 1122 may decay as the candidate referent 1122 becomes older, as the user 1000 moves away, as the spatial relationship becomes uncertain, or as new observations conflict with earlier observations. In some embodiments, a candidate referent 1122 may be refreshed when it is observed again. In other embodiments, a candidate referent 1122 may be removed from the contextual representation 1120 when its confidence value 1138 falls below a threshold.

In some embodiments, the contextual representation 1120 may include actionability values. An actionability value may indicate whether a candidate referent 1122 can be acted upon by one or more assistant services. For example, a payment terminal may be actionable for payment, a sign may be actionable for reading or translation, a person may be actionable for identification or communication, a vehicle may be actionable for safety warning or ride verification, and a device may be actionable for control. The referent resolver 1208 or assistant service selector 1212 may use actionability values to select the selected candidate referent 1210.

In some embodiments, the contextual representation 1120 may include user-attention estimates. A user-attention estimate may be based on head-orientation information 1116, head sweep path 1114, dwell duration of head orientation, acoustic source direction, hand gesture, object saliency, conversation context, prior user behavior, or available gaze information. The user-attention estimate may be used as one factor in selecting the selected candidate referent 1210, but gaze tracking or gaze dwell need not be required.

In some embodiments, the ear-worn contextual companion platform 1001 may operate with optional gaze information from the companion head-mounted device 1064. When gaze information is available, the platform 1001 may use gaze direction, gaze dwell, eye contact, pupil direction, eye openness, or other eye-related information to improve referent resolution. When gaze information is unavailable, the platform 1001 may use head-orientation information 1116, contextual representation 1120, semantic compatibility, gesture information, and acoustic information to resolve referents.

In some embodiments, the platform 1001 may use visual codes or machine-readable identifiers. The optical or infrared sensor 1030 or companion device may detect a QR code, barcode, fiducial marker, NFC-associated visual identifier, payment code, device identifier, sign code, menu code, product code, or other machine-readable symbol. The platform 1001 may associate the detected identifier with a candidate referent 1122 in the contextual representation 1120 and may use the identifier during the assistant operation 1214.

In some embodiments, the platform 1001 may use acoustic identifiers. For example, a device, payment terminal, vehicle, beacon, speaker, or environment may emit an audible or ultrasonic identifier. The outward microphone 1020 may detect the acoustic identifier. The platform 1001 may associate the acoustic identifier with a candidate referent 1122, service endpoint, location, payment request, navigation context, or device-control interface.

In some embodiments, the platform 1001 may use wireless identifiers. For example, Bluetooth, ultra-wideband, Wi-Fi, near-field communication, cellular, or other wireless signals may identify a payment terminal, vehicle, phone, access point, beacon, device, store, person, or location. The wireless interface 1046 may detect such signals. The platform 1001 may combine wireless identifiers with the contextual representation 1120 to improve referent resolution.

In some embodiments, the platform 1001 may use body-worn or carried object identifiers. For example, a personal item associated with the user 1000 may include a tag, beacon, visual marker, acoustic marker, or wireless identifier. The platform 1001 may associate such item with the user 1000 and may detect when the item is separated from the user 1000, moved by another person, or left behind.

In some embodiments, the platform 1001 may operate with different degrees of autonomy. In a low-autonomy mode, the platform 1001 may provide private information only after a user request. In an intermediate-autonomy mode, the platform 1001 may proactively output private prompts but require user confirmation 1218 before external actions. In a high-autonomy safety mode, the platform 1001 may initiate selected protective actions under safety policy 1604 when the user 1000 fails to respond or when an alert condition 1306 exceeds a severity threshold.

In some embodiments, the platform 1001 may support context-specific vocabularies. For example, the silent speech processor 1202 may use a restaurant vocabulary in a restaurant, a transport vocabulary at a station, a payment vocabulary near a payment terminal, a social vocabulary at a conference, a safety vocabulary when walking at night, and a medical vocabulary near a medication package or medical facility. The context-specific vocabulary may be selected based on contextual representation 1120, location data, point-of-interest data, or longitudinal user-specific context 1600.

In some embodiments, the platform 1001 may support context-specific confirmation. For example, a payment confirmation may include amount, merchant, and payment method. A translation confirmation may include addressee and target language. A trusted contact confirmation may include contact name and message. A transportation confirmation may include pickup location and destination. An evidence preservation confirmation may include retention and disclosure settings. Such context-specific confirmation may be output as private assistant output 1070 and may receive user confirmation 1218 through silent or low-audibility user input 1200.

In some embodiments, the platform 1001 may support fail-safe behavior. If referent confidence, authentication confidence, translation confidence, safety confidence, or service-selection confidence is low, the platform 1001 may ask a clarification question, output a warning that confidence is low, request user confirmation 1218, choose a lower-risk action, or refrain from acting. For example, the platform 1001 may avoid making a payment, sending a message, publicly speaking a translation, or entering a vehicle when confidence is insufficient.

In some embodiments, the platform 1001 may support bystander privacy. For example, the platform 1001 may avoid storing bystander identities unless they are selected candidate referents 1210, user contacts, safety-relevant candidate referents, or otherwise relevant under user settings. The platform 1001 may blur, mask, discard, generalize, or not transmit bystander data. The platform 1001 may store only derived safety features, such as trajectory or proximity, when identity is not necessary.

In some embodiments, the platform 1001 may support multiple user profiles. For example, the same companion handheld device 1060 or remote assistant system 1066 may support multiple users, each associated with a separate longitudinal user-specific context 1600, safety policy 1604, trusted contact data 1606, communication style profile 1608, user voice profile 1506, and authentication data. The ear-worn device 1014 may select the appropriate profile based on wearer authentication 1502.

In some embodiments, the platform 1001 may support shared events or group context. For example, users at a conference, family event, school trip, workplace meeting, or travel group may share selected event context. The platform 1001 may use shared event context to identify candidate person referents 1124, provide social prompts, coordinate transportation, detect separation from group members, translate group communications, or provide safety alerts. Shared event context may be permissioned and time-limited.

In some embodiments, the platform 1001 may support child, elder, or caregiver modes. In such modes, trusted contact action 1312, location sharing, evidence preservation action 1316, safety alerts, reduced-capacity detection, or route monitoring may be configured differently. For example, a caregiver may receive alerts if the user 1000 fails to respond to a high-risk prompt, leaves a safe area, misses a route, or appears disoriented, subject to applicable permissions and law.

In some embodiments, the platform 1001 may support enterprise or professional modes. For example, the platform 1001 may assist the user 1000 in meetings, conferences, sales interactions, legal proceedings, field service, medical settings, factory settings, or security work. The platform 1001 may provide name recall, conversation context, translation, safety alerts, silent note-taking, private prompts, silent communication, or evidence preservation subject to enterprise policies and user permissions.

In some embodiments, the platform 1001 may support accessibility modes. For example, the platform 1001 may provide private social cueing for users who have difficulty interpreting social cues, silent speech communication for users with speech impairment, hazard warnings for users with reduced situational awareness, translation or transcription for users with hearing loss, memory prompts for users with cognitive load or memory impairment, or simplified prompts for users who prefer reduced complexity.

In some embodiments, the platform 1001 may support medical-adjacent but non-diagnostic assistance. For example, the platform 1001 may detect that the user 1000 appears disoriented, has fallen, is not responding, is repeating route loops, or appears to need help, and may initiate private prompts or trusted contact action 1312. Unless expressly configured and approved for medical use, such operation need not constitute diagnosis or treatment, but may provide contextual support and escalation.

In some embodiments, the platform 1001 may support vehicle and mobility integration. For example, the platform 1001 may communicate with a vehicle, taxi, ride-hailing service, public transit system, bicycle, scooter, navigation service, or pedestrian safety service. The platform 1001 may verify a vehicle, guide the user 1000 to a pickup location, warn of approaching vehicles, route to a safer street, or privately output transport instructions.

In some embodiments, the platform 1001 may support payment and commerce integration. For example, the platform 1001 may identify a payment terminal, receipt, bill, product, ticket machine, or merchant; resolve the semantic objective 1204 “pay for this” to the correct candidate referent 1122; request authentication and confirmation; and initiate payment. The platform 1001 may also apply protective friction when payment appears risky.

In some embodiments, the platform 1001 may support contextual search. For example, if the user 1000 silently says “what is that,” the platform 1001 may identify the selected candidate referent 1210, determine whether the referent is a person, object, sign, product, place, or device, and select an appropriate search or identification service. The platform 1001 may output the result privately through the ear-worn device 1014.

In some embodiments, the platform 1001 may support task and memory capture. For example, the user 1000 may silently say “remind me to send this,” “remember this,” “note that,” “follow up with him,” or another instruction. The referent resolver 1208 may associate the instruction with a selected candidate referent 1210, person, place, document, or event. The assistant service selector 1212 may create a task, note, reminder, calendar entry, message draft, or other record.

In some embodiments, the platform 1001 may support contextual emotional support without storing sensitive details. For example, the platform 1001 may detect that the user 1000 is distressed and may provide a generic supportive prompt, trusted-contact suggestion, or delay-response suggestion without storing the underlying sensitive communication. In other embodiments, the user 1000 may authorize storage of prior support outcome data 1610 to improve future assistance.

In some embodiments, the platform 1001 may support model updates. Models for silent speech recognition, optical feature extraction, referent resolution, translation, user-state estimation, safety-risk classification, personalized output generation, or voice synthesis may be updated over time. Updates may be received from the remote assistant system 1066, companion handheld device 1060, or another source. The platform 1001 may verify model authenticity before installation.

In some embodiments, the platform 1001 may support calibration. Calibration may include fitting calibration, acoustic calibration, silent speech enrollment, articulation biometric enrollment, ear-canal acoustic signature enrollment, voice profile enrollment, head-motion calibration, optical sensor calibration, privacy setting calibration, or safety policy setup. Calibration may be performed during onboarding, periodically, after device replacement, after fit change, or when confidence values 1138 degrade.

In some embodiments, the platform 1001 may support degradation modes. If the optical or infrared sensor 1030 is unavailable, the platform 1001 may use acoustic, inertial, location, and companion-device data. If the inward microphone 1022 is unavailable, the platform 1001 may use optical or vibration-based silent-speech detection. If network connection 1068 is unavailable, the platform 1001 may use local models. If authentication is unavailable, the platform 1001 may disable sensitive operations while still providing low-risk private output.

In some embodiments, the platform 1001 may support multiple output priorities. Safety warnings may have highest priority, followed by urgent navigation, active communication, translation, social cues, reminders, and low-priority suggestions. The platform 1001 may interrupt, queue, merge, summarize, or suppress outputs based on priority and context.

In some embodiments, the platform 1001 may support contextual silence. The platform 1001 may deliberately refrain from outputting private assistant output 1070 when the user 1000 is in a sensitive conversation, when an output could distract from a hazard, when confidence is low, when a prompt has recently been dismissed, or when the user 1000 has requested quiet mode. Contextual silence may be overridden by high-severity safety conditions.

In some embodiments, the platform 1001 may support reversible actions. For example, messages may be drafted before sending, payments may require confirmation, translations may be previewed before public output, ride requests may be cancelable, and evidence preservation may be reviewable before disclosure. Reversible actions may be preferred when confidence is moderate or when user state indicates reduced capacity.

In some embodiments, the platform 1001 may support learning from explicit corrections. If the user 1000 says “no, not him,” “wrong sign,” “different Anna,” “do not warn me about that,” “use formal Japanese,” “shorter,” “more direct,” “call this person first,” or another correction, the platform 1001 may update confidence values 1138, referent resolution, service selection, communication style profile 1608, or prior support outcome data 1610.

In some embodiments, the platform 1001 may support event-bounded memory. For example, at a conference, social event, trip, or meeting, the platform 1001 may retain candidate person referents 1124, conversation summaries, name badges, room locations, agenda items, and tasks for the duration of the event and then discard, summarize, or archive them according to user preference.

In some embodiments, the platform 1001 may support location-bounded memory. For example, at a station, airport, hotel, restaurant, venue, or workplace, the platform 1001 may maintain location-specific candidate referents 1122 and context. When the user 1000 leaves the location, the platform 1001 may discard or summarize the location-specific context.

In some embodiments, the platform 1001 may support confidence explanation. If the platform 1001 outputs a private warning, social cue, translation, or action proposal 1308, the user 1000 may ask why. The platform 1001 may privately explain the main factors, such as repeated observations, head orientation, text recognition, prior relationship data, route deviation, or detected foreign-language content. Such explanations may be concise and privacy-preserving.

In some embodiments, the platform 1001 may support silent override. The user 1000 may silently cancel, snooze, suppress, confirm, escalate, or modify an assistant operation 1214. A silent override may be authenticated using articulation biometric 1504 for sensitive operations.

The embodiments described in this section may be combined with any of the other embodiments described herein. The optional variations described in this section are non-limiting and may be used to broaden, narrow, specialize, or adapt the ear-worn contextual companion platform 1001 for different product designs, privacy requirements, safety requirements, user populations, environments, and services.

In some embodiments, the optical sensor may be configured to operate intermittently, opportunistically, continuously, or in response to detected conditions. For example, the optical sensor may operate at a low sampling rate during ordinary use, increase sampling when head motion indicates scanning, increase sampling when a silent utterance is detected, increase sampling when an alert condition is suspected, or reduce sampling when privacy, power, or thermal constraints require it. The system may also activate or deactivate one or more sensors based on context, such as whether the user is walking, speaking, receiving a notification, entering a crowded place, approaching a payment terminal, or requesting translation.

In some embodiments, the ear-worn device may include a privacy indicator, permission setting, consent mechanism, or mode control. However, in other embodiments, because the optical sensor may generate non-photographic features rather than conventional images, the sensor may operate as a contextual sensor without presenting itself as a conventional image-recording camera. The system may provide the user with controls for whether optical data is processed locally, transmitted, retained, used for safety detection, used for translation, used for social assistance, used for evidence preservation, or used for personalization.

In some embodiments, the optical sensor, infrared emitter, microphones, inertial sensors, silent-speech sensors, speakers, processors, memory, wireless communication interfaces, and power components may be integrated within a common earbud housing. In other embodiments, some components may be distributed between left and right earpieces, between an earpiece and a companion phone, between an earpiece and a watch, between an earpiece and smart glasses, between an earpiece and a vehicle, or between an earpiece and a cloud service. The term ear-worn device therefore includes both a single integrated earpiece and a distributed wearable system in which the earpiece provides at least one sensing, input, output, or authentication function.

The embodiments described in this section may be combined with the silent speech processing, silent sound processing, internal microphone, external microphone, cartilage-conduction, bone-conduction, laser microphone, speaker recognition, viseme recognition, command interpretation, contextual language-model selection, payment, hearing-aid, and object-command embodiments described elsewhere herein. In particular, optical or infrared contextual sensing by an ear-worn device may supply additional context for disambiguating silent speech, selecting a candidate referent, selecting an assistant service, generating a private prompt, or initiating a proactive alert.

### Figure Descriptions for Ear-Worn Contextual Companion Embodiments

FIG. 10 illustrates an embodiment of an ear-worn contextual companion platform 1001. A user 1000 may wear a left ear-worn device 1010 and a right ear-worn device 1012, each of which may be an example of an ear-worn device 1014. The ear-worn device 1014 may comprise a housing 1016, an ear speaker or private output transducer 1018, one or more outward microphones 1020, one or more inward microphones 1022, one or more bone-conduction, cartilage-conduction, vibration, or body-conducted-signal sensors 1024, one or more silent-speech sensors 1026, one or more optical or infrared sensors 1030, one or more inertial measurement units or head-motion sensors 1040, one or more processors 1042, memory 1044, one or more wireless interfaces 1046, one or more authentication sensors or modules 1048, and a battery or power unit 1050. The ear-worn device 1014 may further comprise an outward-facing speaker or external acoustic output transducer 1019 configured to output externally audible speech, translated speech, synthesized speech, or other public audio toward an interlocutor or nearby third party.

In the embodiment of FIG. 10, the ear-worn device 1014 may communicate with one or more companion devices or remote systems. Such companion devices or remote systems may include a companion handheld device 1060, a companion wrist-worn device 1062, a companion head-mounted device 1064, and a remote assistant system 1066 accessible over a network connection 1068. The ear-worn device 1014 may output private assistant output 1070 to the user 1000 through the ear speaker or private output transducer 1018. In some embodiments, the platform 1001 may also cause public companion-device output 1072, such as translated speech, generated user-voice audio, visual output, or another output through the companion handheld device 1060, companion wrist-worn device 1062, companion head-mounted device 1064, vehicle system, external speaker, or remote communication service. In some embodiments, public companion-device output 1072 may be output through the outward-facing speaker 1019 of the ear-worn device 1014, through the companion handheld device 1060, companion wrist-worn device 1062, companion head-mounted device 1064, or another external output device.

FIG. 11 illustrates an embodiment of natural head-motion contextual mapping. The user 1000 may turn the head through a sequence of orientations, including a first head orientation 1100, a second head orientation 1102, and a third head orientation 1104. At each head orientation, the optical or infrared sensor 1030 may have an instantaneous sensor field of view 1110 and may acquire a temporally separated observation 1112. The sequence of head orientations may define a head sweep path 1114. Head-orientation information 1116 from the inertial measurement unit 1040 or another sensor may be associated with the temporally separated observations 1112.

In the embodiment of FIG. 11, the platform 1001 may generate or update a contextual representation 1120 using the temporally separated observations 1112 and head-orientation information 1116. The contextual representation 1120 may comprise candidate referents 1122, including a candidate person referent 1124, a candidate object referent 1126, a candidate text-bearing referent 1128, and a candidate vehicle or hazard referent 1130. The contextual representation 1120 may include or be implemented as a spatially indexed context cache 1132 over a preceding time window 1134. A candidate referent 1122 may be a referent outside current field of view 1136 when the user 1000 later provides input. Each candidate referent 1122 may be associated with one or more confidence values 1138.

FIG. 12 illustrates an embodiment of silent intent and referent resolution. Silent or low-audibility user input 1200 may be processed by a silent speech processor 1202 to determine a semantic objective 1204. In some embodiments, the semantic objective 1204 may include an incomplete referent slot 1206. A referent resolver 1208 may use the contextual representation 1120, candidate referents 1122, confidence values 1138, head-orientation information 1116, and longitudinal user-specific context 1600 to select a selected candidate referent 1210. An assistant service selector 1212 may then select a service or workflow, and the platform 1001 may cause an assistant operation 1214. The assistant operation 1214 may produce a private prompt or private output 1216, request user confirmation 1218, initiate public companion-device output 1072, or initiate another action.

FIG. 13 illustrates an embodiment in which the ear-worn contextual companion platform 1001 supports both a reactive mode 1300 and a proactive mode 1302. In the reactive mode 1300, the user 1000 may provide silent or low-audibility user input 1200, which may be resolved to a semantic objective 1204 and a selected candidate referent 1210. In the proactive mode 1302, the platform 1001 may detect a user-relevant condition 1304 without receiving contemporaneous silent or low-audibility user input 1200. The user-relevant condition 1304 may satisfy an alert condition 1306. The platform 1001 may generate an action proposal 1308, select an intervention level 1310, and, where appropriate, initiate a trusted contact action 1312, transportation action 1314, or evidence preservation action 1316.

FIG. 14 illustrates an embodiment of context-disambiguated silent interpretation and translation. Source-language silent input 1400 may be processed by the silent speech processor 1202. The translation processor 1402 may translate the source-language silent input 1400. A context-disambiguation processor 1404 may use the contextual representation 1120, selected candidate referent 1210, location, social context, addressee identity, text-bearing referents, or longitudinal user-specific context 1600 to disambiguate the source-language silent input 1400 before or during translation. Target-language output 1406 may be output as public speaker output 1408, for example through the companion handheld device 1060. A foreign-language reply 1410 may be detected and translated into a private return translation 1412, which may be output as private assistant output 1070 through the ear-worn device 1014.

FIG. 15 illustrates an embodiment of an authenticated silent communication session. A communication session 1500 may involve the user 1000 and a remote participant 1510. During the communication session 1500, the user 1000 may provide silent or low-audibility user input 1200. Wearer authentication 1502 and articulation biometric 1504 may be used to determine whether the input is authorized. A user voice profile 1506 may be used by a voice synthesis processor 1508 to generate generated user-voice audio 1512. The generated user-voice audio 1512 may be transmitted to the remote participant 1510, while audio from the remote participant 1510 may be output privately to the user 1000 through the ear-worn device 1014.

FIG. 16 illustrates an embodiment of a longitudinal user-specific companion state. The platform 1001 may maintain longitudinal user-specific context 1600, including relationship data 1602, safety policy 1604, trusted contact data 1606, communication style profile 1608, and prior support outcome data 1610. A user-state estimator 1612 may determine a current state of the user 1000 using sensor data, interaction data, biometric data, communication data, context, or other information. A personalized output generator 1614 may generate private assistant output 1070, action proposals 1308, intervention levels 1310, or service-selection decisions using the longitudinal user-specific context 1600, contextual representation 1120, semantic objective 1204, selected candidate referent 1210, and user state.

FIGS. 10-16 are intended to illustrate example embodiments only. Components shown separately may be combined, and components shown together may be separated. Functions associated with one device may be performed by another device. For example, processing described with respect to the processor 1042 may be performed by the companion handheld device 1060, companion wrist-worn device 1062, companion head-mounted device 1064, remote assistant system 1066, or a combination thereof. Likewise, a component shown in the left ear-worn device 1010 may instead be provided in the right ear-worn device 1012, in both devices, or in a companion device. The figures are therefore not intended to limit the physical placement, distribution, or number of components.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the diagrams, scenarios, and flow charts in the figures and as discussed herein, each block and/or communication can represent a processing of information and/or a transmission of information in accordance with example embodiments. Alternative embodiments are included within the scope of these example embodiments. In these alternative embodiments, for example, functions described as blocks, transmissions, communications, requests, responses, and/or messages can be executed out of order from that shown or discussed, including substantially concurrent or in reverse order, depending on the functionality involved. Further, more or fewer blocks and/or functions can be used with any of the diagrams, scenarios, and flow charts discussed herein, and these diagrams, scenarios, and flow charts can be combined with one another, in part or in whole.

A block that represents a processing of information can correspond to circuitry that can be configured to perform the specific logical functions of a herein-described method or technique. Alternatively or additionally, a block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk or hard drive or other storage medium.

The computer readable medium can also include non-transitory computer readable media such as computer-readable media that stores data for short periods of time like register memory, processor cache, and random access memory (RAM). The computer readable media can also include non-transitory computer readable media that stores program code and/or data for longer periods of time, such as secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### Definitions and Clarifications:

Herein below are a few definitions and clarifications. As used herein: The terms “a” and “an”, when modifying a noun, do not imply that only one of the noun exists. The term “comprise” (and grammatical variations thereof) shall be construed broadly, as if followed by “Without limitation”. If A comprises B, then A includes B and may include other things.

The term “e. g.” means including without limitation. The fact that an “example” or multiple examples of something are given does not imply that they are the only instances of that thing. An example (or a group of examples) is merely a non-exhaustive and non-limiting illustration.

The term “include” (and grammatical variations thereof) shall be construed broadly, as if followed by “Without limitation”.

The term “or” is an inclusive disjunctive. For example “A or B” is true if A is true, or B is true, or both A or B are true.

A parenthesis is simply to make text easier to read, by indicating a grouping of words. A parenthesis does not mean that the parenthetical material is optional or can be ignored

1. An ear-worn contextual companion system, comprising:
an ear-worn device configured to be worn by a user, the ear-worn device comprising:
an optical or infrared sensor;
a head-motion sensor configured to generate head-orientation information;
a silent-speech sensor configured to detect silent or low-audibility user input;
a private output transducer configured to output information to the user; and
one or more processors configured to:
receive, from the optical or infrared sensor, temporally separated observations acquired as a head orientation of the user changes;
generate or update, using the temporally separated observations and the head-orientation information, a contextual representation comprising candidate referents in surroundings of the user;
receive the silent or low-audibility user input;
determine, from the silent or low-audibility user input, a semantic objective requiring contextual grounding;
select, from the contextual representation, a selected candidate referent for the semantic objective; and
cause an assistant operation associated with the selected candidate referent.

2. The system of claim 1, wherein the selected candidate referent is outside a current field of view of the optical or infrared sensor when the silent or low-audibility user input is received.

3. The system of claim 1, wherein the contextual representation covers an angular range greater than an instantaneous field of view of the optical or infrared sensor.

4. The system of claim 1, wherein the optical or infrared sensor comprises an infrared sensor, near-infrared sensor, low-resolution image sensor, event-based sensor, depth sensor, time-of-flight sensor, structured-light receiver, fisheye sensor, wide-angle sensor, proximity sensor, or non-photographic environmental sensor.

5. The system of claim 1, wherein the ear-worn device further comprises an outward-facing speaker configured to output externally audible speech toward an interlocutor.

6. The system of claim 5, wherein the private output transducer is configured to output a cancellation or masking signal to reduce perception by the user of audio output from the outward-facing speaker.

7. The system of claim 1, wherein the candidate referents comprise at least one of a person, object, text-bearing object, sign, menu, vehicle, hazard, personal item, payment terminal, device, location, interface element, or previously observed entity.

8. The system of claim 1, wherein the semantic objective comprises an incomplete referent slot corresponding to “this,” “that,” “there,” “him,” “her,” “it,” or an implicit object of a command.

9. A method performed by a wearable assistant system, comprising:
receiving sensor data generated at least in part by an ear-worn device worn by a user;
generating or accessing, from the sensor data, a contextual representation comprising candidate referents associated with surroundings of the user;
receiving silent or low-audibility user input from the user;
determining, from the silent or low-audibility user input, a semantic objective comprising an incomplete referent slot;
selecting, from the contextual representation, a selected candidate referent to fill the incomplete referent slot;
selecting, based on the semantic objective and the selected candidate referent, one of a plurality of assistant services without requiring the user to explicitly select an application; and
causing the selected assistant service to perform an assistant operation.

10. The method of claim 9, wherein the contextual representation is generated at least in part from temporally separated optical or infrared observations acquired by the ear-worn device during natural head movement of the user.

11. The method of claim 9, wherein the selected candidate referent was previously observed and is not currently imaged by an optical or infrared sensor when the silent or low-audibility user input is received.

12. The method of claim 9, wherein the selected candidate referent is a text-bearing referent, and wherein the assistant operation comprises reading, translating, summarizing, or interpreting text associated with the text-bearing referent.

13. The method of claim 9, wherein the selected candidate referent is a person referent, and wherein the assistant operation comprises outputting a name, relationship, prior interaction, remembered obligation, social-context cue, or conversational prompt associated with the person referent.

14. The method of claim 9, wherein the selected assistant service comprises a translation service, and wherein the method further comprises translating source-language content derived from the silent or low-audibility user input into target-language output and outputting the target-language output to a third party.

15. The method of claim 14, wherein the target-language output is output by an outward-facing speaker of the ear-worn device.

16. The method of claim 9, wherein the selected assistant service comprises a communication service, and wherein the method further comprises generating speech audio in a voice associated with the user from the silent or low-audibility user input and transmitting the generated speech audio to a remote participant after authenticating the user.

17. A method of operating an ear-worn ambient guardian system, comprising:
receiving contextual sensor data associated with an ear-worn device worn by a user;
maintaining, using the contextual sensor data, a contextual representation comprising candidate referents associated with surroundings of the user;
detecting, without receiving a contemporaneous user command, a user-relevant condition based on the contextual representation;
determining that the user-relevant condition satisfies an alert condition;
generating a private alert or action proposal associated with the alert condition; and
outputting the private alert or action proposal through the ear-worn device.

18. The method of claim 17, wherein the alert condition comprises an approaching vehicle, bicycle, person, animal, obstacle, platform edge, unsafe route, route deviation, left-behind personal item, approaching known person, persistent-following condition, unsafe transportation condition, hostile ambient speech, emotionally significant communication, or reduced-capacity state of the user.

19. The method of claim 17, further comprising receiving silent or low-audibility confirmation from the user and initiating a protective action in response to the confirmation, wherein the protective action comprises trusted-contact communication, live-location sharing, transportation request, route guidance, emergency communication, payment delay, message delay, or evidence preservation.

20. The method of claim 17, further comprising detecting a reduced-capacity state of the user and lowering a threshold for determining that the user-relevant condition satisfies the alert condition.
